(19) United States
(12) Patent Application Publication
(10) Pub. No.: US 2021/0380743 A1
(43) Pub. Date: Dec. 9, 2021

(54) ULTRAVIOLET-RAY ABSORBING POLYMER, FORMATION RESIN COMPOSITION, AND FORMED BODY

(71) Applicants: TOYO INK SC HOLDINGS CO., LTD., Tokyo (JP); TOYOCOLOR CO., LTD., Tokyo (JP)

(72) Inventors: Akio HIMIZU, Tokyo (JP); Keisuke MASUKO, Tokyo (JP); Joji MIKAMI, Tokyo (JP); Takeshi NISHINAKA, Tokyo (JP); Tomoyuki AOTANI, Tokyo (JP); Kazunori SHIGEMORI, Tokyo (JP); Motoki TANAKA, Tokyo (JP); Hiroyuki HAYASHI, Tokyo (JP)

(73) Assignees: TOYO INK SC HOLDINGS CO., LTD., Tokyo (JP); TOYOCOLOR CO., LTD., Tokyo (JP)

(21) Appl. No.: 17/405,036

(22) Filed: Aug. 18, 2021

Related U.S. Application Data
(63) Continuation of application No. PCT/JP2020/006299, filed on Feb. 18, 2020.

(30) Foreign Application Priority Data
Feb. 20, 2019 (JP) 2019-028618
Mar. 15, 2019 (JP) 2019-048496
Aug. 21, 2019 (JP) 2019-150888
Aug. 21, 2019 (JP) 2019-150889

(51) Int. Cl. C08F 220/14; C08F 220/18; C08F 212/08; C08L 33/12; C08L 33/08; C08L 23/06

(52) U.S. Cl. CPC C08F 220/14; C08F 220/1818; C08F 220/1811; C08L 23/06; C08F 220/1804; C08L 33/12; C08L 33/08; C08F 212/08

(57) ABSTRACT

An ultraviolet-ray absorbing polymer containing a monomer unit represented by general formula (12) below and a monomer unit derived from a monomer represented by general formula (1) below. In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom. In general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

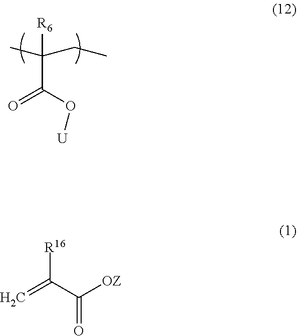

### CROSS REFERENCE TO RELATED APPLICATIONS

This application is a Continuation of PCT International Application No. PCT/JP2020/006299, filed on Feb. 18, 2020, which claims priority under 35 U.S.C § 119(a) to Patent Application No. 2019-028618, filed in Japan on Feb. 20, 2019, Patent Application No. 2019-048496, filed in Japan on Mar. 15, 2019, Patent Application No. 2019-150888, filed in Japan on Aug. 21, 2019 and Patent Application No. 2019-150889, filed in Japan on Aug. 21, 2019, all of which are hereby expressly incorporated by reference into the present application.

### BACKGROUND

### Technical Field

The present invention relates to an ultraviolet-ray absorbing polymer, a formation resin composition, and a formed body.

### Related Art

Conventionally, resin formed bodies (hereinafter, referred to as formed bodies) have been used as packaging materials for pharmaceutical drugs, cosmetics and so on. The contents like pharmaceutical drugs and cosmetics are easily deteriorated by the ultraviolet ray. However, when an ultraviolet ray absorber is blended, the ultraviolet ray absorber may migrate and contaminate the content.

Therefore, in Patent literature 1 and 2, a composition which contains a resin with polyolefin and an ultraviolet ray absorber incorporated therein is disclosed. In Patent literature 3, a polymer obtained by copolymerization of ultraviolet-ray absorbing monomers is disclosed.

### LITERATURE OF RELATED ART

### Patent Literature

Patent literature 1: Japanese Patent Laid-Open No. 2001-72722
Patent literature 2: Japanese Patent Laid-Open No. 2001-114842
Patent literature 3: Japanese Patent Laid-Open No. 2005-008785

### SUMMARY

### Problems to be Solved

The present invention provides an ultraviolet-ray absorbing polymer having a satisfactory intermiscibility with polyolefin and being capable of forming a formed body with a satisfactory transparency, for example, capable of suppressing ultraviolet deterioration of the content when forming a packaging material.

### Means to Solve Problems

An embodiment of the present invention is an ultraviolet-ray absorbing polymer containing a monomer unit represented by general formula (12) below and a monomer unit derived from a monomer represented by general formula (1) below.

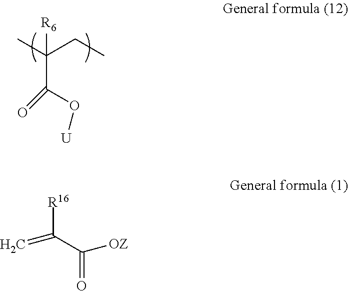

In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom, in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

Another embodiment of the present invention is an ultraviolet-ray absorbing polymer which contains block A and block B, wherein

the block A is a polymer block containing a monomer unit represented by general formula (12) below, and
the block B is a polymer block containing monomer unit derived from a monomer represented by general formula (1) below (however, the polymer block does not contain the monomer unit represented by general formula (12)).

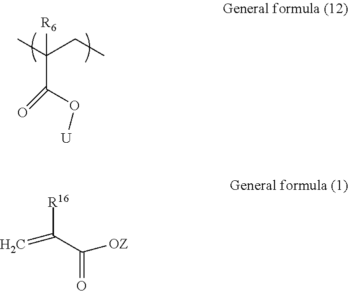

In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom, in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

### DESCRIPTION OF THE EMBODIMENTS

Hereinafter, embodiments of the present invention are described in detail, but the description of the embodiments or the requirements below are examples of the embodiments of the present invention, and the present invention is not limited hereto within a scope not departing from the gist.

The embodiments of the present invention are as follows.

<1> An ultraviolet-ray absorbing polymer containing a monomer unit represented by general formula (12) below and a monomer unit derived from a monomer represented by general formula (1) below.

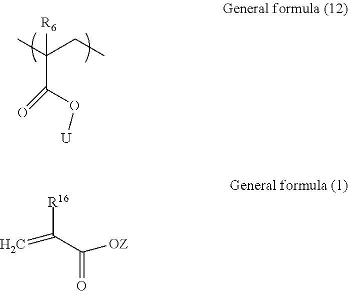

In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom, in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

<2> An ultraviolet-ray absorbing polymer which contains block A and block B, wherein the block A is a polymer block containing a monomer unit represented by general formula (12) below, and the block B is a polymer block containing a monomer unit derived from a monomer represented by general formula (1) below (however, the polymer block does not contain the monomer unit represented by general formula (12)).

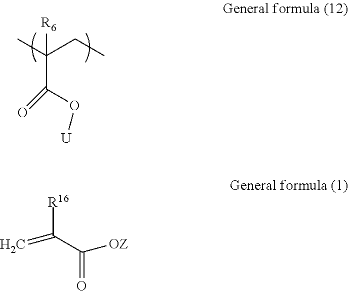

In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom, in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

<3> The ultraviolet-ray absorbing polymer according to <2>, wherein the block A contains 30 to 100 mass % of the monomer unit represented by general formula (12).

<4> The ultraviolet-ray absorbing polymer according to any one of <1> to <3>, wherein the skeleton absorbing ultraviolet rays is one or more skeletons selected from a group consisting of a benzotriazole skeleton, a triazine skeleton, and a benzophenone skeleton.

<5> The ultraviolet-ray absorbing polymer according to <4>, wherein the skeleton absorbing ultraviolet rays is one or more skeletons selected from a group consisting of the benzotriazole skeleton and the triazine skeleton, the monomer unit containing the benzotriazole skeleton contains one monomer unit selected from a group consisting of a monomer unit represented by general formula (a1-1) below and a monomer unit represented by general formula (3) below, and the monomer unit containing the triazine skeleton contains a monomer unit represented by general formula (a1-4) below.

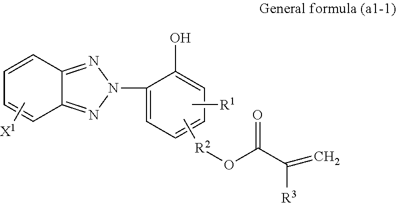

In general formula (a1-1), R¹ represents any one selected from a group consisting of a hydrogen atom and a hydrocarbon group having 1 to 8 carbon atoms, R² represents any one selected from a group consisting of an alkylene group having 1 to 6 carbon atoms and —O—R⁵, R⁵ represents an alkylene group having 1 to 6 carbon atoms, R³ represents any one selected from a group consisting of a hydrogen atom and a methyl group, and X¹ represents any one selected from a group consisting of a hydrogen atom, a halogen atom, a hydrocarbon group having 1 to 8 carbon atoms, an alkoxy group having 1 to 6 carbon atoms, a cyano group, and a nitro group.

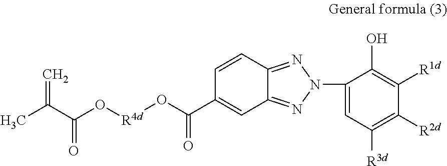

In general formula (3), R^{1d} represents any one selected from a group consisting of a hydrogen atom, an alkyl group having 1 to 20 carbon atoms, and a cycloalkyl group having 3 to 20 carbon atoms, R^{2d} and R^{3d} independently represent any one selected from a group consisting of a hydrogen atom, an alkyl group having 1 to 20 carbon atoms, a cycloalkyl group having 3 to 20 carbon atoms, and an alkoxy group having 1 to 20 carbon atoms, and R^{4d} represents any one selected from a group consisting of an alkylene group having 1 to 20 carbon atoms and a hydroxy alkylene group having 3 to 5 carbon atoms.

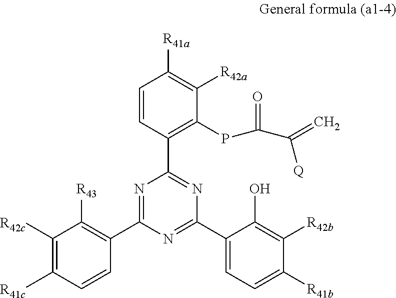

In general formula (a1-4), R₄₁ₐ, R_{41b}, and R_{41c} independently represent any one selected from a group consisting of a hydrogen atom, an alkyl group having 1 to 20 carbon atoms, an aryl group having 6 to 20 carbon atoms, —O—R₄₄ₐ, and —O—R₄₅ₐ—CO—O—R₄₆ₐ, R₄₄ₐ and R₄₆ₐ independently represent any one selected from a group consisting of an alkyl group having 1 to 20 carbon atoms and an aryl group having 6 to 20 carbon atoms, the alkyl group optionally forms a cyclic structure, R₄₅ₐ represents any one selected from a group consisting of an alkylene group having 1 to 20 carbon atoms and an arylene group having 6 to 20 carbon atoms, R₄₂ₐ, R_{42b}, and R_{42c} independently represent any one selected from a group consisting of a hydrogen atom and an alkyl group having 1 to 10 carbon atoms, R₄₃ represents any one selected from a group consisting of a hydrogen atom, a hydroxyl group, an alkyl group having 1 to 20 carbon atoms, an aryl group having 6 to 20 carbon atoms, —O—R_{44b}, and —O—R_{45b}—CO—O—R_{46b}, R_{44b} and R_{46b} independently represent any one selected from a group consisting of an alkyl group having 1 to 20 carbon atoms and an aryl group having 6 to 20 carbon atoms, the alkyl group optionally forms a cyclic structure, R_{45b} represents any one selected from a group consisting of an alkylene group having 1 to 20 carbon atoms and an arylene group having 6 to 20 carbon atoms, and the alkyl group optionally forms a cyclic structure.

P represents any one selected from a group consisting of —O— and —O—R₄₇—O—, R₄₇ represents an alkylene group having 1 to 20 carbon atoms, the alkylene group optionally contains a hydroxyl group, and Q represents any one selected from a group consisting of a hydrogen atom and a methyl group.

<6> The ultraviolet-ray absorbing polymer according to any one of <1> to <5>, which is obtained by copolymerization of the monomer unit represented by general formula (12), the monomer unit derived from the monomer represented by general formula (1), and a monomer unit represented by general formula (5) below.

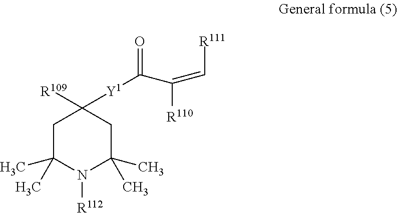

In general formula (5), R¹⁰⁹ represents any one selected from a group consisting of a hydrogen atom and a cyano group, R¹¹⁰ and R¹¹¹ independently represent any one selected from a group consisting of a hydrogen atom and a methyl group, R¹¹² represents any one selected from a group consisting of a hydrogen atom and a hydrocarbon group, and Y¹ represents any one selected from a group consisting of an oxygen atom and an imino group.

<7> A formation resin composition, wherein the formation resin composition contains a thermoplastic resin and the ultraviolet-ray absorbing polymer according to any one of <1> to <6>, and the weight average molecular weight of the ultraviolet-ray absorbing polymer is 5,000 to 100,000.

<8> The formation resin composition according to <7>, wherein the thermoplastic resin is polyolefin.

<9> A formed body containing the formation resin composition according to <7> or <8>.

Next, terms in the specification and the like are defined. In the specification and the like, “(meth)acryl”, “(meth)acrylate”, “(meth)acryloyl” and so on mean “acryl or methacryl”, “acrylate or methacrylate”, “acryloyl or methacryloyl” and so on. For example, “(meth)acrylic acid” means “acrylic acid or methacrylic acid”. In addition, an unsaturated monomer or a monomer respectively means a compound containing an ethylenic unsaturated group.

### First Embodiment

The ultraviolet-ray absorbing polymer of the present embodiment contains a monomer unit represented by general formula (12) below and a monomer unit derived from a monomer represented by general formula (1) below. The ultraviolet-ray absorbing polymer may be a block polymer.

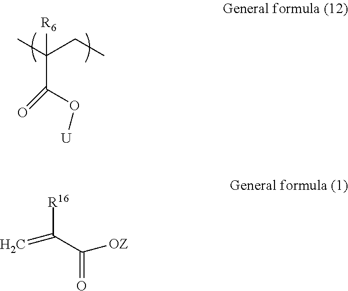

<General Formula (12)>

In general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom.

By the monomer unit represented by general formula (12) having a skeleton absorbing ultraviolet rays, the ultraviolet-ray absorbing polymer has an ultraviolet-ray absorbing property. The skeleton absorbing ultraviolet rays may be, for example, a hydrocarbon group that optionally contains a heteroatom.

The monomer unit represented by general formula (12) is a unit generated by polymerizing a monomer represented by general formula (16) below.

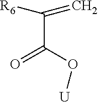

In general formula (16), R₆ represents any one selected from a group consisting of a hydrogen atom and a methyl group, U represents a hydrocarbon group, and the hydrocarbon group includes a skeleton absorbing ultraviolet rays and optionally contains a heteroatom.

The monomer unit represented by general formula (16) may be used independently or in appropriate combination of two or more as necessary.

The content of the monomer unit represented by general formula (16) is preferably 3 to 40 mass %, more preferably 3 to 30 mass %, and further preferably 5 to 25 mass % in 100 mass % of the monomer mixture. With an appropriate content, the balance between the ultraviolet-ray absorbing property and the intermiscibility with polyolefin is easily achieved. When the ultraviolet-ray absorbing polymer is synthesized as a block polymer which contains block A obtained by polymerizing an ultraviolet-ray absorbing unsaturated monomer and block B obtained by polymerizing another monomer, intermiscibility does not decrease even if the ultraviolet-ray absorbing unsaturated monomer is contained by 40 mass % or more in the monomer components of the ultraviolet-ray absorbing polymer. Besides, in the monomer components of the block polymer, the upper limit of the ultraviolet-ray absorbing unsaturated monomer is preferably 70 mass % or less, more preferably 60 mass % or less.

<Monomer Unit (a1) Represented by General Formula (16)>

In monomer unit (a1) represented by general formula (16), U represents a hydrocarbon group, and the hydrocarbon group includes a skeleton absorbing ultraviolet rays and optionally contains a heteroatom. Preferably, the skeleton absorbing ultraviolet rays is, for example, one or more skeletons selected from a group consisting of a benzotriazole skeleton, a triazine skeleton, and a benzophenone skeleton. Hereinafter, the monomer unit is described for each of the skeletons absorbing ultraviolet rays.

(Monomer Unit Containing Benzotriazole Skeleton)

In a case that U is a benzotriazole skeleton, monomer units represented by general formulas (a1-1) to (a1-3) below are listed as examples.

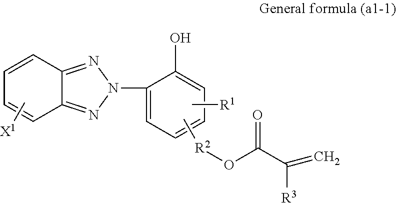

In general formula (a1-1), R¹ represents any one selected from a group consisting of a hydrogen atom and a hydrocarbon group having 1 to 8 carbon atoms. R² represents any one selected from a group consisting of an alkylene group having 1 to 6 carbon atoms and —O—R⁵, and R⁵ represents an alkylene group having 1 to 6 carbon atoms. R³ represents any one selected from a group consisting of a hydrogen atom and a methyl group. X¹ represents any one selected from a group consisting of a hydrogen atom, a halogen atom, a hydrocarbon group having 1 to 8 carbon atoms, an alkoxy group having 1 to 6 carbon atoms, a cyano group, and a nitro group.

The hydrocarbon group having 1 to 8 carbon atoms may be, for example, a chain hydrocarbon group such as a methyl group, an ethyl group, a propyl group, an isopropyl group, a butyl group, an isobutyl group, a tert-butyl group, a pentyl group, a hexyl group, a heptyl group, and an octyl group; a cycloaliphatic hydrocarbon group such as a cyclopropyl group, a cyclopentyl group, a cyclohexyl group, a cycloheptyl group, and a cyclooctyl group; an aromatic hydrocarbon group such as a phenyl group, a tolyl group, a xylyl group, a benzyl group, a phenethyl group, and the like.

The alkylene group having 1 to 6 carbon atoms may be, for example, a linear alkylene group such as a methylene group, an ethylene group, a trimethylene group, and a tetramethylene group; a branched alkylene group such as a propylene group, 2-methyl trimethylene group, 2-methyl tetramethylene group, and the like.

The halogen atom may be, for example, a fluorine atom, a chlorine atom, bromine atom, and an iodine atom.
The alkoxy group having 1 to 6 carbon atoms may be, for example, a methoxy group, an ethoxy group, a propoxy group, a butoxy group, a pentoxy group, a heptoxy group, and the like.

The monomer unit represented by general formula (a1-1) is originated from, for example, monomers such as 2-[2′-hydroxy-5′-(methacryloyl oxymethyl)phenyl]-2H-benzotriazole, 2-[2′-hydroxy-5′-(methacryloyl oxyethyl)phenyl]-2H-benzotriazole, 2-[2′-hydroxy-5′-(methacryloyl oxypropyl)phenyl]-2H-benzotriazole, 2-[2′-hydroxy-3′-tert-butyl-5′-(methacryloyl oxyethyl)phenyl]-2H-benzotriazole, 2-[2′-hydroxy-5′-tert-butyl-3′-(methacryloyl oxyethyl)phenyl]-2H-benzotriazole, 2-[2′-hydroxy-5′-(β-methacryloyl oxyethoxy)-3′-tert-butylphenyl]-4-tert-butyl-2H-benzotriazole.

The monomer unit represented by general formula (a1-1) is originated from, for example, the monomers below.

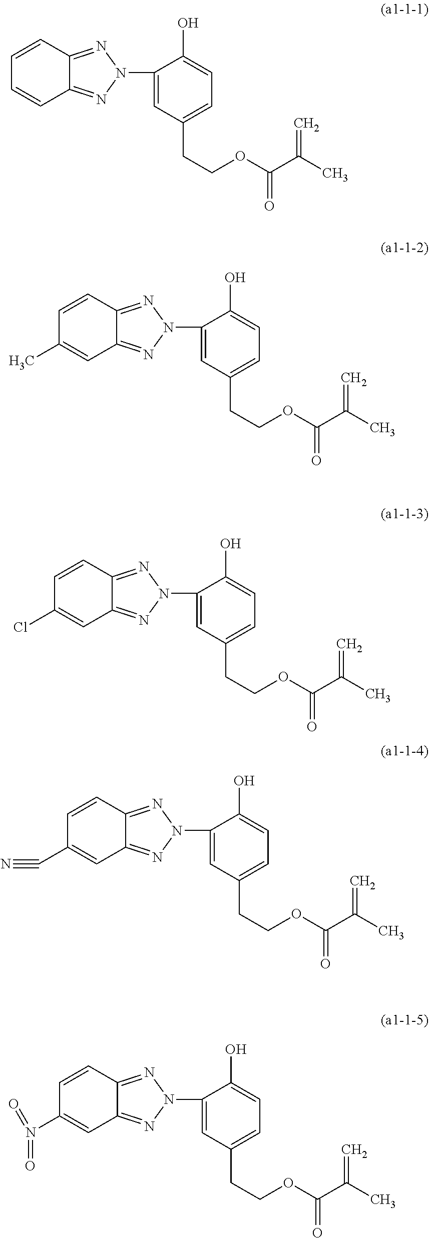

The monomer unit represented by general formula (a1-1) may be used independently or in appropriate combination of two or more as necessary.

The content of the monomer unit represented by general formula (a1-1) is preferably 1 to 30 mass % and more preferably 5 to 25 mass % in the monomer units constituting the ultraviolet-ray absorbing polymer. With an appropriate content, the balance between the ultraviolet-ray absorbing property and the intermiscibility with polyolefin is easily achieved.

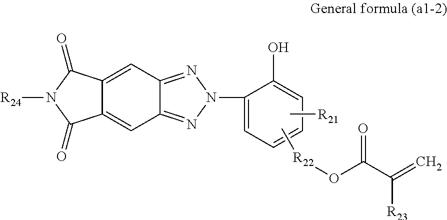

In general formula (a1-2), R₂₁ represents any one selected from a group consisting of a hydrogen atom, an alkyl group having 1 to 20 carbon atoms, a cycloalkyl group having 3 to 20 carbon atoms, and an alkoxy group having 1 to 20 carbon atoms. R₂₂ represents any one selected from a group consisting of an alkylene group having 1 to 20 carbon atoms, —R₂₅—O(CO)NH—R₂₆—, —O—R₂₇—, and —O—R₂₈—O(CO)NH—R₂₉—, and R₂₅, R₂₆, R₂₇, R₂₈ and R₂₉ independently represent an alkylene group having 1 to 20 carbon atoms. R₂₃ represents any one selected from a group consisting of a hydrogen atom and a methyl group. R₂₄ represents any one selected from a group consisting of a hydrogen atom, an alkyl group having 1 to 20 carbon atoms, and a cycloalkyl group having 3 to 20 carbon atoms. Besides, the cycloalkyl group may further contain a substituent.

The alkyl group having 1 to 20 carbon atoms may be, for example, a methyl group, an ethyl group, a propyl group, an isopropyl group, a butyl group, an isobutyl group, a tert-butyl group, a pentyl group, a hexyl group, a heptyl group, an octyl group, a nonyl group, decyl group, an undecyl group, a dodecyl group, a tridecylgroup, a tetradecyl group, a pentadecyl group, a hexadecyl group, a heptadecyl group, an octadecyl group, a nonadecyl group, an eicosyl group, and the like. The cycloalkyl group having 3 to 20 carbon atoms may be, for example, a cycloalkyl group such as a cyclopropyl group, a cyclopentyl group, a cyclohexyl group, a cycloheptyl group and a cyclooctyl group, and the like. The alkoxy group having 1 to 20 carbon atoms may be, for example, a methoxy group, an ethoxy group, a propoxy group, an isopropoxy group, a butoxy group, an isobutoxy group, a tert-butoxy group, a pentyloxy group, a hexyloxy group, a heptyloxy group, an octyloxy group, a nonyloxy group, a decyloxy group, an undecyloxy group, a dodecyloxy group, a tridecyloxy group, a tetradecyloxy group, a pentadecyloxy group, a hexadecyloxy group, a heptadecyloxy group, an octadecyloxy group, a nonadecyloxy group, an eicosyloxy group, and the like.

In addition, in general formula (a1-2), the hydrogen atom in the alkyl group having 1 to 20 carbon atoms may be substituted by a halogen atom. For example, the alkyl group may be 1-bromomethyl group, 2-bromoethyl group, 2-chloroethyl group, 2-iodoethyl group, 3-bromopropyl group, 4-bromobutyl group, 1-bromobutyl group, 5-bromopentyl group, 6-bromohexyl group, 7-bromoheptyl group, 8-bromooctyl group, 9-bromononyl group, 10-bromodecyl group, 11-bromoundecyl group, 12-bromododecyl group, 13-bromotridecyl group, 14-bromotetradecyl group, 15-bromopentadecyl group, 16-bromohexadecyl group, 17-bromoheptadecyl group, 18-bromooctadecyl group, 19-bromononadecyl group, 20-bromoeicosyl group, and the like. The cycloalkyl group having 3 to 20 carbon atoms may be, for example, 2-bromocyclopropyl group, 2-bromocyclopentyl group, 4-bromocyclohexyl group, and the like. The alkoxy group having 1 to 20 carbon atoms may be, for example, 1-bromomethoxy group, 2-bromoethoxy group, 3-chloropropoxy group, and the like.

The alkylene group having 1 to 20 carbon atoms may be, for example, a linear alkylene group such as a methylene group, an ethylene group, a trimethylene group, a tetramethylene group, a pentamethylene group, a hexamethylene group, a heptamethylene group, and an octamethylene group; a branched alkylene group such as a propylene group, 2-methyltrimethylene group, 2-methyltetramethylene group, and the like. The hydrogen atom in the alkylene group having 1 to 20 carbon atoms may be substituted by a halogen atom. For example, the alkylene group may be a monobromomethylene group, a monobromoethylene group, a monochloroethylene group, a monoiodo ethylene group, a dibromoethylene group, a monobromotrimethylene group, a monobromotetramethylene group, a monobromopentamethylene group, a monobromohexamethylene group, a monobromoheptamethylene group, a monobromooctamethylene group, and the like.

The monomer unit represented by general formula (a1-2) is originated from, for example, the monomers below.

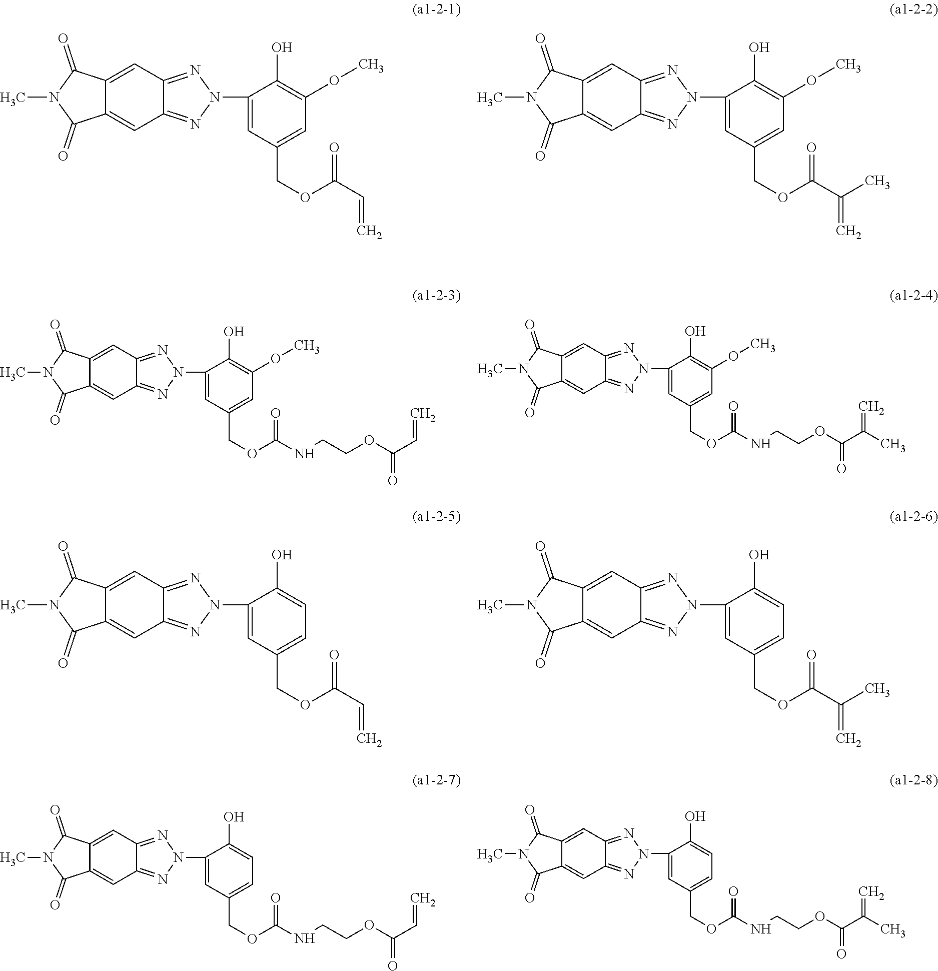

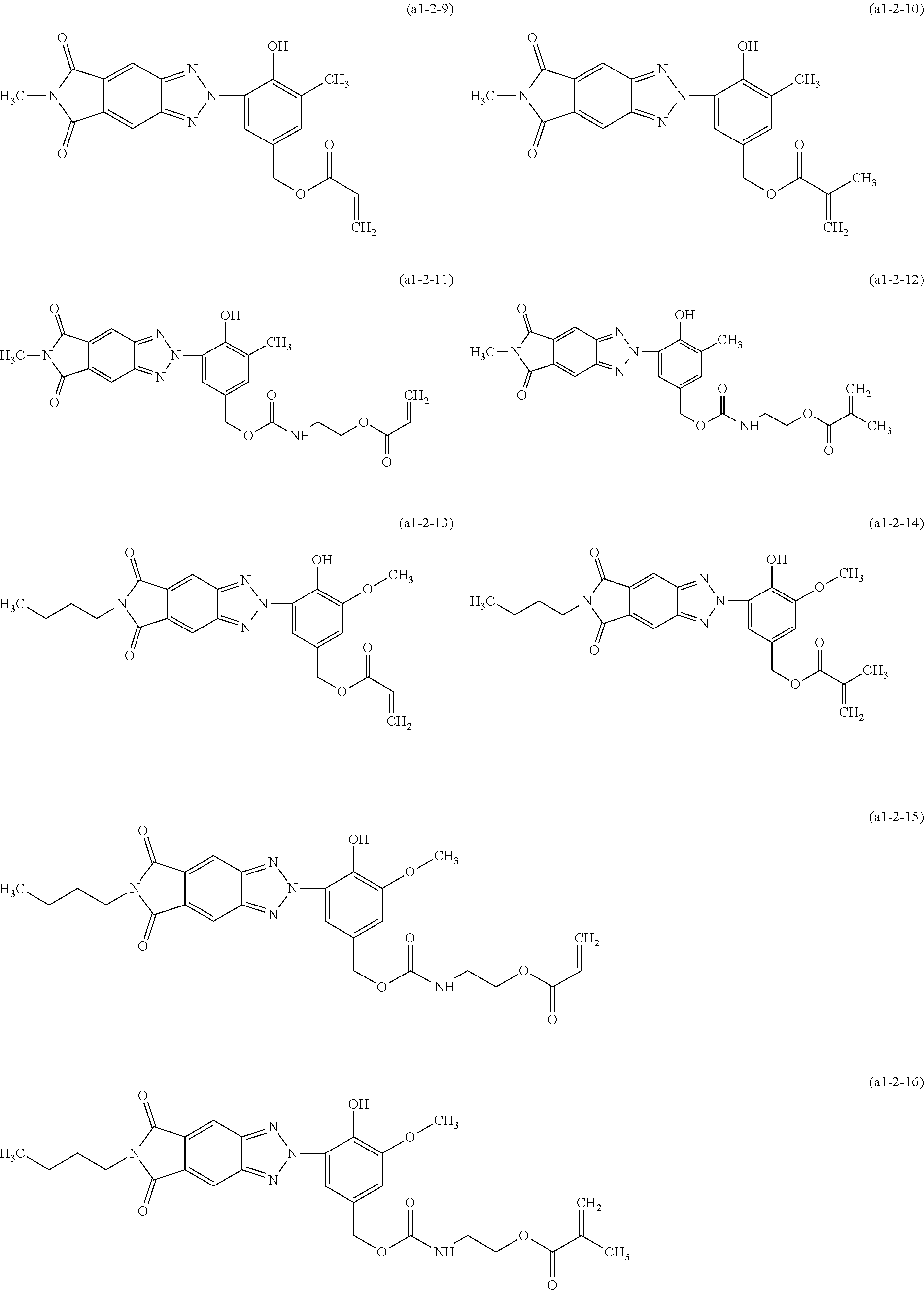

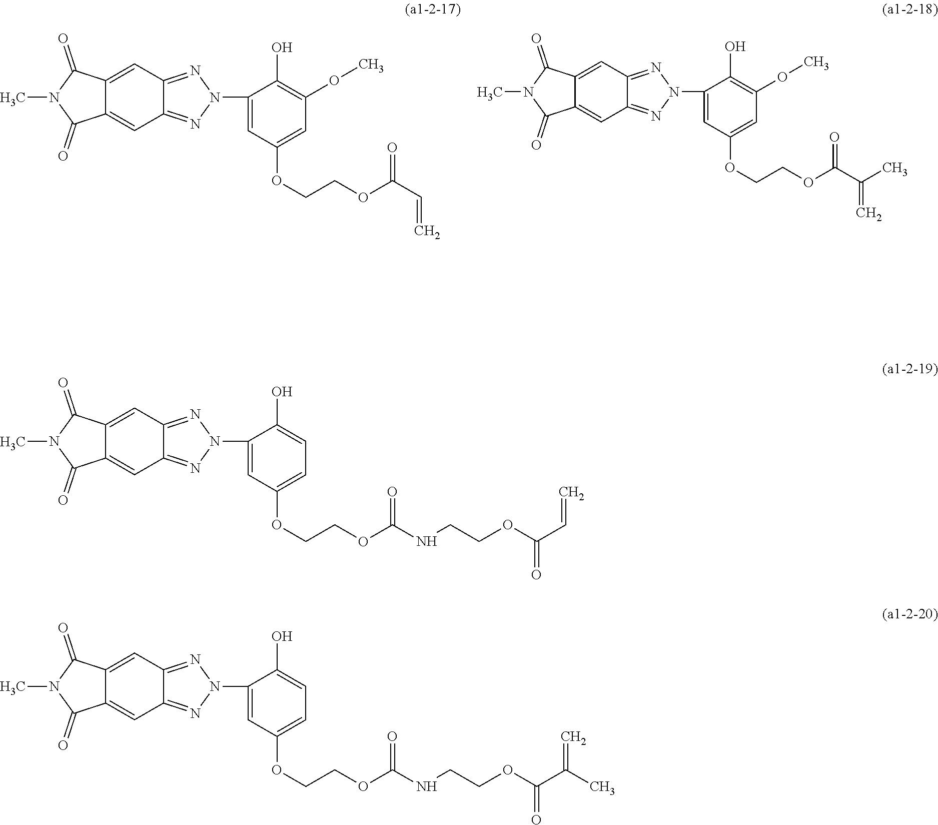

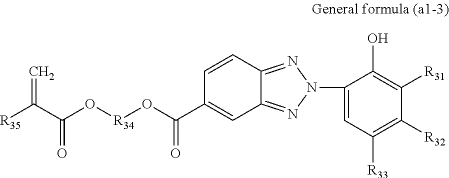

In general formula (a1-3), R₃₁ represents any one selected from a group consisting of a hydrogen atom, an alkyl group having 1 to 20 carbon atoms, and a cycloalkyl group having 3 to 20 carbon atoms, R₃₂ and R₃₃ independently represent any one selected from a group consisting of a hydrogen atom, an alkyl group having 1 to 20 carbon atoms, a cycloalkyl group having 3 to 20 carbon atoms, and an alkoxy group having 1 to 20 carbon atoms, and R₃₄ represents any one selected from a group consisting of an alkylene group having 1 to 20 carbon atoms and a hydroxy alkylene group having 3 to 5 carbon atoms. R₃₅ represents any one selected from a group consisting of a hydrogen atom and a methyl group.

The alkyl group having 1 to 20 carbon atoms may be, for example, a methyl group, an ethyl group, a propyl group, an isopropyl group, a butyl group, an isobutyl group, a tert-butyl group, a pentyl group, a hexyl group, a heptyl group, an octyl group, a nonyl group, a decyl group, an undecyl group, a dodecyl group, a tridecylgroup, a tetradecyl group, a pentadecyl group, a hexadecyl group, a heptadecyl group, an octadecyl group, a nonadecyl group, an eicosyl group, and the like. The cycloalkyl group having 3 to 20 carbon atoms may be, for example, a cycloalkyl group such as a cyclopropyl group, a cyclopentyl group, a cyclohexyl group, a cycloheptyl group, a cyclooctyl group, and the like. The alkoxy group having 1 to 20 carbon atoms may be, for example, a methoxy group, an ethoxy group, a propoxy group, an isopropoxy group, a butoxy group, an isobutoxy group, a tert-butoxy group, a pentyloxy group, a hexyloxy group, a heptyloxy group, an octyloxy group, a nonyloxy group, a decyloxy group, an undecyloxy group, a dodecyloxy group, a tridecyloxy group, a tetradecyloxy group, a pentadecyloxy group, a hexadecyloxy group, a heptadecyloxy group, an octadecyloxy group, a nonadecyloxy group, an eicosyloxy group, and the like.

The alkylene group having 1 to 20 carbon atoms may be, for example, a linear alkylene group such as a methylene group, an ethylene group, a trimethylene group, a tetramethylene group, a pentamethylene group, a hexamethylene group, a heptamethylene group, and an octamethylene group; a branched alkylene group such as a propylene group, 2-methyltrimethylene group and 2-methyltetramethylene group, and the like. The hydrogen atom in the alkylene group having 1 to 20 carbon atoms may be substituted by a halogen. For example, the alkylene group may be a monobromomethylene group, a monobromoethylene group, a monochloroethylene group, a monoiodo ethylene group, a dibromoethylene group, a monobromotrimethylene group, a monobromotetramethylene group, a monobromopentamethylene group, a monobromohexamethylene group, a monobromoheptamethylene group, a monobromooctamethylene group, and the like. The hydroxy alkylene group having 3 to 5 carbon atoms may be, for example, 2-hydroxypropylene group, 1-methyl-2-hydroxyethylene group, 2-hydroxybutylene group, 2-hydroxypentylene group, 1-methyl-2-hydroxypropylene group, and the like.

In addition, the hydrogen atom in the alkyl group, the cycloalkyl group, the alkoxy group, the alkylene group and the hydroxy alkylene group may be substituted by a halogen atom. The halogen-atom substituted alkyl group having 1 to 20 carbon atoms may be, for example, 1-bromomethyl group, 2-bromoethyl group, 2-chloroethyl group, 2-iodoethyl group, 3-bromopropyl group, 4-bromobutyl group, 1-bromobutyl group, 5-bromopentyl group, 6-bromohexyl group, 7-bromoheptyl group, 8-bromooctyl group, 9-bromononyl group, 10-bromodecyl group, 11-bromoundecyl group, 12-bromododecyl group, 13-bromotridecyl group, 14-bromotetradecyl group, 15-bromopentadecyl group, 16-bromohexadecyl group, 17-bromoheptadecyl group, 18-bromooctadecyl group, 19-bromononadecyl group, 20-bromoeicosyl group, and the like.

The halogen-atom substituted cycloalkyl group having 3 to 20 carbon atoms may be, for example, 2-bromocyclopropyl group, 2-bromocyclopentyl group, 4-bromocyclohexyl group, and the like. The halogen-atom substituted alkoxy group having 1 to 20 carbon atoms may be, for example, 1-bromomethoxy group, 2-bromoethoxy group, 3-chloropropoxy group, and the like.

The monomer unit represented by general formula (3) in which R₃₅ is a methyl group in general formula (a1-3) is shown below.

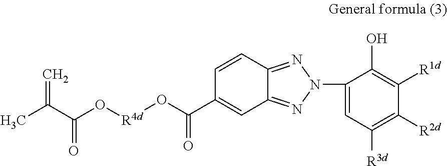

In general formula (3), R^{1d} represents any one selected from a group consisting of a hydrogen atom, an alkyl group having 1 to 20 carbon atoms, and a cycloalkyl group having 3 to 20 carbon atoms, R^{2d} and R^{3d} independently represent any one selected from a group consisting of a hydrogen atom, an alkyl group having 1 to 20 carbon atoms, a cycloalkyl group having 3 to 20 carbon atoms, and an alkoxy group having 1 to 20 carbon atoms, and R^{4d} represents any one selected from a group consisting of an alkylene group having 1 to 20 carbon atoms and a hydroxy alkylene group having 3 to 5 carbon atoms.

The alkyl group having 1 to 20 carbon atoms, the cycloalkyl group having 3 to 20 carbon atoms, the alkoxy group having 1 to 20 carbon atoms, the alkylene group having 1 to 20 carbon atoms, and the hydroxy alkylene group having 3 to 5 carbon atoms may refer to the description of general formula (a1-3).

The monomer unit represented by general formula (a1-3) is originated from, for example, the monomers below.

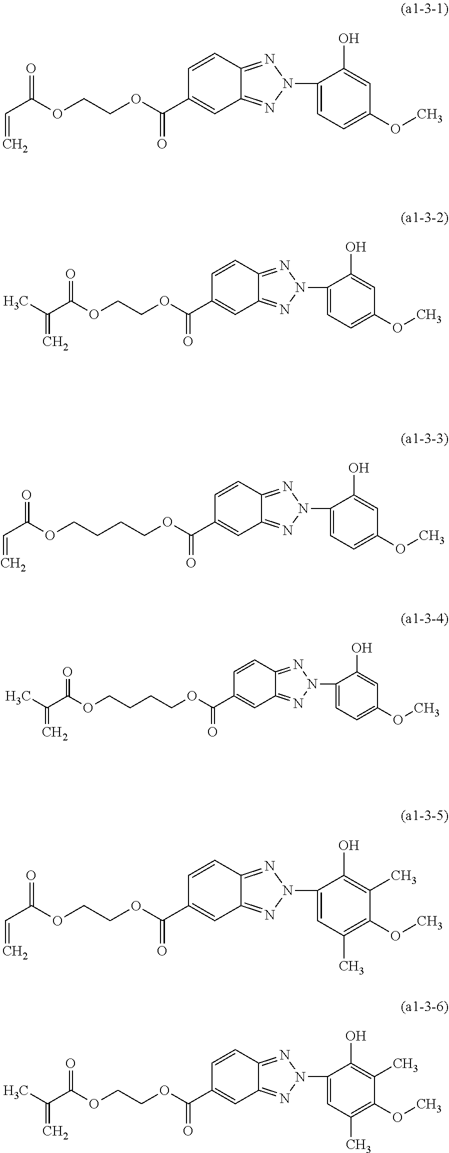

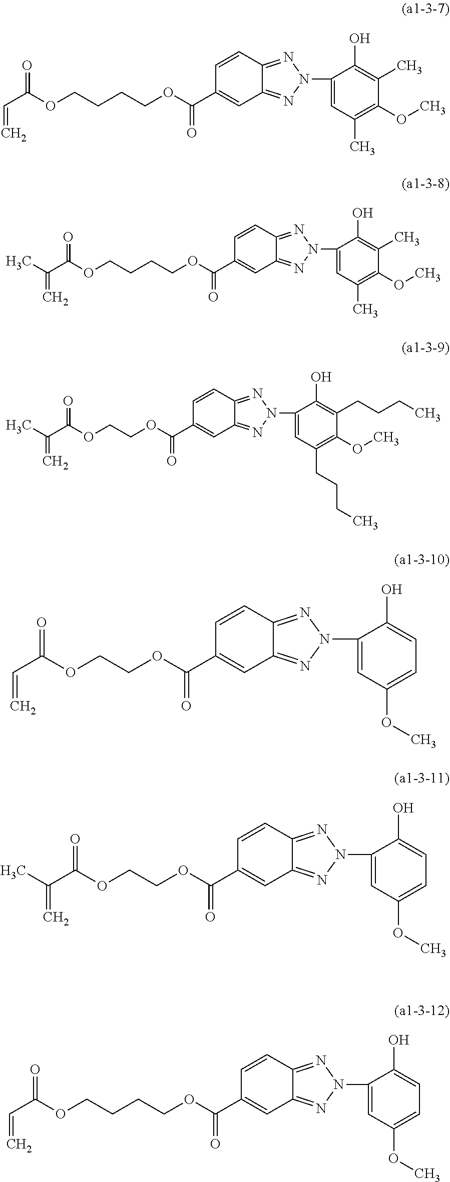

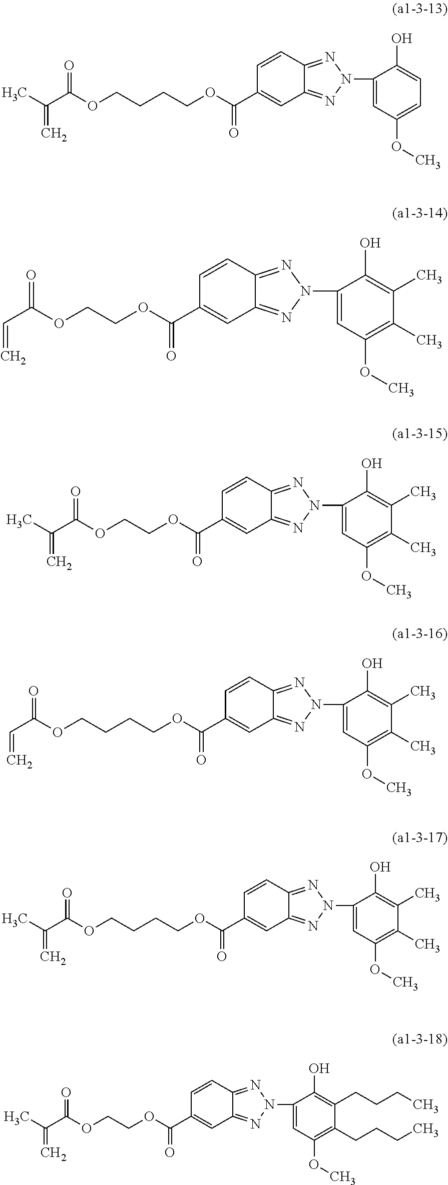

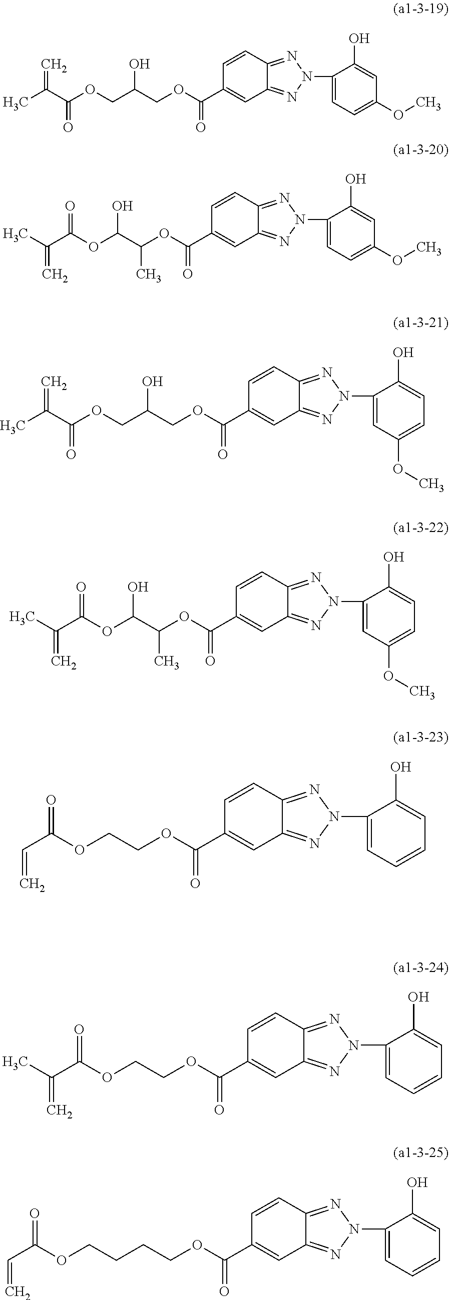

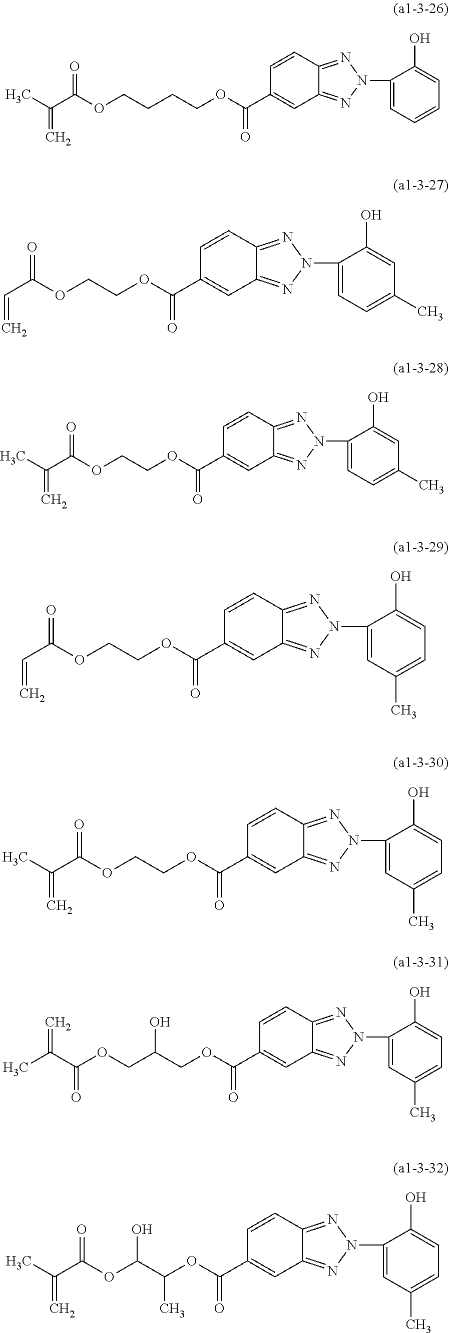

The content of the monomer unit represented by general formula (3) is preferably 2 to 50 mass % and more preferably 5 to 40 mass % in the monomer units constituting the ultraviolet-ray absorbing polymer.

(Monomer Unit Containing Triazine Skeleton)

When U is a triazine skeleton in general formula (16), a monomer unit represented by general formula (a1-4) below is listed as an example.

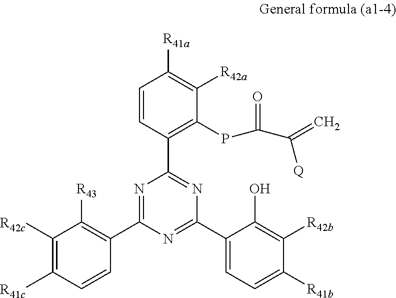

In general formula (a1-4), R₄₁ₐ, R_{41b}, and R_{41c} independently represent any one selected from a group consisting of a hydrogen atom, an alkyl group having 1 to 20 carbon atoms, an aryl group having 6 to 20 carbon atoms, —O—R₄₄ₐ, and —O—R₄₅ₐ—CO—O—R₄₆ₐ, R₄₄ₐ and R₄₆ₐ independently represent any one selected from a group consisting of an alkyl group having 1 to 20 carbon atoms and an aryl group having 6 to 20 carbon atoms, the alkyl group optionally forms a cyclic structure, and R₄₅ is represented by an alkylene group having 1 to 20 carbon atoms or an arylene group having 6 to 20 carbon atoms.

R₄₂ₐ, R_{42b}, and R_{42c} are independently a hydrogen atom or an alkyl group having 1 to 10 carbon atoms.
R₄₃ is represented by a hydrogen atom, a hydroxyl group, an alkyl group having 1 to 20 carbon atoms, an aryl group having 6 to 20 carbon atoms, —O—R_{44b}, or —O—R_{45b}—CO—O—R_{46b}, R_{44b} and R_{46b} are independently represented by an alkyl group having 1 to 20 carbon atoms or an aryl group having 6 to 20 carbon atoms, the alkyl group optionally forms a cyclic structure, R_{45b} represents any one selected from a group consisting of an alkylene group having 1 to 20 carbon atoms and an arylene group having 6 to 20 carbon atoms, and the alkyl group optionally forms a cyclic structure.
P represents any one selected from a group consisting of —O— and —O—R₄₇—O—, R₄₇ represents an alkylene group having 1 to 20 carbon atoms, the alkylene group optionally contains a hydroxyl group, and Q represents any one selected from a group consisting of a hydrogen atom and a methyl group.

The alkyl group having 1 to 20 carbon atoms may be, for example, a chain hydrocarbon group such as a methyl group, a ethyl group, a propyl group, an isopropyl group, a butyl group, an isobutyl group, a tert-butyl group, a pentyl group, a hexyl group, a heptyl group, an octyl group, a nonyl group, a decyl group, an undecyl group, a dodecyl group, a tridecylgroup, a tetradecyl group, a pentadecyl group, a hexadecyl group, a heptadecyl group, an octadecyl group, a nonadecyl group, and an eicosyl group; and a cycloaliphatic hydrocarbon group a cyclopropyl group, a cyclopentyl group, a cyclohexyl group, a cycloheptyl group, and a cyclooctyl group.

The hydrogen atom in the alkyl group having 1 to 20 carbon atoms may be substituted by a halogen atom. For example, the alkyl group may be a chain hydrocarbon group such as 1-bromomethyl group, 2-bromoethyl group, 2-chloroethyl group, 2-iodoethyl group, 3-bromopropyl group, 4-bromobutyl group, 1-bromobutyl group, 5-bromopentyl group, 6-bromohexyl group, 7-bromoheptyl group, 8-bromooctyl group, 9-bromononyl group, 10-bromodecyl group, 11-bromoundecyl group, 12-bromododecyl group, 13-bromotridecyl group, 14-bromotetradecyl group, 15-bromopentadecyl group, 16-bromohexadecyl group, 17-bromoheptadecyl group, 18-bromooctadecyl group, 19-bromononadecyl group, and 20-bromoeicosyl group; a cycloaliphatic hydrocarbon group such as 2-bromocyclopropyl group, 2-bromocyclopentyl group, and 4-bromocyclohexyl group, and the like.

The aryl group having 6 to 20 carbon atoms may be, for example, an aromatic hydrocarbon group such as a phenyl group, a tolyl group, an xylyl group, a benzyl group, a phenethyl group and the like. The hydrogen atom in the aryl group having 6 to 20 carbon atoms may also be substituted by a halogen atom. For example, the aryl group may be an aromatic hydrocarbon group such as a monobromophenyl group, a dibromophenyl group, a monochlorophenyl group, a monobromo tolyl group, a monobromoxylyl group, a monobromobenzyl group, a monobromophenethyl group and the like.

The alkylene group having 1 to 20 carbon atoms may be, for example, a linear alkylene group such as a methylene group, an ethylene group, a trimethylene group, a tetramethylene group, a pentamethylene group, a hexamethylene group, a heptamethylene group, and an octamethylene group; a branched alkylene group such as a propylene group, 2-methyl trimethylene group, and 2-methyltetramethylene group, and the like. The hydrogen atom in the alkylene group having 1 to 20 carbon atoms may be substituted by a halogen atom. For example, the alkylene group may be a monobromomethylene group, a monobromoethylene group, a monochloroethylene group, a monoiodo ethylene group, a dibromoethylene group, a monobromotrimethylene group, a monobromotetramethylene group, a monobromopentamethylene group, a monobromohexamethylene group, a monobromoheptamethylene group, a monobromooctamethylene group and the like.

The arylene group having 6 to 20 carbon atoms may be, for example, an aromatic hydrocarbon group such as a phenylene group, a tolylene group, an xylylene group, and the like. The hydrogen atom in the arylene group having 6 to 20 carbon atoms may be substituted by a halogen atom. For example, the arylene group may be an aromatic hydrocarbon group such as a monobromophenylene group, a monochlorophenylene group, a monobromotolylene group, a monobromoxylylene group, and the like.

P represents any one selected from a group consisting of —O— and —O—R₄₇—O—, R₄₇ represents an alkylene group having 1 to 20 carbon atoms, and the alkylene group optionally contains a hydroxyl group. The alkylene group having 1 to 20 carbon atoms may be, for example, a methylene group, an ethylene group, a propylene group, a butylene group, a pentylene group, a hexylene group, a hepthylene group, an octylene group, a nonylene group, a decylene group, and the like.

A unit represented by general formula (45) below and a unit represented by general formula (46) below are listed, in both of which R₄₇ is a hydroxy propylene group.

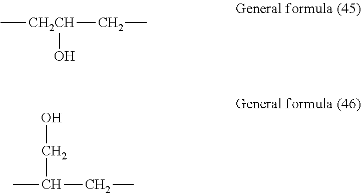

P is preferably —O—.

The alkylene group having 1 to 20 carbon atoms which optionally contains a hydroxyl group also includes a group in which the hydrogen atom is further substituted.

The monomer unit represented by general formula (a1-4) is originated from, for example, the monomers below.

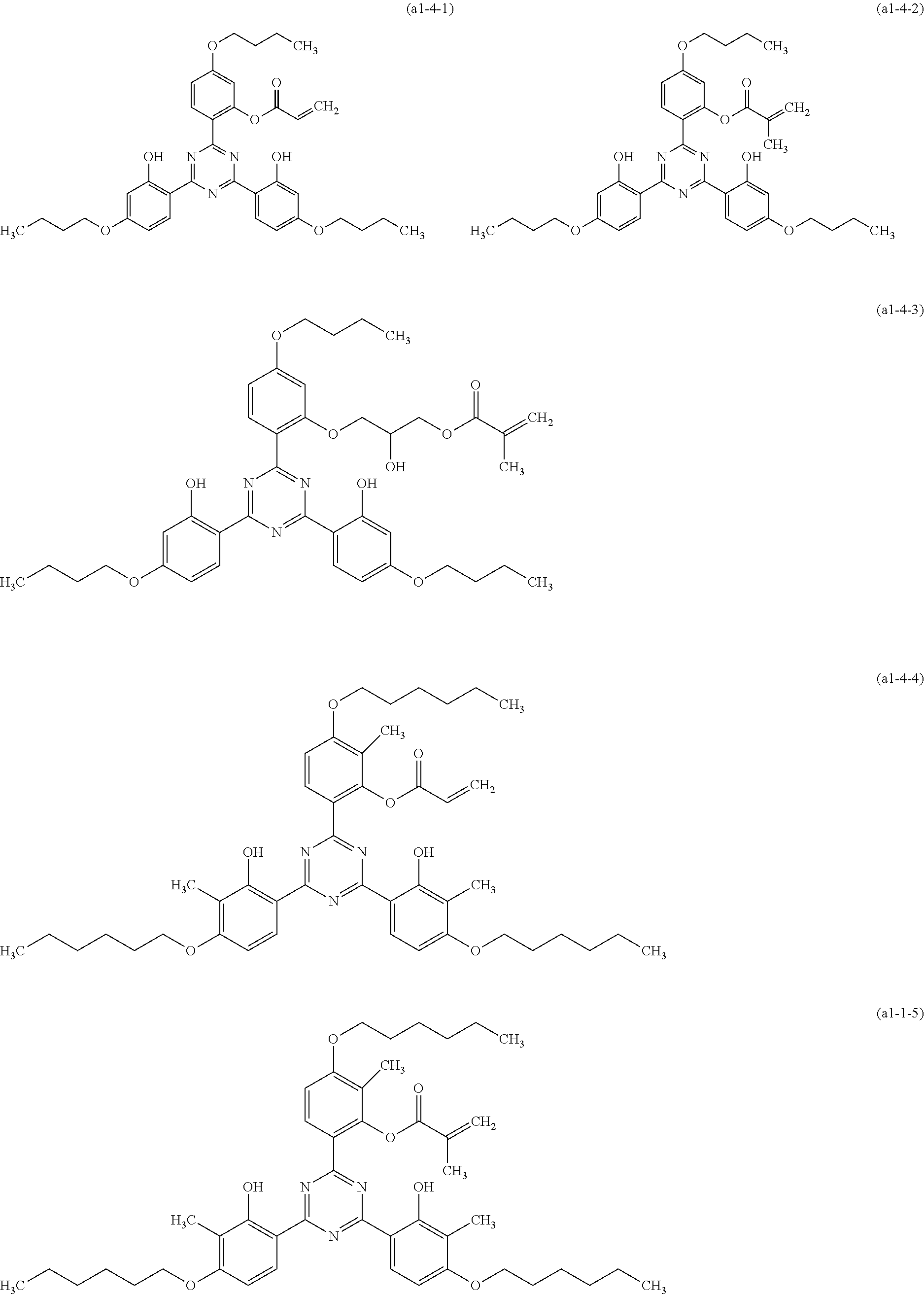

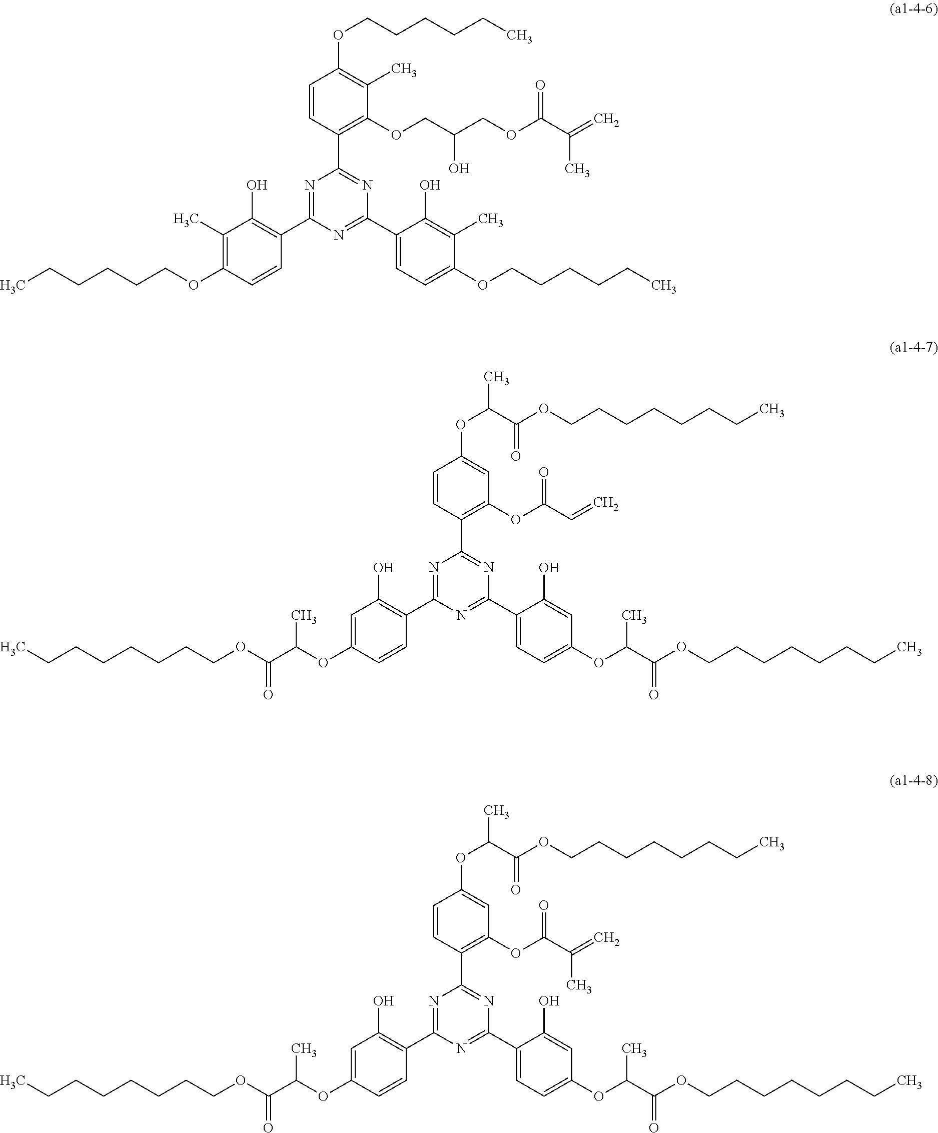

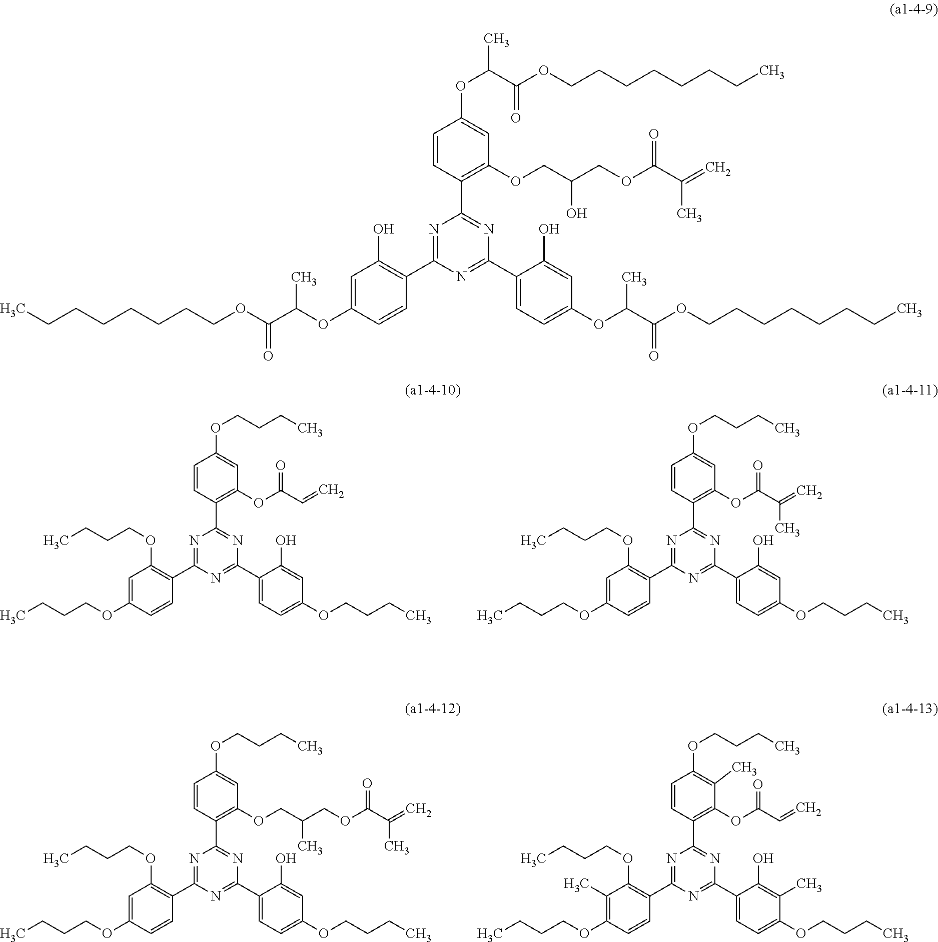

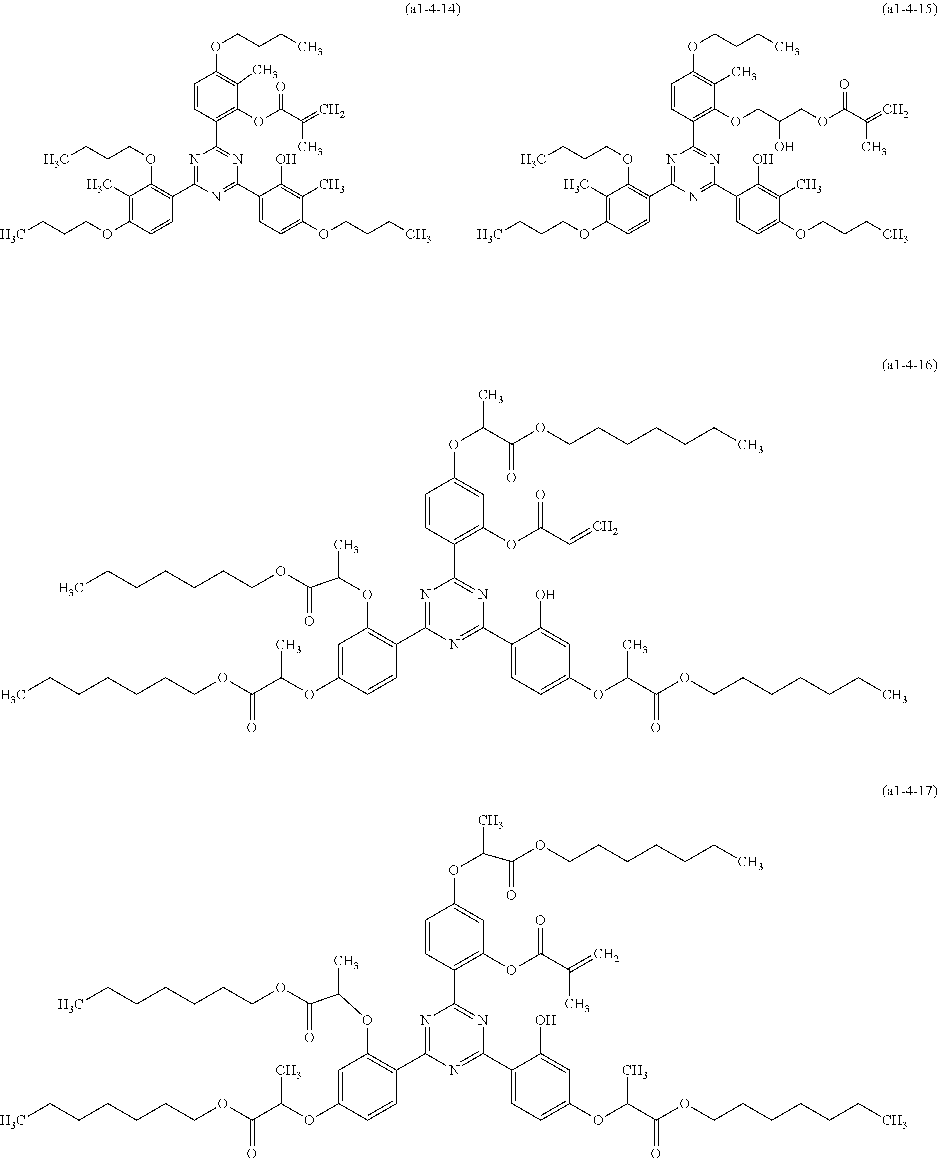

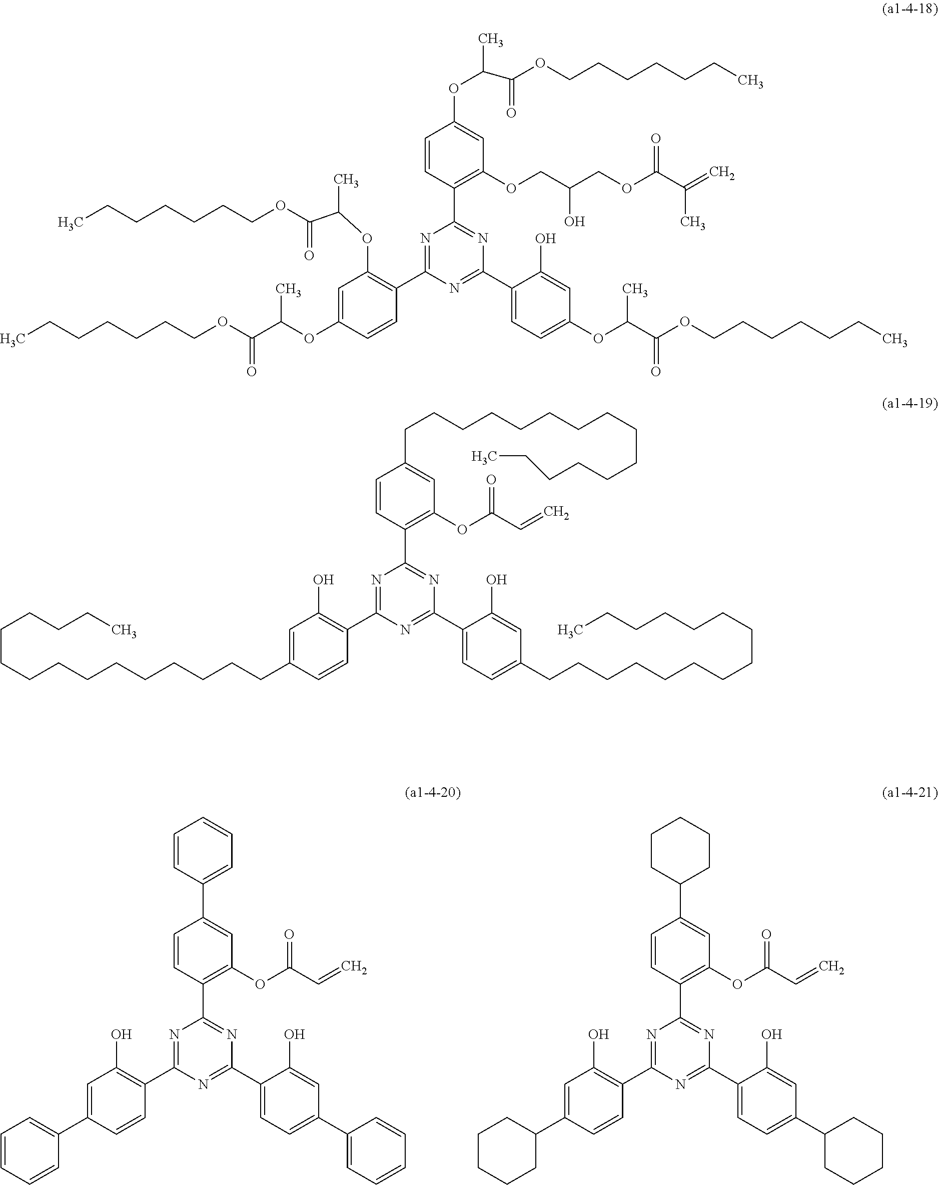

(Monomer Unit Containing Benzophenone Skeleton)

When U in general formula (16) is a benzophenone skeleton, a compound having a benzophenone skeleton and an ethylenic unsaturated group is preferable.

The monomer unit having a benzophenone skeleton is originated from, for example, monomers such as 4-acryloyloxy benzophenone, 4-methacryloyloxy benzophenone, 2-hydroxy-4-acryloyloxy benzophenone, 2-hydroxy-4-methacryloyloxy benzophenone, 2-hydroxy-4-(2-acryloyloxy)ethoxy benzophenone, 2-hydroxy-4-(2-methacryloyloxy)ethoxy benzophenone, 2-hydroxy-4-(2-methyl-2-acryloyloxy)ethoxy benzophenone, 2,2′-dihydroxy-4-methacryloyloxy benzophenone, and the like.

The monomer unit having a benzophenone skeleton may be used independently or in appropriate combination of two or more as necessary.

The monomer unit having a benzophenone skeleton is preferably 0.1 to 30 mass % and more preferably 1 to 30 mass % in the monomer units constituting the ultraviolet-ray absorbing polymer. With an appropriate content, decrease in other physical properties can be suppressed and the ultraviolet-ray absorbing property can be improved.

In addition, when the ultraviolet-ray absorbing polymer is a block polymer having block A, which is a polymer block containing a monomer unit represented by general formula (12), and block B, which is a polymer block containing a monomer unit derived from a monomer represented by general formula (1) (however, not containing the monomer unit represented by general formula (12)), the content of the monomer unit represented by general formula (12) is preferably 30 to 100 mass % and more preferably 50 to 100 mass % in block A. In addition, block B contains a (meth)acrylic acid ester unit. The (meth)acrylic acid ester unit is formed by polymerizing a known (meth)acrylic acid ester. Block B improves the intermiscibility of the formed body with a resin.

<General Formula (1)>

In general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

When Z is selected from a group consisting of a chain hydrocarbon group having 10 or more carbon atoms and a polycyclic hydrocarbon group having 10 or more carbon atoms, hydrophobicity is increased. Thereby, the ultraviolet-ray absorbing polymer has a higher affinity with the polyolefin having a high hydrophobicity, and thus the intermiscibility between the two is improved. Besides, the upper limit of the carbon number in Z is not limited, for example, the carbon number is preferably 30 or less, more preferably 22 or less, and further preferably 20 or less.

In general formula (1), the chain hydrocarbon group having 10 or more carbon atoms may be a linear structure linear structure, a branched structure or a cyclic structure. The chain hydrocarbon group may be, for example, an alkyl group such as a decyl group, an undecyl group, a dodecyl group, a tridecylgroup, a tetradecyl group, a pentadecyl group, a hexadecyl group, a heptadecyl group, an octadecyl group, a nonadecyl group, an eicosyl group, a hencosyl group, a docosyl group, a tricosyl group, a tetracosyl, and the like. The chain hydrocarbon group is preferably a branched structure, and more preferably an isostearyl group. Preferably, the carbon number in the hydrocarbon group of the linear structure and the branched structure is 14 or more.

The hydrocarbon group having a cyclic structure (also referred to as cyclic hydrocarbon group) may be a cycloaliphatic hydrocarbon group or a polycyclic hydrocarbon group. The cycloaliphatic hydrocarbon group is a group having one saturated or unsaturated carbon ring without aromatic properties, and the polycyclic hydrocarbon group is a group having a plurality of saturated or unsaturated carbon rings without aromatic properties.

The cycloaliphatic hydrocarbon group may be, for example, a cyclododecyl group and the like.

The polycyclic hydrocarbon group may be, for example, an isobornyl group, a dicyclopentanyl group, a dicyclopentenyl group, 2-methyl-2-adamantyl group, 2-ethyl-2-adamantyl group, and the like. In the cycloaliphatic hydrocarbon group and the polycyclic hydrocarbon group, the polycyclic hydrocarbon group is preferable, and a dicyclopentanyl group is more preferable.

The monomer unit composed of the monomer represented by general formula (1) is originated from, for example, monomers such as lauryl (meth)acrylate, isobornyl (meth)acrylate, stearyl (meth)acrylate, isostearyl (meth)acrylate, behenyl (meth)acrylate, dicyclopentanyl (meth)acrylate, dicyclopentenyl (meth)acrylate, 2-methyl-2-adamantyl (meth)acrylate, and 2-ethyl-2-adamantyl (meth)acrylate. In particular, isostearyl (meth)acrylate, dicyclopentanyl (meth)acrylate, dicyclopentenyl (meth)acrylate, and isobornyl (meth)acrylate are preferable, and dicyclopentanyl (meth)acrylate is further preferable.

The monomer unit derived from the monomer represented by general formula (1) may be used independently or in appropriate combination of two or more as necessary.

The content of the monomer unit derived from the monomer represented by general formula (1) is preferably 30 to 97 mass % and more preferably 40 to 80 mass % in in the monomer mixture. In addition, when the ultraviolet-ray absorbing polymer is a block polymer, the content of the monomer unit derived from the monomer represented by general formula (1) is preferably 30 to 100 mass % and more preferably 35 to 80 mass % in block B. With an appropriate content, the balance between the ultraviolet-ray absorbing property and the intermiscibility with polyolefin is easily achieved.

In addition, monomer unit other than the monomer unit represented by general formula (12) and the monomer unit derived from the monomer represented by general formula (1) may be included. (meth)acrylic acid ester capable of forming a (meth)acrylic acid ester unit other than the monomer unit derived from the monomer represented by general formula (1) may be, for example, methyl (meth)acrylate, ethyl (meth)acrylate, n-propyl (meth)acrylate, isopropyl (meth)acrylate, n-butyl(meth)acrylate, isobutyl(meth)acrylate, t-butyl (meth)acrylate, n-hexyl (meth)acrylate, cyclohexyl (meth)acrylate, t-butylcyclohexyl (meth)acrylate, 2-ethyl hexyl (meth)acrylate, t-octyl (meth)acrylate, dodecyl (meth)acrylate, octadecyl (meth)acrylate, acetoxyethyl (meth)acrylate, phenyl (meth)acrylate, 2-hydroxy ethyl (meth)acrylate, 2-methoxyethyl (meth)acrylate, 2-ethoxyethyl (meth)acrylate, 2-(2-methoxyethoxy)ethyl (meth)acrylate, 3-phenoxy-2-hydroxy propyl (meth)acrylate, benzyl (meth)acrylate, (meth)acrylate diethylene glycol monomethyl ether, (meth)acrylate diethyleneglycol monoethyl ether, (meth)acrylate triethylene glycol monomethyl ether, (meth)acrylate triethylene glycol monoethyl ether, (meth)acrylate polyethylene glycol monomethyl ether, (meth)acrylate polyethylene glycol monoethyl ether, β-phenoxyethoxyethyl (meth)acrylate, (meth)acrylate nonylphenoxypolyethylene glycol, dicyclopentenyl (meth)acrylate, dicyclopentenyl oxyethyl (meth)acrylate, trifluoroethyl (meth)acrylate, octafluoropentyl (meth)acrylate, perfulorooctylethyl (meth)acrylate, dicyclopentanyl (meth)acrylate, tribromophenyl (meth)acrylate, tribromophenyl oxyethyl, (meth)acrylate, and the like.

In addition, other than the (meth)acrylic acid ester unit, an aromatic vinyl monomer unit and other monomer units may be contained. When the monomer unit derived from the monomer represented by general formula (1) and an aromatic vinyl monomer unit are contained, the intermiscibility with polyolefin is further improved.

The aromatic vinyl monomer forming an aromatic vinyl monomer unit may be, for example, styrene, α-methylstyrene, vinyl benzoate, methyl vinylbenzoate, vinyltoluene, dimethylstyrene, trimethylstyrene, ethylstyrene, isopropylstyrene, butylstyrene, hydroxystyrene, methoxystyrene, butoxystyrene, acetoxystyrene, chlorostyrene, dichlorostyrene, bromostyrene, chloromethylstyrene, hydroxy styrene protected by a group capable of being deprotected using an acidic substance (for example, tert-butoxycarbonyl group (t-Boc)), and the like.

In particular, it is extremely preferable to use an aromatic vinyl monomer and a polycyclic hydrocarbon group in combination with the monomer mixture. Thereby, the intermiscibility with polyolefin is further improved.

The aromatic vinyl monomer may be used independently or in appropriate combination of two or more as necessary.

The content of the aromatic vinyl monomer is preferably 10 to 80 mass % and more preferably 20 to 70 mass % in 100 mass % of the monomer mixture. With an appropriate content, the intermiscibility with polyolefin is further improved.

Other monomer units are monomer units except those listed above, and the monomers forming other monomer units may be, for example, a crotonic acid ester, a vinyl ester, a maleic acid diester, a fumaric acid diester, an itaconic acid diester, a (meth)acrylamide, a vinyl ether, an ester of vinyl alcohol, styrene, (meth)acrylonitrile, an acid-group-containing monomer, and the like.

The crotonic acid ester may be, for example, butyl crotonate, hexyl crotonate, and the like.

The vinyl ester may be, for example, vinyl acetate, vinyl propionate, vinyl butyrate, vinyl methoxyacetate, and the like. The maleic acid diester may be, for example, dimethyl maleate, diethyl maleate, dibutyl maleate, and the like.

The fumaric acid diester may be, for example, dimethyl fumarate, diethyl fumarate, dibutyl fumarate, and the like.

The itaconic acid diester may be, for example, dimethyl itaconate, diethyl itaconate, dibutyl itaconate, and the like.

The (meth)acrylamide may be, for example, (meth)acrylamide, N-methyl (meth)acrylamide, N-ethyl (meth)acrylamide, N-propyl (meth)acrylamide, N-isopropyl (meth)acrylamide, N-n-butyl (meth)acrylamide, N-t-butyl (meth)acrylamide, N-cyclohexyl (meth)acrylamide, N-(2-methoxyethyl) (meth)acrylamide, N,N-dimethyl (meth)acrylamide, N,N-diethyl (meth)acrylamide, N-phenyl (meth)acrylamide, N-benzyl (meth)acrylamide, (meth)acryloyl morpholine, diacetone acrylamide, and the like.

The vinyl ether may be, for example, methyl vinyl ether, butylvinyl ether, hexylvinyl ether, methoxyethyl vinyl ether, and the like.

The acid-group-containing monomer may be, for example, an unsaturated monocarboxylic acid such as acrylic acid, methacrylic acid, crotonic acid, α-chloracrylic acid, and cinnamic acid; an unsaturated dicarboxylic acid or an anhydride thereof, such as maleic acid, maleic anhydride, fumaric acid, itaconic acid, itaconic anhydride, citraconic acid, citraconic anhydride, and mesaconic acid; an unsaturated polybasic carboxylic acid having three or more basics or an anhydride thereof; a mono[(meth)acrylyloxyalkyl] ester of a polybasic carboxylic acid having two or more basics, such as mono(2-acrylyloxyethyl) succinate, mono(2-methacrylyloxyethyl) succinate, mono(2-acrylyloxyethyl) phthalate, and mono(2-methacrylyloxyethyl) phthalate; a mono(meth)acrylate of a terminated carboxypolymer such as ω-carboxy-polycaprolactone monoacrylate, ω-carboxy-polycaprolactone monomethacrylate, and the like.

The monomers forming the other monomer units may be used independently or in appropriate combination of two or more as necessary.

The aforementioned optional monomer unit may be, for example, a monomer unit represented by general formula (5). Thereby, the photostability of the ultraviolet-ray absorbing polymer is further improved.

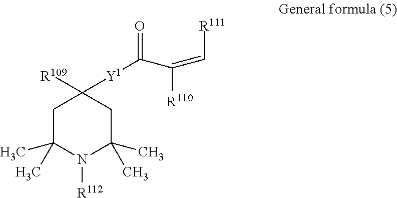

In general formula (5), R¹⁰⁹ represents any one selected from a group consisting of a hydrogen atom and a cyano group, R¹¹⁰ and R¹¹¹ independently represent any one selected from a group consisting of a hydrogen atom and a methyl group, R¹¹² represents any one selected from a group consisting of a hydrogen atom and a hydrocarbon group, and Y¹ represents any one selected from a group consisting of an oxygen atom and an imino group.

The polymer synthesised using the monomer unit represented by general formula (5) has an improved photostability due to the nitrogen-containing heterocyclic ring.

The monomer unit represented by general formula (5) may be originated from a monomer such as 4-(meth)acryloyloxy-2,2,6,6-tetramethylpiperidine, 4-(meth)acryloylamino-2,2,6,6-tetramethylpiperidine, pentamethylpiperidinyl methacrylate, pentamethylpiperidinyl acrylate, 4-(meth)acryloylamino-1,2,2,6,6-pentamethylpiperidine, 4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine and the like.

The monomer unit represented by general formula (5) may be used independently or in appropriate combination of two or more as necessary.

The content of the monomer unit represented by general formula (5) is preferably 3 to 40 mass %, more preferably 3 to 30 mass % and further preferably 5 to 25 mass % in 100 mass % of the monomer mixture. With an appropriate content, the balance between the photostability and the intermiscibility with polyolefin is easily achieved.

In addition, when the ultraviolet-ray absorbing polymer is a block polymer, the content of the monomer unit represented by general formula (5) is preferably 1 to 30 mass % and more preferably 5 to 25 mass % in each block. With an appropriate content, the photostability is improved, and the intermiscibility with polyolefin is further improved.

The ultraviolet-ray absorbing polymer is preferably synthesized by radical polymerization of block A and block B. The ultraviolet-ray absorbing polymer may be a block polymer having at least block A and block B and may be, but not limited to, for example, structures of AB, BAB, ABA and the like.

In the ultraviolet-ray absorbing polymer, the ratio of block A in the total of block A and block B is preferably 10 to 70 mass % and more preferably 30 to 60 mass %.

The method for synthesizing the block polymer is preferably living radical polymerization. Besides, as long as the ultraviolet-ray absorbing polymer is a block polymer having block A and block B, the synthesis method is not limited to living radical polymerization.

In addition, as described later, when the formation resin composition is manufactured containing the ultraviolet-ray absorbing polymer and polyolefin, the ultraviolet-ray absorbing polymer preferably contains the monomer unit represented by general formula (4) in the monomer components.

### General Formula (4)

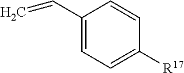

In general formula (4), R¹⁷ represents any one selected from a group consisting of a hydrogen atom and a hydrocarbon group having 1 to 8 carbon atoms.

The monomer unit represented by general formula (4) functions to secure the intermiscibility with polyolefin.

The monomer forming the monomer unit represented by general formula (4) is preferably styrene, vinyl toluene and the like.

From the viewpoint of securing intermiscibility, the total of the monomer unit represented by general formula (4) and the monomer unit derived from the monomer represented by general formula (1) is preferably 30 to 97 mass %, more preferably 30 to 90 mass % and further preferably 50 to 90 mass % in the monomer components.

The synthesis method of the ultraviolet-ray absorbing polymer may be anionic polymerization, living anionic polymerization, cationic polymerization, living cationic polymerization, free radical polymerization, and living radical polymerization. The ultraviolet-ray absorbing polymer is a random copolymer or a block copolymer, and is preferably a block copolymer. In addition, in the block copolymers, a copolymer synthesized by free radical polymerization, living radical polymerization is preferable.

Preferably, a polymerization initiator is used in free radical polymerization. The polymerization initiator is preferably an azo-type compound or a peroxide for example. The azo-type compound may be, for example, 2,2′-azobisisobutyronitrile, 2,2′-azobis(2-methylbutyronitrile), 1,1′-azobis(cyclohexanel-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate), 4,4′-azobis(4-cyanovaleric acid), 2,2′-azobis(2-hydroxy propionitrile), 2,2′-azobis[2-(2-imidazoline-2-yl)propane], or the like. The peroxide may be, for example, benzoyl peroxide, t-butyl peroxy benzoate, cumene hydroperoxide, diisopropyl peroxy dicarbonate, di-n-propyl peroxydicarbonate, di(2-ethoxyethyl)peroxy dicarbonate, t-butyl peroxyneodecanoate, t-butyl peroxypivalate, (3,5,5-trimethylhexanoyl)peroxide, dipropionyl peroxide, diacetyl peroxide, or the like.

The polymerization initiator may be used independently or in appropriate combination of two or more as necessary.

The reaction temperature for synthesis is preferably 40 to 150° C. and more preferably 50 to 110° C. The reaction time is preferably 3 to 30 hours and more preferably 5 to 20 hours.

In the living radical polymerization, a side reaction generated in a general radical polymerization is suppressed and the polymerization grows uniformly. Therefore, a block polymer or resins with uniform molecular weight can be easily synthesized.

In the living radical polymerization, the atom-transfer radical polymerization which uses an organic halide or a halogenated sulfonyl compound as the initiator and uses a transition metal complex as the catalysis preferable in that it can adapt to a wide range of monomers and a polymerization temperature adapted to existing equipment can be employed. The atom-transfer radical polymerization can be performed by methods put forth in the following reference literature 1 to 8.
(Reference literature 1) Fukuda, et al., Prog. Polym. Sci. 2004, 29, 329
(Reference literature 2) Matyjaszewski et a1., Chem. Rev. 2001, 101, 2921
(Reference literature 3) Matyjaszewski et a1., J. Am. Chem. Soc. 1995, 117, 5614
(Reference literature 4) Macromolecules 1995, 28, 7901, Science, 1996, 272, 866
(Reference literature 5) International Publication No. WO96/030421
(Reference literature 6) International Publication No. WO97/018247
(Reference literature 7) Japanese Patent Laid-Open No. 9-208616
(Reference literature 8) Japanese Patent Laid-Open No. 8-41117

The living radical polymerization (hereinafter, simply referred to as “living polymerization”) includes, for example, reversible addition-fragmentation chain transfer polymerization (hereinafter, referred to as RAFT polymerization), atom-transfer radical polymerization (hereinafter, referred to as ATRP), living polymerization using an iodine compound, living polymerization using an organic tellurium compound (hereinafter, referred to as TERP), and the like. In particular, the RAFT polymerization is preferable because the reaction operation is easy and a compound that contains heavy metal is not required. In addition, because the RAFT agent used in RAFT polymerization has an effect of absorbing ultraviolet rays, the ultraviolet-ray absorbing property of the ultraviolet-ray absorbing polymer is further improved.

The reaction temperature of the polymerization is preferably 40 to 150° C. and more preferably 50 to 110° C. The reaction time is preferably 3 to 30 hours and more preferably 5 to 20 hours.

The RAFT polymerization is a method of performing radical polymerization on a monomer under the existence of a RAFT agent, and the molecular weight and the molecular weight distribution of the polymer are easily controlled.

The RAFT agent is a compound having a chain transferring effect and a polymerization initiating effect and includes, for example, a dithiobenzoate type, a trithiocarbonate type, a dithiocarbamate type, a xanthate type, and a disulphide type which is a precursor of these types.

The dithiobenzoate type includes, for example, 2-cyano-2-propyl dithiobenzoate, 4-cyano-4-(thiobenzoylthio) pentanoic acid, 2-phenyl-2-propyl dithiobenzoate, and the like. The trithiocarbonate type includes, for example, 4-[(2-carboxyethyl sulfanylthiocarbonyl)sulfanyl]-4-cyanopentanoic acid, 2-{[(2-carboxyethyl)sulfanylthiocarbonyl]sulfanyl} propanic acid, 4-cyano-4-[(dodecylsulfanylthiocarbonyl)sulfanyl] pentanoic acid, 2-cyano-2-[(dodecylsulfanylthiocarbonyl)sulfanyl] propanic acid, 2-[(dodecylsulfanylthiocarbonyl)sulfanyl] propanic acid, methyl 4-cyano-4-[(dodecylsulfanylthiocarbonyl)sulfanyl] pentanoate, 2-methyl-2-[(dodecylsulfanylthiocarbonyl)sulfanyl] propanic acid, S,S-dibenzyltrithiocarbonic acid, bis[4-(allyloxycarbonyl)benzyl] trithiocarbonate, bis[4-(2,3-dihydroxy propoxycarbonyl)benzyl] trithiocarbonate, bis{4-[ethyl-(2-acetyloxyethyl)carbamoyl]benzyl}trithiocarbonate, bis{4-[ethyl-(2-hydroxy ethyl)carbamoyl]benzyl} trithiocarbonate, bis[4-(2-hydroxy ethoxycarbonyl)benzyl] trithiocarbonate, and the like.
The dithiocarbamate type includes, for example, 2′-cyanobutane-2′-yl 4-chloro-3,5-dimethylpyrazole-1-dithiocarbamate, 2′-cyanobutane-2′-yl 3,5-dimethylpyrazole-1-dithiocarbamate, cyanomethyl 3,5-dimethylpyrazole-1-dithiocarbamate, cyanomethyl N-methyl-N-phenyl dithiocarbamate, and the like.
The disulphide type includes bis(dodecylsulfanylthiocarbonyl) disulfide, bis(thiobenzoyl) disulphide and the like. These compounds are preferable for manufacturing of a block copolymer.

In particular, a trithiocarbonate compound which is easy to control in reaction during synthesis is preferable, and 4-cyano-4-[(dodecylsulfanylthiocarbonyl)sulfanyl] pentanoic acid, 2-cyano-2-[(dodecylsulfanylthiocarbonyl)sulfanyl] propanic acid, methyl 4-cyano-4-[(dodecylsulfanylthiocarbonyl)sulfanyl] pentanoate, bis{4-[ethyl-(2-hydroxy ethyl)carbamoyl]benzyl} trithiocarbonate, bis(dodecylsulfanylthiocarbonyl) disulphide are more preferable.

The amount of the RAFT agent used is preferably 0.1 to 10 parts by mass with respect to 100 parts by mass of the monomer.

Preferably, an organic solvent is used in the synthesis of the ultraviolet-ray absorbing polymer. The organic solvent may be, for example, ethyl acetate, n-butyl acetate, isobutyl acetate, toluene, xylene, acetone, hexane, methylethyl ketone, cyclohexanone, propyleneglycol monomethyl etheracetate, dipropyleneglycol monomethyl etheracetate, ethyleneglycol monoethyl etheracetate, ethyleneglycol monobutyl etheracetate, diethyleneglycol monoethyl etheracetate, diethyleneglycol monobutyl etheracetate, or the like.

The organic solvent may be used independently or in appropriate combination of two or more as necessary.

The mass average molecular weight of the ultraviolet-ray absorbing polymer is preferably 1,000 to 500,000, more preferably 3,000 to 100,000, further preferably 5,000 to 100,000, and particularly preferably 6,000 to 50,000. Besides, the mass average molecular weight is a numeric value measured by gel permeation chromatography (GPC).

The components having a weight average molecular weight equal to or lower than 1,000 is preferably 10% or less in the entire ultraviolet-ray absorbing polymer. Accordingly, the formed body (described later) made by using a formation resin composition containing the ultraviolet-ray absorbing polymer suppresses haze and migration, and the ultraviolet-ray absorbing effect is further improved.

The molecular weight distribution (Mw/Mn) is preferably 1.5 or lower. When the molecular weight distribution is 1.5 or lower, the intermiscibility with polyolefin is further improved, and the transparency is further improved too. Note that, Mn is the number average molecular weight.

The method for setting the components having a weight average molecular weight equal to or lower than 1,000 in the entire ultraviolet-ray absorbing polymer to 1% or less may be, for example, (1) a method of using living radical polymerization to synthesize a polymer having a sharp molecular weight distribution so as to suppress the components having a weight average molecular weight equal to or lower than 1,000, (2) a method of adding a poor solvent to the ultraviolet-ray absorbing polymer solution to perform liquid separation and suppress the components having a weight average molecular weight equal to or lower than 1,000, (3) a method of dripping the ultraviolet-ray absorbing polymer solution into a poor solvent and performing resedimentation, filtering and drying to suppress the components having a weight average molecular weight equal to or lower than 1,000. Note that, the method for setting the components having a weight average molecular weight equal to or lower than 1,000 in the entire ultraviolet-ray absorbing polymer to 1% or less is not limited to the above methods.

<Formation Resin Composition>

The formation resin composition contains the ultraviolet-ray absorbing polymer and a thermoplastic resin, and optionally contains a colorant and other additives as necessary. The thermoplastic resin may be, for example, polyolefin such as polyethylene and polypropylene, polystyrene, polyphenylene ether, acrylonitrile-butadiene-styrene copolymer (ABS resin), polycarbonate, polyamide, polyacetal, polyester, polyvinylchloride, a polyacrylic resin such as polymethyl methacrylate, and polyetherimide. Among these resins, although polyolefin is difficult to obtain a formed body having satisfactory transparency, satisfactory formation ability and mechanical strength of the formed product can be obtained. Hereinafter, the description is focused on polyolefin.

The blending amount of the ultraviolet-ray absorbing polymer is preferably 0.01 to 10 parts by mass with respect to 100 parts by mass of the polyolefin contained in the formed body.

(Polyolefin)

The polyolefin may be, for example, polyethylene, polypropylenepolyethylene, polypropylene, polybutene-1, poly-4-methylpentene, and copolymers thereof.

The number average molecular weight of the polyolefin is about 30,000 to 500,000, and is preferably 30,000 to 200,000.

The polyethylene may be, for example, low-density polyethylene and high-density polyethylene. The polypropylene may be, for example, crystalline or amorphous polypropylene.

The copolymer thereof may be, for example, a random, block or graft copolymer of ethylene-propylene, a copolymer of α-olefin with ethylene or propylene, an ethylene-vinyl acetate copolymer, an ethylene-methyl acrylate copolymer, an ethylene-ethyl acrylate copolymer, an ethylene-acrylic acid copolymer, and the like.
In particular, the crystalline or amorphous polypropylene and the random, block or graft copolymer of ethylene-propylene are preferable, and the propylene-ethylene block copolymer are further preferable. In addition, polypropylene is preferable because it is inexpensive and has a low specific gravity, thus being capable of obtaining a light-weighted formed body.

The melt flow rate (MFR) of the polyolefin is preferably 1 to 100 (g/10 min). Note that, the MFR is a numerical value obtained according to JISK-7210.

The formation resin composition may contain wax.

The wax may be, for example, polyethylene wax, polypropylene wax and the like. The melting point of the wax is preferably 50 to 180° C. and more preferably 80 to 170° C. Note that, the melting point of the wax is measured under a nitrogen atmosphere using a differential scanning calorimeter. Note that, polyolefin is a compound having a softening point but no melting point.

The number average molecular weight of the wax is preferably 500 to 25,000 and more preferably 1,000 to 15,000. Note that, the number average molecular weight is a numerical value measured according to JIS K2207: 1996 (Japanese Industrial Standard).

The blending amount of the wax is preferably 0.1 to 10 parts by mass with respect to 100 parts by mass of the polyolefin in the formed body described later.

The formation resin composition may be manufactured, for example, in the composition ratio of the formed body or as a master batch containing a high concentration of the ultraviolet-ray absorbing polymer, and is preferably manufactured as a master batch. Regarding the master batch, for example, it is preferable that a thermoplastic resin is melt-kneaded with a colorant such as a salt-forming compound and then formed into an arbitrary shape. Next, the master batch and a dilution resin (for example, the thermoplastic resin used in the master batch) is melt-kneaded and can be formed into a formed body having a desired shape. The shape of the master batch may be, for example, a pellet shape, powder, a plate shape and the like. Regarding the master batch, for example, the ultraviolet-ray absorbing polymer and polyolefin can be melt-kneaded and made into a pellet shape using a pelletizer. Moreover, in order to prevent aggregation of the ultraviolet-ray absorbing polymer, it is preferable to manufacture a dispersion in which the ultraviolet-ray absorbing polymer and wax are melt-kneaded, and then melt-knead the dispersion with polyolefin to manufacture the master batch. Here, the dispersion is preferably manufactured using a blend mixer, a three-roll mill or the like.

Compared with blending the ultraviolet-ray absorbing polymer in an amount equivalent to the amount contained in the formed body during formation, when the ultraviolet-ray absorbing polymer is predispersed as the master batch in a coloring formation resin composition and then blended (melt-kneaded) with a thermoplastic resin serving as the dilution resin to manufactured a desired formed body, the ultraviolet-ray absorbing polymer is easily dispersed uniformly in the formed body.

When the formation resin composition is manufactured as a master batch, the ultraviolet-ray absorbing polymer is preferably blended by 1 to 200 parts by mass and more preferably blended by 1 to 30 parts by mass with respect to 100 parts by mass of polyolefin. The mass ratio of the master batch (X) with respect to the dilution resin (Y) serving as the base resin of the formed body is preferably X/Y=10/1 to 1/100 and more preferably 1/5 to 1/100. Within this range, the formed body easily obtains a satisfactory ultraviolet-ray absorbing property and light transmittance.

The dilution resin (Y) is not limited to polyolefin, and a thermoplastic resin having a satisfactory intermiscibility with polyolefin can be appropriately selected and used.

The melt-kneading may be performed by, for example, a single-screw kneading extruder, a twin-screw kneading extruder, a tandem twin-screw kneading extruder and the like. The melt-kneading temperature varies depending on the type of the polyolefin, but is usually about 150 to 250° C.

The formation resin composition may further contain an antioxidant, a light stabilizer, a dispersant and the like as necessary.

The formation resin composition may contain a thermoplastic resin other than the ultraviolet-ray absorbing polymer and polyolefin. The thermoplastic resin other than polyolefin may be, for example, polycarbonate, a polyacrylic resin, polyester, a cycloolefin resin and the like.

<Polycarbonate>

Polycarbonate is a compound obtained by synthesizing a divalent phenol and a carbonate precursor using a known method. The divalent phenol may be, for example, hydroquinone, resorcinol, 2,2-bis(4-hydroxy phenyl) propane, bis(4-hydroxyphenyl) methane, 2,2-bis(4-hydroxy-3,5-dimethylphenyl) propane, 2,2-bis(4-hydroxy-3,5-dibromophenyl) propane, bis(4-hydroxyphenyl) sulphide and the like. In particular, bis(4-hydroxyphenyl) alkane is preferable, and 2,2-bis(4-hydroxy phenyl)propane, which is referred to as bisphenol A, is more preferable. The carbonate precursor may be, for example, phosgene, diphenyl carbonate, dihaloformate of divalent phenol and the like. In particular, diphenyl carbonate is preferable.

The divalent phenol and carbonate precursor may respectively be used independently or in appropriate combination of two or more as necessary.

<Polyacrylic Resin>

The polyacrylic resin is a compound obtained by polymerizing a monomer such as methyl methacrylate and/or ethyl methacrylate using a known method, and includes, for example, ethylene-methyl acrylate copolymer, ethylene-ethyl acrylatecopolymer, ethylene-acrylic acid copolymer and the like. In addition to the above monomers, for example, monomers such as butadiene, α-methylstyrene and maleic anhydride can also be added for polymerization, and heat resistance, flowability and impact resistance can be adjusted according to the monomer amount and the molecular weight.

<Polyester>

Polyester is a resin having an ester bond in the main-chain of the molecule, and includes a polycondensation product synthesized from a dicarboxylic acid (including derivatives thereof) and a diol (divalent alcohol or divalent phenol); a polycondensation product synthesized from a dicarboxylic acid (including derivatives thereof) and a cyclic ether compound; a ring-opening polymer of a cyclic ether compound, and the like. The polyester includes a homopolymer obtained from a polymer of a dicarboxylic acid and a diol, a copolymer using a plurality of raw materials, and a polymer blend in which the homopolymer and the copolymer are mixed. Besides, the derivatives of the dicarboxylic acid are anhydrides and esterified products. The dicarboxylic acid includes aliphatic dicarboxylic acids and aromatic dicarboxylic acids, and the aromatic dicarboxylic acids which improve heat resistance are more preferable.

The aromatic dicarboxylic acid includes, for example, terephthalic acid, isophthalic acid, phthalic acid, chlorphthalic acid, nitrophthalic acid, p-carboxylphenylacetic acid, m-phenylene diglycolic acid, p-phenylene diglycolic acid, diphenyldiacetic acid, diphenyl-p,p′-dicarboxylic acid, diphenyl-4,4′-diacetic acid, diphenyl methane-p,p′-dicarboxylic acid, diphenyl ethane-m,m′-dicarboxylic acid, stilbene dicarboxylic acid, diphenyl butane-p,p′-dicarboxylic acid, benzophenone-4,4′-dicarboxylic acid, naphthalin-1,4-dicarboxylic acid, naphthalin-1,5-dicarboxylic acid, naphthalin-2,6-dicarboxylic acid, naphthalin-2,7-dicarboxylic acid, p-carboxyphenoxyacetic acid, p-carboxyphenoxybutyric acid, 1,2-diphenoxypropane-p,p′-dicarboxylic acid, 1,5-diphenoxypentane-p,p′-dicarboxylic acid, 1,6-diphenoxyhexane-p,p′-dicarboxylic acid, p-(p-carboxyphenoxy) benzoic acid, 1,2-bis(2-methoxyphenoxy)-ethane-p,p′-dicarboxylic acid, 1,3-bis(2-methoxyphenoxy)propane-p,p′-dicarboxylic acid, 1,4-bis(2-methoxyphenoxy)butane-p,p′-dicarboxylic acid, 1,5-bis(2-methoxyphenoxy)-3-oxypentane-p,p′-dicarboxylic acid, and the like.

The aliphatic dicarboxylic acid includes, for example, oxalic acid, succinic acid, adipic acid, cholic acid, azelaic acid, sebacic acid, dodecane dicarboxylic acid, undecane dicarboxylic acid, maleic acid, fumaric acid, and the like.

The divalent alcohol includes, for example, ethylene glycol, trimethyleneglycol, butane-1,3-diol, butane-1,4-diol, 2,2-dimethylpropane-1,4-diol, cis-2-butene-1,4-diol, tetramethylene glycol, pentamethylene glycol, hexamethylene glycol, octamethylene glycol, decamethylene glycol, cyclohexane dimethanol, and the like. In particular, ethyleneglycol, butane-1,4-diol, and cyclohexane dimethanol are preferable.

The divalent phenol includes, for example, hydroquinone, resorcinol, bisphenol A and the like. The cyclic ether compound includes, for example, ethylene oxide, propylene oxide and the like.

The dicarboxylic acid or the divalent alcohol may respectively be used independently or in appropriate combination of two or more as necessary.

<Cycloolefin Resin>

The cycloolefin resin is a polymer of ethylene or α-olefin with cyclic olefin. The α-olefin is a monomer derived from α-olefin of C4 to C12 (having 4 to 12 carbon atoms), and includes, for example, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, and the like. The cyclic olefin is a monomer derived from norbornene, and includes products substituted by a hydryl grup, a halogen atom, or a monovalent or divalent hydrocarbon group. In particular, unsubstituted norbornene is preferable.

When the formation resin composition uses thermoplastic resins other than polyolefin, similar to the case in which polyolefin is used, it is also preferable to make the composition into a master batch. In addition, the manufacturing method, arbitrary components and the like of the master batch are the same as described above.

<Formed Body>

The formation resin composition is preferably used for, for example, food packaging materials, medicine packaging materials, and display application. The food packaging materials or medicine packaging materials preferably uses, for example, polyester and the like in the thermoplastic resins. These formed bodies have improved flexibility and visibility and can suppress the deterioration of the content. Accordingly, the shelf life of the medicine or cosmetics can be extended. In addition, the display application (for example, television, personal computer, smartphone, etc.) preferably use, for example, polyacrylic resin or polycarbonate in the thermoplastic resin. These formed bodies can absorb ultraviolet rays in the backlight or light in the short wavelength region of the visible light, and thereby suppress side effect to eyes. In addition, by absorbing the ultraviolet rays in the sunlight and the light in the short wavelength region of the visible light, deterioration of display elements of the display can be suppressed, and transparency decrease caused by migration can be suppressed. Furthermore, the formation resin composition can also be widely used in applications such as materials for displays, materials for sensors and optical control materials.

The formation resin composition contains the dilution resin (Y) in the case of master batch. The formed body is manufactured by forming the formation resin composition. The dilution resin (Y) is preferably the same resin as the resin used in the manufacturing of the master batch, but other resins can also be used as long as the problems can be solved.

The forming method includes, for example, extrusion forming, injection forming, blow forming and the like. The extrusion forming includes, for example, compression forming, pipe extrusion forming, laminate forming, T-die forming, inflation forming, melt spinning and the like.

The forming temperature depends on the softening point of the dilution resin and is usually 160 to 240° C.

Variation in blending does not easily occur even when the formed body is manufactured by high-speed extrusion forming (rotation speed of the screw of the forming machine: about 150 rpm) having a forming speed higher than normal extrusion forming, or manufactured by compression forming having a long no-shearing region. In particular, even in the high-speed compression forming (production speed is 500 pieces/min or more and may be 700 to 900 pieces/min in some cases) having a forming speed about 10 times that of the injection forming, variation in blending (colour unevenness, colour separation) does not easily occur in the formed product, and contamination of the content does not easily occur.

The compression forming is described as an example of the manufacturing method of the formed body. The compression forming is a manufacturing method of a molded product which includes steps of firstly melt-mixing the coloring formation resin composition of the present invention and putting the resin composition into a compression molding machine, then applying an extrusion force caused by compression but no shearing force in the compression molding machine to thereby obtain a molded product. Here, applying an extrusion force caused by compression but no shearing force means that the coloring formation resin composition exists in a state that no mixed force is applied to the coloring formation resin composition, that is, in a no-shearing region. Besides, in the present invention, the molded product is an article obtained by putting the resin into a mold. In addition, the formed product includes the molded product and an article which is obtained without using a mold, such as a plastic film.

The formed body can be widely used for, for example, application such as medical drugs, cosmetics, food containers, packaging materials, general goods, fiber products, medicine containers, industrial coating materials, automobile parts, household appliances, building materials of houses, toiletry products, and the like. Besides, the molded body is an article obtained by putting the resin into a mold. On the other hand, the formed body includes the molded body and an article which is obtained without using a mold, such as a plastic film.

The ultraviolet-ray absorbing polymer can be used for adhesive application. The adhesive preferably contains the ultraviolet-ray absorbing polymer and a curing agent. The ultraviolet-ray absorbing polymer is a polymer having a glass transition temperature of −60 to −20° C., which is synthesized by radical polymerization of an ultraviolet-ray absorbing unsaturated monomer, a (meth)acrylic acid ester and an acidic group containing monomer and/or a hydroxyl group containing monomer. Besides, the glass transition temperature is obtained by the FOX formula.

The hydroxyl group containing monomer includes, for example, 2-hydroxyethyl (meth)acrylate, 4-hydroxybutyl (meth)acrylate and the like.

The curing agent includes, for example, an isocyanate curing agent, an epoxy curing agent, an aziridine curing agent, a metal chelate curing agent and the like.

The adhesive can be coated on, for example, a release sheet and form an adhesive layer by drying, and then a substrate can be pasted on the adhesive layer to make an adhesive sheet.

In the display application (for example, television, personal computer, smartphone, etc.), the adhesive sheet is preferably pasted on the display for use. By containing the above ultraviolet-ray absorbing material, the adhesive sheet can absorb the ultraviolet rays in the backlight or the light in the short wavelength region of the visible light and suppress side effect to eyes. In addition, by absorbing the ultraviolet rays in the sunlight or the light in the short wavelength region of the visible light, deterioration of display elements of the display can be suppressed, and transparency decrease caused by migration can be suppressed.

The present invention is relevant to the subjects of Japanese Patent Application No. 2019-28618 filed on Feb. 20, 2019, Japanese Patent Application No. 2019-48496 filed on Mar. 15, 2019, Japanese Patent Application No. 2019-150888 filed on Aug. 21, 2019, and Japanese Patent Application No. 2019-150889 filed on Aug. 21, 2019, and the entire disclosure contents thereof are incorporated in the present specification by reference.

### Implementation Example

Hereinafter, the present invention is described in more detail by experimental examples, but the present invention is not limited to the experimental examples in a scope not departing from the technical ideas of the present invention. Besides, in the following, “part” means “part by mass”, and “%” means “mass %”.

(Molecular Weight)

The number average molecular weight (Mn) and the weight average molecular weight (Mw) are measured by gel permeation chromatograph (GPC) equipped with a RI detector. The device is HLC-8320GPC (manufactured by Tosoh Corporation), two separation columns are connected in series, the filler used in both columns is “TSK-GEL SUPERHZM-N”, the oven temperature is 40° C., THF solution is used as the eluent, and the measurement is performed at a flow rate of 0.35 ml/min. The sample is dissolved in a solvent consisting of 1 wt % of the eluent and 20 microliters of the sample is injected. Both of the molecular weights are values in terms of polystyrene.

### Experimental Example 1

The polyolefin used in this experimental example is shown below. Moreover, the number average molecular weights of all the polyolefin are in a range of 30,000 to 200,000.

(A-1): polyethylene (Suntec LD M2270, MFR=7 g/10 min, manufactured by Asahi Kasei Corporation)
(A-2): polyethylene (Novatec UJ790, MFR=50 g/10 min, manufactured by Japan polyethylene Corporation)
(A-3): polypropylene (Novatec PP FA3EB, MFR=10.5 g/10 min, manufactured by Japan Polypropylene Corporation)
(A-4): polypropylene (Prime Polypro J226T, MFR=20 g/10 min, manufactured by Prime Polymer Co., Ltd.)
(A-5): polyethylene (Evolue HSP65051B MFR=0.45 g/10 min, manufactured by Prime Polymer Co., Ltd.)

The wax used in this experimental example is shown below.

(D-1): polyethylene wax (Sanwax 131-P, number average molecular weight 3500, melting point 105° C., manufactured by Sanyo Chemical Industries Ltd.)
(D-2): polyethylene wax (Hi-Wax 405MP number average molecular weight 4500, melting point 120° C., manufactured by Mitsui Chemicals, Inc.)
(D-3): polypropylenewax (Hi-Wax NP056 number average molecular weight 7200, melting point 130° C., manufactured by Mitsui Chemicals, Inc.)

### Manufacturing Example of Ultraviolet-Ray Absorbing Polymer

### (Polymer (B-1))

75.0 parts of methylethyl ketone was added into a four-neck separable flask equipped with a thermometer, an agitator, a dropping funnel and a cooler, and the temperature was raised to 75° C. in a nitrogen stream. Additionally, 14 parts of RUVA-93 (manufactured by Otsuka Chemicals) as the monomer unit represented by general formula (a1-1), 43 parts of isostearyl acrylate as the monomer represented by general formula (1), 43 parts of methyl methacrylate, 5.0 parts of 2,2′-azobis(methyl isobutyrate), and 20.0 parts of methylethyl ketone were uniformly mixed and then added into the dropping funnel. Next, the content of the dropping funnel was dropped for 2 hours. After the dropping was completed, the reaction continued for 2 hours. Subsequently, sampling was performed and the polymerization yield was confirmed to be 98% or higher. The mixture was cooled to 50° C. and taken out to a Teflon (registered trademark) bat. Furthermore, the mixture was dried by a vacuum dryer under 50° C. for 12 hours, and polymer (B-1) was manufactured.

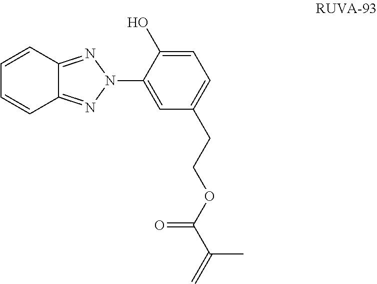 [SMILES: C=C(C)C(=O)OCCc1ccc(O)c(-n2nc3ccccc3n2)c1]

(Manufacturing of Polymer (B-2) to (B-27))

Except that the type of the monomer used in polymer (B-1) and the amount used were changed as described in Table 1, polymer (B-2) to polymer (B-27) were manufactured in the same manner as polymer (B-3).

TABLE 1

| | blending of ethylenic unsaturated monomer | | | | | | | |
|---|---|---|---|---|---|---|---|---|
| polymer | RUVA-93 | 14 | isostearyl acrylate | 43 | | | methyl | 43 |
| B-1 | | | | | | | methacrylate | |
| polymer | RUVA-93 | 14 | isostearyl acrylate | 43 | | | styrene | 43 |
| B-2 | | | | | | | | |
| polymer | RUVA-93 | 2 | isostearyl acrylate | 49 | | | methyl | 49 |
| B-3 | | | | | | | methacrylate | |
| polymer | RUVA-93 | 35 | isostearyl acrylate | 32 | | | methyl | 33 |
| B-4 | | | | | | | methacrylate | |
| polymer | ultraviolet-ray | 14 | isostearyl acrylate | 43 | | | methyl | 43 |
| B-5 | absorbing | | | | | | methacrylate | |
| | monomer 1 | | | | | | | |
| polymer | ultraviolet-ray | 14 | isostearyl acrylate | 43 | | | methyl | 43 |
| B-6 | absorbing | | | | | | methacrylate | |
| | monomer 2 | | | | | | | |
| polymer | RUVA-93 | 14 | stearyl acrylate | 43 | | | methyl | 43 |
| B-7 | | | | | | | methacrylate | |
| polymer | RUVA-93 | 14 | stearyl methacrylate | 43 | | | methyl | 43 |
| B-8 | | | | | | | methacrylate | |
| polymer | RUVA-93 | 14 | behenyl acrylate | 43 | | | methyl | 43 |
| B-9 | | | | | | | methacrylate | |
| polymer | RUVA-93 | 14 | dodecyl acrylate | 43 | | | methyl | 43 |
| B-10 | | | | | | | methacrylate | |
| polymer | RUVA-93 | 14 | isostearyl acrylate | 20 | | | methyl | 66 |
| B-11 | | | | | | | methacrylate | |
| polymer | RUVA-93 | 14 | isostearyl acrylate | 43 | Adekastab | 10 | methacrylate | 33 |
| B-12 | | | | | LA-82 | | methyl | |
| polymer | RUVA-93 | 14 | isostearyl acrylate | 43 | Adekastab | 2 | methyl | 41 |
| B-13 | | | | | LA-82 | | methacrylate | |
| polymer | RUVA-93 | 14 | isostearyl acrylate | 43 | Adekastab | 40 | methyl | 3 |
| B-14 | | | | | LA-82 | | methacrylate | |
| polymer | RUVA-93 | 14 | isostearyl acrylate | 43 | Adekastab | 10 | methyl | 33 |
| B-15 | | | | | LA-87 | | methacrylate | |
| polymer | RUVA-93 | 14 | dicyclopentanyl | 43 | | | methyl | 43 |
| B-16 | | | methacrylate | | | | methacrylate | |
| polymer | RUVA-93 | 14 | dicyclopentanyl | 43 | | | styrene | 43 |
| B-17 | | | methacrylate | | | | | |
| polymer | RUVA-93 | 14 | dicyclopentanyl acrylate | 43 | | | styrene | 43 |
| B-18 | | | | | | | | |
| polymer | RUVA-93 | 14 | dicyclopentenyl | 43 | | | styrene | 43 |
| B-19 | | | methacrylate | | | | | |
| polymer | RUVA-93 | 14 | dicyclopentenyl acrylate | 43 | | | styrene | 43 |
| B-20 | | | | | | | | |
| polymer | RUVA-93 | 14 | isobornyl acrylate | 43 | | | styrene | 43 |
| B-21 | | | | | | | | |
| polymer | RUVA-93 | 14 | isobornyl methacrylate | 43 | | | styrene | 43 |
| B-22 | | | | | | | | |
| polymer | RUVA-93 | 14 | 2-methyl-2-adamantyl | 43 | | | styrene | 43 |
| B-23 | | | methacrylate | | | | | |
| polymer | RUVA-93 | 14 | dicyclopentanyl acrylate | 43 | Adekastab | 10 | styrene | 33 |
| B-24 | | | | | LA-82 | | | |
| polymer | | | isostearyl acrylate | 50 | | | methyl | 50 |
| B-25 | | | | | | | methacrylate | |
| polymer | RUVA-93 | 14 | | | | | methyl | 86 |
| B-26 | | | | | | | methacrylate | |
| polymer | RUVA-93 | 14 | butyl acrylate | 43 | | | methyl | 43 |
| B-27 | | | | | | | methacrylate | |

Details of the terms in Table 1 are as follows.

ultraviolet-ray absorbing monomer 1:
2-[2′-hydroxy-3′-tert-butyl-5′-(methacryloyloxyethyl)
phenyl]-2H-benzotriazole
ultraviolet-ray absorbing monomer 2:
2-[2′-hydroxy-5′-(β-methacryloyloxyethoxy)-3′-tert-
butylphenyl]-4-tert-butyl-2H-benzotriazole

Adekastab LA-82 (manufactured by Adeka Corporation)

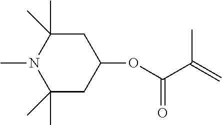 [SMILES: C=C(C)C(=O)OC1CC(C)(C)N(C)C(C)(C)C1]

Adekastab LA-87 (manufactured by Adeka Corporation)

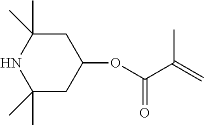 [SMILES: C=C(C)C(=O)OC1CC(C)(C)NC(C)(C)C1]

### Implementation Example 1

### [Manufacturing of Master Batch]

100 parts of wax (D-1) and 100 parts of polymer (B-1) were mixed, and a three-roll mill was used to knead at 160° C. so as to manufacture dispersion of polymer (B-1). Next, 10 parts of the obtained dispersion were mixed along with 100 parts of polyolefin (A-1) in a Henschel mixer. Next, the mixture was melt-kneaded at 180° C. by a single-screw extruder having a screw diameter of 30 mm, and a pelletizer was used to cut into a pellet shape so as to manufacture a master batch.

[Film Formation]

10 parts of the master batch manufactured was mixed with 100 parts of polyolefin (A-1) as a dilution resin. Next, a T-die formation machine (manufactured by Toyo Seiki) was used to melt-mix the mixture at a temperature of 180° C. and form a film having a thickness of 250 μm.

### Implementation Examples 2 to 53, Comparison Examples 1 to 4

Except that the materials of implementation example 1 are changed to the materials and the blending amount shown in Table 2, the master batch was manufactured in the same manner as implementation example 1. Next, films of implementation examples 2 to 53 and comparison examples 1 to 4 were respectively formed.

Details of the terms in Table 2 and Table 3 are as follows.

Adekastab LA-29 (manufactured by ADEKA)

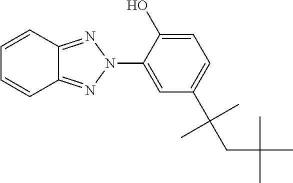 [SMILES: CC(C)(C)CC(C)(C)c1ccc(O)c(-n2nc3ccccc3n2)c1]

[Ultraviolet-Ray Absorbing Property]

The transmittance of the formed film was measured using an UV-VIS-NIR spectrophotometer (manufactured by Shimadzu Corporation). The transmittance was a spectral transmittance measured with respect to a white standard plate. An evaluation was made on whether the following conditions are satisfied. The evaluation criterion is as follows.

A: the light transmittance at the wavelength of 290 to 360 nm is lower than 2% across the entire region, satisfactory
B: regions in which the light transmittance is partially 2% or higher exist in the range of a wavelength of 290 to 360 nm, region of practical use
C: the light transmittance at the wavelength of 290 to 360 nm is 2% or higher across the entire region, not for practical use

[Transparency]

The transparency of the formed film was visually evaluated. The evaluation criterion is as follows.

AA: no turbidity is recognized, excellent
A: almost no turbidity is recognized, satisfactory
B: turbidity is slightly recognized, region of practical use
C: turbidity is clearly recognized, not for practical use

[Light Resistance Test]

The formed film was exposed for 1500 hours by a xenon weathermeter in an illumination of 60 W/m² at 300 to 400 nm. The evaluation criterion is as follows.

A: no yellowing is recognized, satisfactory
B: yellowing is slightly recognized, region of practical use
C: yellowing is clearly recognized, not for practical use

[Migration Evaluation]

The formed film was clamped by a soft vinylchloride sheet and was thermal-compression bonded using a heat press machine under conditions of a pressure of 100 g/cm², a temperature of 170° C. for 30 seconds. Next, the film was directly removed and migration to the soft vinylchloride sheet was evaluated using an UV-VIS-NIR spectrophotometer (manufactured by Shimadzu Corporation). The evaluation was performed by selecting five arbitrary points in the soft vinylchloride sheet subjected to the above processing, measuring the absorbance of the ultraviolet region and calculating the average value.

A: the absorbance at 280 to 480 nm is not detected (lower than 0.05), satisfactory
B: the absorbance at 280 to 480 nm is 0.05 or higher and 0.2 or lower, region of practical use
C: the absorbance at 280 to 480 nm is over 0.2, not for practical use

TABLE 2

| | manufacturing of master batch | | | | | | | | | | | | | |
|---|---|---|---|---|---|---|---|---|---|---|---|---|---|---|
| | manufacturing of dispersion | | | | | | | | | | | | | |
| | | | ultraviolet-ray | | | | | | | | | | | |
| | | | absorbing | | | | | manufacturing | | | ultraviolet- | | | |
| | | | polymer or | | | | | of T-die film | | | ray | | light | |
| | | | ultraviolet-ray | | disper- | poly- | | master | dilution | | absorbing | transpar- | resist- | migration |
| | wax | | absorber | | sion | olefin | | batch | resin | | property | ency | ance | evaluation |
| implementation example 1 | D-1 | 100 | B-1 | 100 | 10 | A-1 | 100 | 10 | A-1 | 100 | A | AA | B | A |
| implementation example 2 | D-1 | 100 | B-1 | 100 | 10 | A-2 | 100 | 10 | A-2 | 100 | A | AA | B | A |
| implementation example 3 | D-1 | 100 | B-1 | 100 | 10 | A-3 | 100 | 10 | A-3 | 100 | A | AA | B | A |
| implementation example 4 | D-1 | 100 | B-1 | 100 | 10 | A-4 | 100 | 10 | A-4 | 100 | A | AA | B | A |
| implementation example 5 | D-2 | 100 | B-1 | 100 | 10 | A-1 | 100 | 10 | A-1 | 100 | A | AA | B | A |
| implementation example 6 | D-3 | 100 | B-1 | 100 | 10 | A-1 | 100 | 10 | A-1 | 100 | A | AA | B | A |
| implementation example 7 | D-1 | 100 | B-2 | 100 | 10 | A-1 | 100 | 10 | A-1 | 100 | A | AA | B | A |
| implementation example 8 | D-1 | 100 | B-3 | 100 | 10 | A-1 | 100 | 10 | A-1 | 100 | B | AA | B | A |
| implementation example 9 | D-1 | 100 | B-4 | 100 | 10 | A-1 | 100 | 10 | A-1 | 100 | A | A | B | A |
| implementation example 10 | D-1 | 100 | B-5 | 100 | 10 | A-1 | 100 | 10 | A-1 | 100 | A | AA | B | A |
| implementation example 11 | D-1 | 100 | B-6 | 100 | 10 | A-1 | 100 | 10 | A-1 | 100 | A | AA | B | A |
| implementation example 12 | D-1 | 100 | B-7 | 100 | 10 | A-1 | 100 | 10 | A-1 | 100 | A | A | B | A |
| implementation example 13 | D-1 | 100 | B-8 | 100 | 10 | A-1 | 100 | 10 | A-1 | 100 | A | A | B | A |
| implementation example 14 | D-1 | 100 | B-9 | 100 | 10 | A-1 | 100 | 10 | A-1 | 100 | A | A | B | A |
| implementation example 15 | D-1 | 100 | B-10 | 100 | 10 | A-1 | 100 | 10 | A-1 | 100 | A | B | B | A |
| implementation example 16 | D-1 | 100 | B-11 | 100 | 10 | A-1 | 100 | 10 | A-1 | 100 | A | A | B | A |
| implementation example 17 | D-1 | 100 | B-12 | 100 | 10 | A-1 | 100 | 10 | A-1 | 100 | A | AA | A | A |
| implementation example 18 | D-1 | 100 | B-13 | 100 | 10 | A-1 | 100 | 10 | A-1 | 100 | A | AA | B | A |
| implementation example 19 | D-1 | 100 | B-14 | 100 | 10 | A-1 | 100 | 10 | A-1 | 100 | A | B | A | A |
| implementation example 20 | D-1 | 100 | B-15 | 100 | 10 | A-1 | 100 | 10 | A-1 | 100 | A | AA | A | A |
| implementation example 21 | D-1 | 100 | B-16 | 100 | 10 | A-1 | 100 | 10 | A-1 | 100 | A | AA | B | A |
| implementation example 22 | D-1 | 100 | B-17 | 100 | 10 | A-1 | 100 | 10 | A-1 | 100 | A | AA | B | A |
| implementation example 23 | D-1 | 100 | B-18 | 100 | 10 | A-1 | 100 | 10 | A-1 | 100 | A | AA | B | A |
| implementation example 24 | D-1 | 100 | B-19 | 100 | 10 | A-1 | 100 | 10 | A-1 | 100 | A | AA | B | A |
| implementation example 25 | D-1 | 100 | B-20 | 100 | 10 | A-1 | 100 | 10 | A-1 | 100 | A | AA | B | A |
| implementation example 26 | D-1 | 100 | B-21 | 100 | 10 | A-1 | 100 | 10 | A-1 | 100 | A | AA | B | A |
| implementation example 27 | D-1 | 100 | B-22 | 100 | 10 | A-1 | 100 | 10 | A-1 | 100 | A | AA | B | A |
| implementation example 28 | D-1 | 100 | B-23 | 100 | 10 | A-1 | 100 | 10 | A-1 | 100 | A | AA | B | A |

TABLE 3

| | manufacturing of master batch | | | | | | | | | | | | | |
|---|---|---|---|---|---|---|---|---|---|---|---|---|---|---|
| | manufacturing of dispersion | | | | | | | | | | | | | |
| | | | ultraviolet-ray | | | | | | | | | | | |
| | | | absorbing | | | | | manufacturing | | | ultraviolet- | | | |
| | | | polymer or | | | | | of T-die film | | | ray | | light | |
| | | | ultraviolet-ray | | disper- | poly- | | master | dilution | | absorbing | transpar- | resist- | migration |
| | wax | | absorber | | sion | olefin | | batch | resin | | property | ency | ance | evaluation |
| implementation example 29 | D-1 | 100 | B-24 | 100 | 10 | A-1 | 100 | 10 | A-1 | 100 | A | AA | A | A |
| implementation example 30 | D-1 | 100 | B-1 | 100 | 10 | A-5 | 100 | 10 | A-5 | 100 | A | A | B | A |
| implementation example 31 | D-1 | 100 | B-2 | 100 | 10 | A-5 | 100 | 10 | A-5 | 100 | A | A | B | A |
| implementation example 32 | D-1 | 100 | B-3 | 100 | 10 | A-5 | 100 | 10 | A-5 | 100 | B | A | B | A |
| implementation example 33 | D-1 | 100 | B-4 | 100 | 10 | A-5 | 100 | 10 | A-5 | 100 | A | B | B | A |
| implementation example 34 | D-1 | 100 | B-5 | 100 | 10 | A-5 | 100 | 10 | A-5 | 100 | A | A | B | A |
| implementation example 35 | D-1 | 100 | B-6 | 100 | 10 | A-5 | 100 | 10 | A-5 | 100 | A | A | B | A |
| implementation example 36 | D-1 | 100 | B-7 | 100 | 10 | A-5 | 100 | 10 | A-5 | 100 | A | B | B | A |
| implementation example 37 | D-1 | 100 | B-8 | 100 | 10 | A-5 | 100 | 10 | A-5 | 100 | A | B | B | A |
| implementation example 38 | D-1 | 100 | B-9 | 100 | 10 | A-5 | 100 | 10 | A-5 | 100 | A | B | B | A |
| implementation example 39 | D-1 | 100 | B-10 | 100 | 10 | A-5 | 100 | 10 | A-5 | 100 | A | B | B | A |
| implementation example 40 | D-1 | 100 | B-11 | 100 | 10 | A-5 | 100 | 10 | A-5 | 100 | A | B | B | A |
| implementation example 41 | D-1 | 100 | B-12 | 100 | 10 | A-5 | 100 | 10 | A-5 | 100 | A | A | A | A |
| implementation example 42 | D-1 | 100 | B-13 | 100 | 10 | A-5 | 100 | 10 | A-5 | 100 | A | A | B | A |
| implementation example 43 | D-1 | 100 | B-14 | 100 | 10 | A-5 | 100 | 10 | A-5 | 100 | A | B | A | A |
| implementation example 44 | D-1 | 100 | B-15 | 100 | 10 | A-5 | 100 | 10 | A-5 | 100 | A | A | A | A |
| implementation example 45 | D-1 | 100 | B-16 | 100 | 10 | A-5 | 100 | 10 | A-5 | 100 | A | A | B | A |
| implementation example 46 | D-1 | 100 | B-17 | 100 | 10 | A-5 | 100 | 10 | A-5 | 100 | A | AA | B | A |
| implementation example 47 | D-1 | 100 | B-18 | 100 | 10 | A-5 | 100 | 10 | A-5 | 100 | A | AA | B | A |
| implementation example 48 | D-1 | 100 | B-19 | 100 | 10 | A-5 | 100 | 10 | A-5 | 100 | A | AA | B | A |
| implementation example 49 | D-1 | 100 | B-20 | 100 | 10 | A-5 | 100 | 10 | A-5 | 100 | A | AA | B | A |
| implementation example 50 | D-1 | 100 | B-21 | 100 | 10 | A-5 | 100 | 10 | A-5 | 100 | A | AA | B | A |
| implementation example 51 | D-1 | 100 | B-22 | 100 | 10 | A-5 | 100 | 10 | A-5 | 100 | A | AA | B | A |
| implementation example 52 | D-1 | 100 | B-23 | 100 | 10 | A-5 | 100 | 10 | A-5 | 100 | A | AA | B | A |
| implementation example 53 | D-1 | 100 | B-24 | 100 | 10 | A-5 | 100 | 10 | A-5 | 100 | A | AA | A | A |
| comparison example 1 | D-1 | 100 | B-25 | 100 | 10 | A-1 | 100 | 10 | A-1 | 100 | C | AA | B | A |
| comparison example 2 | D-1 | 100 | B-26 | 100 | 10 | A-1 | 100 | 10 | A-1 | 100 | A | C | B | C |
| comparison example 3 | D-1 | 100 | B-27 | 100 | 10 | A-1 | 100 | 10 | A-1 | 100 | A | C | B | C |
| comparison example 4 | D-1 | 100 | Adekastab | 14 | 5.7 | A-1 | 100 | 10 | A-1 | 100 | A | AA | A | C |
| | | | LA-29 | | | | | | | | | | | |

### Experimental Example 2

The polyolefin used in this experimental example (number average molecular weight 30,000 or higher) is shown below.
(C-1): polyethylene (Suntec LD M2270, MFR=7 g/10 min, manufactured by Asahi Kasei Corporation)
(C-2): polyethylene (Novatec UJ790, MFR=50 g/10 min, manufactured by Japan polyethylene Corporation)
(C-3): polypropylene (Novatec PP FA3EB, MFR=10.5 g/10 min, manufactured by Japan Polypropylene Corporation)
(C-4): polypropylene (Prime Polypro J226T, MFR=20 g/10 min, manufactured by Prime Polymer Co., Ltd.)

The wax used in this experimental example is the same as wax (D-1) to (D-3) shown in experimental example 1.

Furthermore, thermoplastic resins other than the polyolefin used in this experimental example are shown below.

(E-1): polycarbonate (Iupilon S3000, MFR=15 g/10 min, manufactured by Mitsubishi Engineering-Plastics)
(E-2): polymethacrylic resin (ACRYPET MF, MFR=14 g/10 min, manufactured by Mitsubishi Rayon)
(E-3): polyester (Mitsui PET SA135, manufactured by Mitsui Chemicals, Inc.)
(E-4): cycloolefin resin (TOPAS5013L-10, manufactured by Mitsui Chemicals, Inc.)

[Manufacturing Example of Ultraviolet-Ray Absorbing Unsaturated Monomer]

### (Ultraviolet-Ray Absorbing Unsaturated Monomer (A-1))

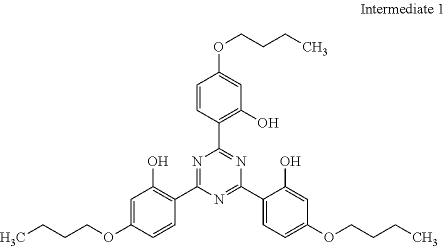 [SMILES: CCCCOc1ccc(-c2nc(-c3ccc(OCCCC)cc3O)nc(-c3ccc(OCCCC)cc3O)n2)c(O)c1]

The above intermediate 1 was synthesized according to the synthesis method in the implementation example of Japanese Patent Laid-Open No. 11-71356 or National Publication of International Patent Application No. 2018-504479, taking cyanuric chloride and 3-butoxyphenol as the raw material. Subsequently, 100 g of tetrahydrofuran and 28.6 mmol of intermediate 1 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added to a 500 mL beaker and agitated, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-1) was manufactured.

(Ultraviolet-Ray Absorbing Unsaturated Monomer (A-2))

Except that methacryloyl chloride was dropped instead of acryloyl chloride in the manufacturing of ultraviolet-ray absorbing unsaturated monomer (A-1), ultraviolet-ray absorbing unsaturated monomer (A-2) was manufactured by the same method.

(Ultraviolet-Ray Absorbing Unsaturated Monomer (A-3))

The following reaction was performed using intermediate 1 in the manufacturing of ultraviolet-ray absorbing unsaturated monomer (A-1). 100 g of N-methylpyrrolidone, 28.6 mmol of intermediate 1 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-3) was manufactured.

(Ultraviolet-Ray Absorbing Unsaturated Monomer (A-4))

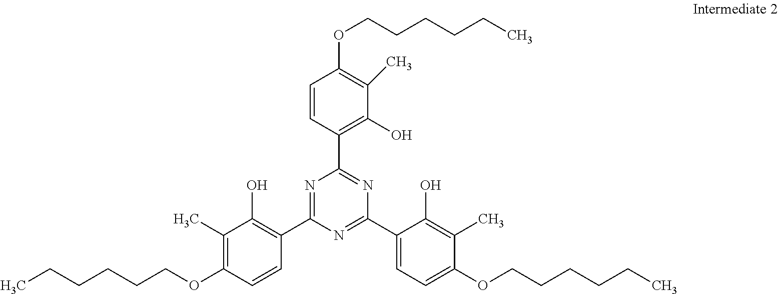 [SMILES: CCCCCCOc1ccc(-c2nc(-c3ccc(OCCCCCC)c(C)c3O)nc(-c3ccc(OCCCCCC)c(C)c3O)n2)c(O)c1C]

The above intermediate 2 was synthesized according to the synthesis method in the implementation example of Japanese Patent Laid-Open No. 11-71356 or National Publication of International Patent Application No. 2018-504479, taking cyanuric chloride, 2-methyl resorcinol and 1-bromohexane as the raw material. Subsequently, 100 g of tetrahydrofuran and 28.6 mmol of intermediate 2 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-4) was manufactured.

NMR measurement was performed on ultraviolet-ray absorbing unsaturated monomer (A-4), and a result supporting the above structure was obtained. The measurement conditions are as follows.

### <Measurement Condition>

device: BRUKER AVANCE400
resonance frequency: 400 MHz (¹H-NMR)
solvent: tetrahydrofuran-d8
Tetramethylsilane was used as the internal standard substance of 1H-NMR, the chemical shift value was represented by 6 value (ppm), and the coupling constant was represented by Hertz. In addition, s is short for singlet, d for doublet, dd for doubledoublet, t for triplet, and m for multiplet. The content of the obtained NMR spectrum is as follows.

δ=13.39 (s, 2H, —OH), 8.34 (d, 2H, J=9.0 Hz, phenyl-H), 8.11 (d, 1H, J=9.0 Hz, phenyl-H), 7.11 (d, 1H, J=9.0 Hz, phenyl-H), 6.67 (d, 2H, J=9.0 Hz, phenyl-H), 6.52 (d, 1H, J=3.2 Hz, —CH═CHH), 6.52 (d, 1H, J=8.8 Hz, —CH═CHH), 5.94 (dd, 1H, J=8.8 Hz, J=3.2 Hz, —CH═CHH), 4.19 (t, 2H, J=6.4 Hz, —O—CH₂—CH₂—), 4.13 (t, 4H, J=6.4 Hz, —O—CH₂—CH₂—), 2.19 (s, 6H, phenyl-CH3), 2.16 (s, 3H, phenyl-CH3), 1.84-1.94 (m, 6H, —O—CH₂—CH₂—), 1.54-1.62 (m, 6H, —O—CH₂—CH₂—CH₂—), 1.38-1.47 (m, 12H, —O—CH₂—CH₂—CH₂—CH₂—CH₂—CH₃), 0.95-1.00 (m, 9H, —O—CH₂—CH₂—CH₂—CH₂—CH₂—CH₃)

As described above, in this experimental example, the structure identification of ultraviolet-ray absorbing unsaturated monomer (A-4) by NMR was described as an example. The structure identification of other ultraviolet-ray absorbing unsaturated monomers are also performed by NMR in the same manner as that of ultraviolet-ray absorbing unsaturated monomer (A-4), and the data is omitted.

(Ultraviolet-Ray Absorbing Unsaturated Monomer (A-5))

Except that methacryloyl chloride is dropped instead of acryloyl chloride in the manufacturing of ultraviolet-ray absorbing unsaturated monomer (A-4), ultraviolet-ray absorbing unsaturated monomer (A-5) was manufactured by the same method.

(Ultraviolet-Ray Absorbing Unsaturated Monomer (A-6))

100 g of N-methylpyrrolidone, 28.6 mmol of intermediate 2 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer is precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-6) was manufactured.

(Ultraviolet-Ray Absorbing Unsaturated Monomer (A-7))

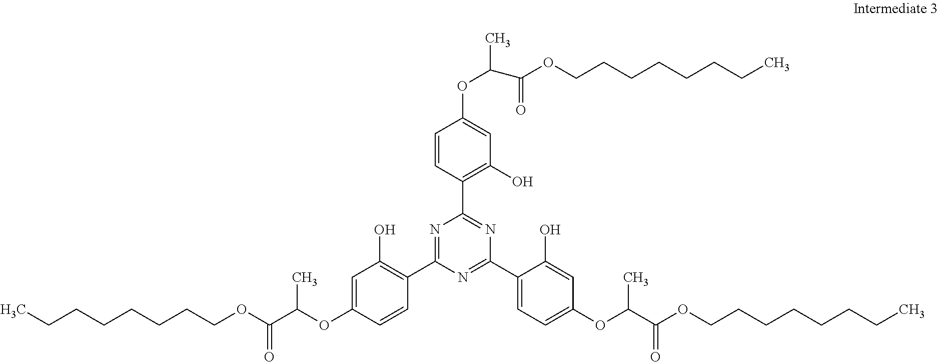 [SMILES: CCCCCCCCOC(=O)C(C)Oc1ccc(-c2nc(-c3ccc(OC(C)C(=O)OCCCCCCCC)cc3O)nc(-c3ccc(OC(C)C(=O)OCCCCCCCC)cc3O)n2)c(O)c1]

The above intermediate 3 was synthesized according to the synthesis method in the implementation example of International Publication No. 2001/047900 and so on, taking cyanuric chloride, resorcinol, 2-bromopropionic acid and 1-octanol as the raw material. Subsequently, 100 g of tetrahydrofuran and 28.6 mmol of intermediate 3 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-7) was manufactured.

(Ultraviolet-Ray Absorbing Unsaturated Monomer (A-8))

Except that methacryloyl chloride was dropped instead of acryloyl chloride in the manufacturing of ultraviolet-ray absorbing unsaturated monomer (A-7), ultraviolet-ray absorbing unsaturated monomer (A-8) was manufactured by the same method.

(Ultraviolet-Ray Absorbing Unsaturated Monomer (A-9))

100 g of N-methylpyrrolidone, 28.6 mmol of intermediate 3 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer is precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-9) was manufactured.

(Ultraviolet-Ray Absorbing Unsaturated Monomer (A-10))

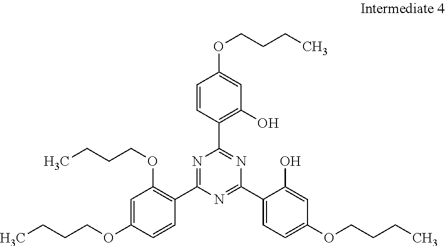 [SMILES: CCCCOc1ccc(-c2nc(-c3ccc(OCCCC)cc3O)nc(-c3ccc(OCCCC)cc3OCCCC)n2)c(O)c1]

The above intermediate 4 was synthesized according to the synthesis method in the implementation example of Japanese Patent Laid-Open No. 11-71356 or National Publication of International Patent Application No. 2018-504479, taking cyanuric chloride, resorcinol and 1-bromobutane as the raw material. Subsequently, 100 g of tetrahydrofuran and 28.6 mmol of intermediate 4 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-10) was manufactured.

(Ultraviolet-Ray Absorbing Unsaturated Monomer (A-11))

Except that methacryloyl chloride was dropped instead of acryloyl chloride in the manufacturing of ultraviolet-ray absorbing unsaturated monomer (A-10), ultraviolet-ray absorbing unsaturated monomer (A-11) was manufactured by the same method.

(Ultraviolet-Ray Absorbing Unsaturated Monomer (A-12))

100 g of N-methylpyrrolidone, 28.6 mmol of intermediate 4 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer is precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-12) was manufactured.

(Ultraviolet-Ray Absorbing Unsaturated Monomer (A-13))

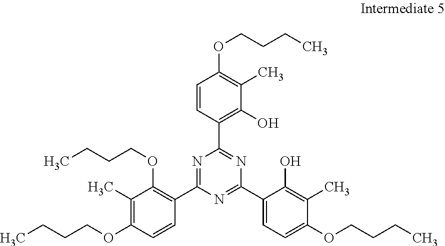 [SMILES: CCCCOc1ccc(-c2nc(-c3ccc(OCCCC)c(C)c3O)nc(-c3ccc(OCCCC)c(C)c3OCCCC)n2)c(O)c1C]

The above intermediate 5 was synthesized according to the synthesis method in the implementation example of Japanese Patent Laid-Open No. 11-71356 or National Publication of International Patent Application No. 2018-504479, taking cyanuric chloride, 2-methyl resorcinol and 1-bromobutane as the raw material. Subsequently, 100 g of tetrahydrofuran and 28.6 mmol of intermediate 5 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-13) was manufactured.

(Ultraviolet-Ray Absorbing Unsaturated Monomer (A-14))

Except that methacryloyl chloride was dropped instead of acryloyl chloride in the manufacturing of ultraviolet-ray absorbing unsaturated monomer (A-13), ultraviolet-ray absorbing unsaturated monomer (A-14) was manufactured by the same method.

(Ultraviolet-Ray Absorbing Unsaturated Monomer (A-15))

The following reaction was performed using intermediate 5 in the manufacturing of ultraviolet-ray absorbing unsaturated monomer (A-13). 100 g of N-methylpyrrolidone, 28.6 mmol of intermediate 5 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer is precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-15) was manufactured.

(Ultraviolet-Ray Absorbing Unsaturated Monomer (A-16))

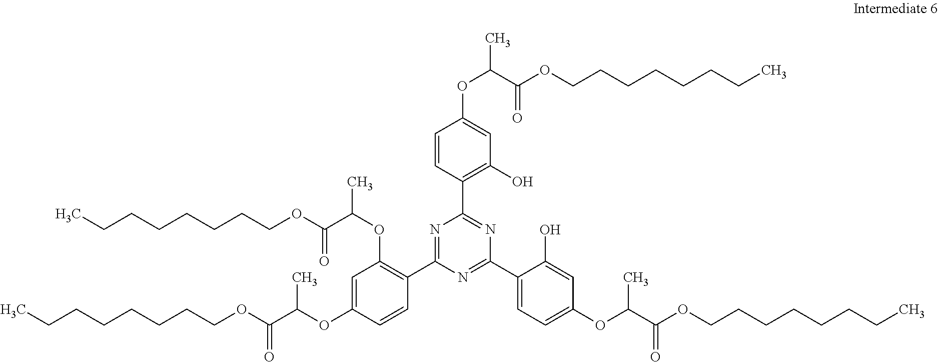 [SMILES: CCCCCCCCOC(=O)C(C)Oc1ccc(-c2nc(-c3ccc(OC(C)C(=O)OCCCCCCCC)cc3O)nc(-c3ccc(OC(C)C(=O)OCCCCCCCC)cc3OC(C)C(=O)OCCCCCCCC)n2)c(O)c1]

The above intermediate 6 was synthesized according to the synthesis method in the implementation example of International Publication No. 2001/047900 and so on, taking cyanuric chloride, resorcinol, 2-bromopropionic acid and 1-octanol as the raw material. Subsequently, 100 g of tetrahydrofuran and 28.6 mmol of intermediate 6 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-16) was manufactured.

(Ultraviolet-Ray Absorbing Unsaturated Monomer (A-17))

Except that methacryloyl chloride was dropped instead of acryloyl chloride in the manufacturing of ultraviolet-ray absorbing unsaturated monomer (A-16), ultraviolet-ray absorbing unsaturated monomer (A-17) was manufactured by the same method.

(Ultraviolet-Ray Absorbing Unsaturated Monomer (A-18))

The following reaction was performed using intermediate 6 in the manufacturing of ultraviolet-ray absorbing unsaturated monomer (A-16). 100 g of N-methylpyrrolidone, 28.6 mmol of intermediate 6 and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, an ultraviolet-ray absorbing unsaturated monomer is precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-18) was manufactured.

(Ultraviolet-Ray Absorbing Unsaturated Monomer (A-19))

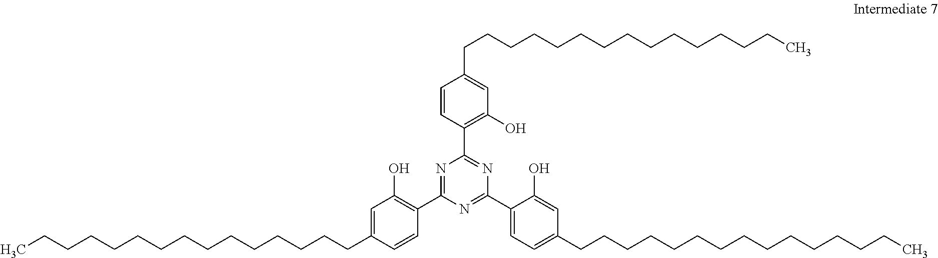 [SMILES: CCCCCCCCCCCCCCCc1ccc(-c2nc(-c3ccc(CCCCCCCCCCCCCCC)cc3O)nc(-c3ccc(CCCCCCCCCCCCCCC)cc3O)n2)c(O)c1]

The above intermediate 7 was synthesized according to the synthesis method in the implementation example of Japanese Patent Laid-Open No. 11-71356 or National Publication of International Patent Application No. 2018-504479, taking cyanuric chloride and 3-pentadecylphenol as the raw material. Subsequently, 100 g of tetrahydrofuran and 28.6 mmol of intermediate 7 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-19) was manufactured.

(Ultraviolet-Ray Absorbing Unsaturated Monomer (A-20))

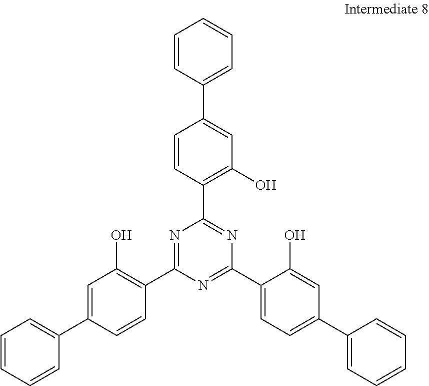 [SMILES: Oc1cc(-c2ccccc2)ccc1-c1nc(-c2ccc(-c3ccccc3)cc2O)nc(-c2ccc(-c3ccccc3)cc2O)n1]

The above intermediate 8 was synthesized according to the synthesis method in the implementation example of Japanese Patent Laid-Open No. 11-71356 or National Publication of International Patent Application No. 2018-504479, taking cyanuric chloride and 3-phenyl phenol as the raw material. Subsequently, 100 g of tetrahydrofuran and 28.6 mmol of intermediate 8 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-20) was manufactured.

(Ultraviolet-Ray Absorbing Unsaturated Monomer (A-21))

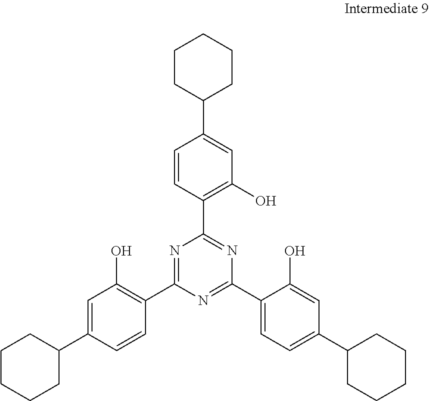 [SMILES: Oc1cc(C2CCCCC2)ccc1-c1nc(-c2ccc(C3CCCCC3)cc2O)nc(-c2ccc(C3CCCCC3)cc2O)n1]

The above intermediate 9 was synthesized according to the synthesis method in the implementation example of Japanese Patent Laid-Open No. 11-71356 or National Publication of International Patent Application No. 2018-504479, taking cyanuric chloride and 3-cyclohexyl-phenol as the raw material. Subsequently, 100 g of tetrahydrofuran and 28.6 mmol of intermediate 9 were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing unsaturated monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing unsaturated monomer (A-21) was manufactured.

[Manufacturing Example of Ultraviolet-Ray Absorbing Polymer]

### (Ultraviolet-Ray Absorbing Polymer (B-1))

75.0 parts of methylethyl ketone was added into a four-neck separable flask equipped with a thermometer, an agitator, a distillation tube and a cooler and the temperature was raised to 75° C. in a nitrogen stream. Additionally, 10 parts of ultraviolet-ray absorbing unsaturated monomer (A-1), 45 parts of dicyclopentanyl methacrylate, 45 parts of styrene, 5.0 parts of 2,2′-azobis(methyl isobutyrate) and 20.0 parts of methylethyl ketone were made uniform and added into a dropping funnel, then attached to the four-neck separable flask and dropped for two hours. Two hours after the dropping was completed, it was confirmed from the solid content that the polymerization yield is 98% or higher, and the temperature was reduced to 50° C. Accordingly, ultraviolet-ray absorbing polymer (B-1) having 50 mass % of nonvolatile content was manufactured.

(Ultraviolet-Ray Absorbing Polymer (B-2) to (B-32))

As shown in Table 4, (B-2) to (B-32) were manufactured in the same manner as ultraviolet-ray absorbing polymer (B-1).

Besides, Adekastab LA-82 (manufactured by ADEKA), which is the unsaturated monomer shown in experimental example 1, was also used.

(Ultraviolet-Ray Absorbing Polymer (B-33))

9.0 parts of methylethyl ketone was added into a four-neck separable flask equipped with a thermometer, an agitator, a dropping funnel and a cooler, 1.0 part of methyl 4-cyano-4-[(dodecylsulfanylthiocarbonyl)sulfanyl] pentanoate and 10.0 parts of ultraviolet-ray absorbing unsaturated monomer (A-1) were added, and the temperature was raised to 75° C. in a nitrogen stream. 0.12 part of 2,2′-azobis(2,4-dimethylvaleronitrile) and 5.0 parts of methylethyl ketone were dropped into the flask for 8 hours, and block A is synthesized. Subsequently, 45.0 parts of dicyclopentanyl methacrylate, 45.0 parts of styrene and 77.5 parts of methylethyl ketone were added, 0.12 part of 2,2′-azobis(2,4-dimethylvaleronitrile) and 10.0 parts of methylethyl ketone were dropped for 8 hours, and block B was synthesized. After the dropping was completed, the reaction continued for 24 hours. Subsequently, sampling was performed and the polymerization yield was confirmed to be 99% or higher. Then, the temperature was reduced to 50° C. Accordingly, ultraviolet-ray absorbing polymer (B-33) having 50 mass % of nonvolatile content was manufactured.

(Ultraviolet-Ray Absorbing Polymer (B-34))

21.6 parts of methylethyl ketone, 3.5 parts of bis(dodecylsulfanylthiocarbonyl) disulphide and 1.9 parts of 2,2′-azobis(2,4-dimethylvaleronitrile) were added into a four-neck separable flask equipped with a thermometer, an agitator, a dropping funnel and a cooler, and the temperature was raised to 70° C. in a nitrogen stream for two hours of reaction. 50.0 parts of ultraviolet-ray absorbing unsaturated monomer (A-1) was added into the flask, and the temperature was raised to 75° C. in a nitrogen stream. 0.31 part of 2,2′-azobis(2,4-dimethylvaleronitrile) and 10.0 parts of methylethyl ketone were dropped into the flask for 8 hours, and block A was synthesized. Subsequently, 25.0 parts of dicyclopentanyl methacrylate, 25.0 parts of styrene and 12.5 parts of methylethyl ketone were added, 0.31 part of 2,2′-azobis(2,4-dimethylvaleronitrile) and 10.0 parts of methylethyl ketone were dropped for 8 hours, and block B was synthesized. After the dropping was completed, the reaction continued for 24 hours. Subsequently, sampling was performed and the polymerization yield was confirmed to be 990 or higher. Then, the temperature was reduced to 50° C. Accordingly, ultraviolet-ray absorbing polymer (B-34) having 50 mass % of nonvolatile content was manufactured.

(Ultraviolet-Ray Absorbing Polymer (B-35))

As shown in Table 4, ultraviolet-ray absorbing polymer (B-35) was manufactured in the same manner as ultraviolet-ray absorbing polymer (B-34). Note that, ultraviolet-ray absorbing polymer (B-33) to (B-35) are block polymers.

TABLE 4

| | ethylenic unsaturated monomer blending | | | | | | | |
|---|---|---|---|---|---|---|---|---|
| | ultraviolet-ray | | | | | | | |
| ultraviolet-ray | absorbing | | | | | | | |
| absorbing | unsaturated | | | | | | | |
| polymer | monomer | | other ethylenic unsaturated monomer | | | | | |
| type | type | part | type | part | type | part | type | part |
| B-1 | A-1 | 10 | dicyclopentanyl | 45 | | | styrene | 45 |
| | | | methacrylate | | | | | |
| B-2 | A-2 | 10 | dicyclopentanyl | 45 | | | styrene | 45 |
| | | | methacrylate | | | | | |
| B-3 | A-3 | 10 | dicyclopentanyl | 45 | | | styrene | 45 |
| | | | methacrylate | | | | | |
| B-4 | A-4 | 10 | dicyclopentanyl | 45 | | | styrene | 45 |
| | | | methacrylate | | | | | |
| B-5 | A-5 | 10 | dicyclopentanyl | 45 | | | styrene | 45 |
| | | | methacrylate | | | | | |
| B-6 | A-6 | 10 | dicyclopentanyl | 45 | | | styrene | 45 |
| | | | methacrylate | | | | | |
| B-7 | A-7 | 10 | dicyclopentanyl | 45 | | | styrene | 45 |
| | | | methacrylate | | | | | |
| B-8 | A-8 | 10 | dicyclopentanyl | 45 | | | styrene | 45 |
| | | | methacrylate | | | | | |
| B-9 | A-9 | 10 | dicyclopentanyl | 45 | | | styrene | 45 |
| | | | methacrylate | | | | | |
| B-10 | A-10 | 10 | dicyclopentanyl | 45 | | | styrene | 45 |
| | | | methacrylate | | | | | |
| B-11 | A-11 | 10 | dicyclopentanyl | 45 | | | styrene | 45 |
| | | | methacrylate | | | | | |
| B-12 | A-12 | 10 | dicyclopentanyl | 45 | | | styrene | 45 |
| | | | methacrylate | | | | | |
| B-13 | A-13 | 10 | dicyclopentanyl | 45 | | | styrene | 45 |
| | | | methacrylate | | | | | |
| B-14 | A-14 | 10 | dicyclopentanyl | 45 | | | styrene | 45 |
| | | | methacrylate | | | | | |
| B-15 | A-15 | 10 | dicyclopentanyl | 45 | | | styrene | 45 |
| | | | methacrylate | | | | | |
| B-16 | A-16 | 10 | dicyclopentanyl | 45 | | | styrene | 45 |
| | | | methacrylate | | | | | |
| B-17 | A-17 | 10 | dicyclopentanyl | 45 | | | styrene | 45 |
| | | | methacrylate | | | | | |
| B-18 | A-18 | 10 | dicyclopentanyl | 45 | | | styrene | 45 |
| | | | methacrylate | | | | | |
| B-19 | A-19 | 10 | dicyclopentanyl | 45 | | | styrene | 45 |
| | | | methacrylate | | | | | |
| B-20 | A-20 | 10 | dicyclopentanyl | 45 | | | styrene | 45 |
| | | | methacrylate | | | | | |
| B-21 | A-21 | 10 | dicyclopentanyl | 45 | | | styrene | 45 |
| | | | methacrylate | | | | | |
| B-22 | A-1 | 10 | isostearyl | 45 | | | styrene | 45 |
| | | | acrylate | | | | | |
| B-23 | A-1 | 10 | dicyclopentanyl | 45 | | | methyl | 45 |
| | | | methacrylate | | | | methacrylate | |
| B-24 | A-1 | 10 | stearyl acrylate | 45 | | | methyl | 45 |
| | | | | | | | methacrylate | |
| B-25 | A-1 | 10 | behenyl acrylate | 45 | | | methyl | 45 |
| | | | | | | | methacrylate | |
| B-26 | A-1 | 10 | dodecyl acrylate | 45 | | | methyl | 45 |
| | | | | | | | methacrylate | |
| B-27 | A-1 | 10 | butyl | 45 | | | methyl | 45 |
| | | | methacrylate | | | | methacrylate | |
| B-28 | A-1 | 1 | dicyclopentanyl | 49 | | | styrene | 50 |
| | | | methacrylate | | | | | |
| B-29 | A-1 | 50 | dicyclopentanyl | 25 | | | styrene | 25 |
| | | | methacrylate | | | | | |
| B-30 | A-1 | 10 | dicyclopentanyl | 40 | Adekastab | 10 | styrene | 40 |
| | | | methacrylate | | LA-82 | | | |
| B-31 | A-1 | 10 | dicyclopentanyl | 44 | Adekastab | 2 | styrene | 44 |
| | | | methacrylate | | LA-82 | | | |
| B-32 | A-1 | 10 | dicyclopentanyl | 25 | Adekastab | 40 | styrene | 25 |
| | | | methacrylate | | LA-82 | | | |
| B-33 | A-1 | 10 | dicyclopentanyl | 45 | | | styrene | 45 |
| | | | methacrylate | | | | | |
| B-34 | A-1 | 50 | dicyclopentanyl | 25 | | | styrene | 25 |
| | | | methacrylate | | | | | |
| B-35 | A-1 | 75 | dicyclopentanyl | 10 | | | styrene | 15 |
| | | | methacrylate | | | | | |

### Implementation Example 1A

### [Manufacturing of Master Batch]

100 parts of wax (D-1) and 100 parts of ultraviolet-ray absorbing polymer (B-1) were mixed, and a three-roll mill was used to knead at 160° C. so as to manufacture dispersion of ultraviolet-ray absorbing polymer (B-1). Next, 10 parts of the obtained dispersion was mixed along with 100 parts of polyolefin (C-1) by a Henschel mixer. Next, the mixture was melt-kneaded at 180° C. by a single-screw extruder having a screw diameter of 30 mm, and a pelletizer was used to cut into a pellet shape so as to manufacture a master batch.

[Film Formation]

10 parts of the master batch manufactured was mixed with 100 parts of polyolefin (C-1) as a dilution resin. Next, a T-die formation machine (manufactured by Toyo Seiki) was used to melt-mix the mixture at a temperature of 180° C. and form a film having a thickness of 250 μm

### Implementation Examples 2A to 40A, Comparison Examples 1A

Except that the materials of implementation example 1A were changed to the materials and blending amount shown in Table 5, the master batch was manufactured in the same manner as implementation example 1A. Next, films of implementation examples 2A to 40A and comparison example 1A were respectively formed. Besides, in comparison example 1A, instead of the ultraviolet-ray absorbing polymer (B-1) of implementation example 1A, intermediate 1 which is used when synthesizing ultraviolet-ray absorbing unsaturated monomer (A-1) was used.

[Film Formation]

10 parts of the master batch manufactured was mixed with 100 parts of polyolefin (C-1) as a dilution resin. Next, a T-die formation machine (manufactured by Toyo Seiki) was used to melt-mix the mixture at a temperature of 180° C. and form a film having a thickness of 250 μm.

TABLE 5

| | manufacturing of master batch | | | | | | | | | | | | | |
|---|---|---|---|---|---|---|---|---|---|---|---|---|---|---|
| | manufacturing | | | | | | | | | | | | | |
| | of dispersion | | | | | | | | | | | | | |
| | | | ultraviolet-ray | | | | | | | | | | | |
| | | | absorbing | | | | | manufacturing | | | ultra- | | | |
| | | | polymer or | | | | | of T-die film | | | violet- | | | migra- |
| | | | ultraviolet-ray | | disper- | | | master | dilution | | ray | | quality | tion |
| | wax | | absorber | | sion | polyolefin | | batch | resin | | absorbing | transpar- | over | evalua- |
| | type | part | type | part | part | type | part | part | type | part | property | ency | time | tion |
| implementation example 1A | D-1 | 100 | B-1 | 100 | 10 | C-1 | 100 | 10 | C-1 | 100 | A | AA | B | A |
| implementation example 2A | D-1 | 100 | B-1 | 100 | 10 | C-2 | 100 | 10 | C-2 | 100 | A | AA | B | A |
| implementation example 3A | D-1 | 100 | B-1 | 100 | 10 | C-3 | 100 | 10 | C-3 | 100 | A | AA | B | A |
| implementation example 4A | D-1 | 100 | B-1 | 100 | 10 | C-4 | 100 | 10 | C-4 | 100 | A | AA | B | A |
| implementation example 5A | D-2 | 100 | B-1 | 100 | 10 | C-1 | 100 | 10 | C-1 | 100 | A | AA | B | A |
| implementation example 6A | D-3 | 100 | B-1 | 100 | 10 | C-1 | 100 | 10 | C-1 | 100 | A | AA | B | A |
| implementation example 7A | D-1 | 100 | B-2 | 100 | 10 | C-1 | 100 | 10 | C-1 | 100 | A | AA | B | A |
| implementation example 8A | D-1 | 100 | B-3 | 100 | 10 | C-1 | 100 | 10 | C-1 | 100 | A | AA | B | A |
| implementation example 9A | D-1 | 100 | B-4 | 100 | 10 | C-1 | 100 | 10 | C-1 | 100 | A | AA | B | A |
| implementation example 10A | D-1 | 100 | B-5 | 100 | 10 | C-1 | 100 | 10 | C-1 | 100 | A | AA | B | A |
| implementation example 11A | D-1 | 100 | B-6 | 100 | 10 | C-1 | 100 | 10 | C-1 | 100 | A | AA | B | A |
| implementation example 12A | D-1 | 100 | B-7 | 100 | 10 | C-1 | 100 | 10 | C-1 | 100 | A | AA | B | A |
| implementation example 13A | D-1 | 100 | B-8 | 100 | 10 | C-1 | 100 | 10 | C-1 | 100 | A | AA | B | A |
| implementation example 14A | D-1 | 100 | B-9 | 100 | 10 | C-1 | 100 | 10 | C-1 | 100 | A | AA | B | A |
| implementation example 15A | D-1 | 100 | B-10 | 100 | 10 | C-1 | 100 | 10 | C-1 | 100 | A | AA | B | A |
| implementation example 16A | D-1 | 100 | B-11 | 100 | 10 | C-1 | 100 | 10 | C-1 | 100 | A | AA | B | A |
| implementation example 17A | D-1 | 100 | B-12 | 100 | 10 | C-1 | 100 | 10 | C-1 | 100 | A | AA | B | A |
| implementation example 18A | D-1 | 100 | B-13 | 100 | 10 | C-1 | 100 | 10 | C-1 | 100 | A | AA | B | A |
| implementation example 19A | D-1 | 100 | B-14 | 100 | 10 | C-1 | 100 | 10 | C-1 | 100 | A | AA | B | A |
| implementation example 20A | D-1 | 100 | B-15 | 100 | 10 | C-1 | 100 | 10 | C-1 | 100 | A | AA | B | A |
| implementation example 21A | D-1 | 100 | B-16 | 100 | 10 | C-1 | 100 | 10 | C-1 | 100 | A | AA | B | A |
| implementation example 22A | D-1 | 100 | B-17 | 100 | 10 | C-1 | 100 | 10 | C-1 | 100 | A | AA | B | A |
| implementation example 23A | D-1 | 100 | B-18 | 100 | 10 | C-1 | 100 | 10 | C-1 | 100 | A | AA | B | A |
| implementation example 24A | D-1 | 100 | B-19 | 100 | 10 | C-1 | 100 | 10 | C-1 | 100 | A | AA | B | A |
| implementation example 25A | D-1 | 100 | B-20 | 100 | 10 | C-1 | 100 | 10 | C-1 | 100 | A | AA | B | A |
| implementation example 26A | D-1 | 100 | B-21 | 100 | 10 | C-1 | 100 | 10 | C-1 | 100 | A | AA | B | A |
| implementation example 27A | D-1 | 100 | B-22 | 100 | 10 | C-1 | 100 | 10 | C-1 | 100 | A | AA | B | A |
| implementation example 28A | D-1 | 100 | B-23 | 100 | 10 | C-1 | 100 | 10 | C-1 | 100 | A | A | B | A |
| implementation example 29A | D-1 | 100 | B-24 | 100 | 10 | C-1 | 100 | 10 | C-1 | 100 | A | A | B | A |
| implementation example 30A | D-1 | 100 | B-25 | 100 | 10 | C-1 | 100 | 10 | C-1 | 100 | A | A | B | A |
| implementation example 31A | D-1 | 100 | B-26 | 100 | 10 | C-1 | 100 | 10 | C-1 | 100 | A | A | B | A |
| implementation example 32A | D-1 | 100 | B-27 | 100 | 10 | C-1 | 100 | 10 | C-1 | 100 | A | B | B | A |
| implementation example 33A | D-1 | 100 | B-28 | 10 | 10 | C-1 | 100 | 10 | C-1 | 100 | B | AA | B | A |
| implementation example 34A | D-1 | 100 | B-29 | 100 | 10 | C-1 | 100 | 10 | C-1 | 100 | A | A | B | A |
| implementation example 35A | D-1 | 100 | B-30 | 100 | 10 | C-1 | 100 | 10 | C-1 | 100 | A | AA | A | A |
| implementation example 36A | D-1 | 100 | B-31 | 100 | 10 | C-1 | 100 | 10 | C-1 | 100 | A | AA | B | A |
| implementation example 37A | D-1 | 100 | B-32 | 100 | 10 | C-1 | 100 | 10 | C-1 | 100 | A | A | A | A |
| implementation example 38A | D-1 | 100 | B-33 | 100 | 10 | C-1 | 100 | 10 | C-1 | 100 | A | AA | B | A |
| implementation example 39A | D-1 | 100 | B-34 | 100 | 10 | C-1 | 100 | 10 | C-1 | 100 | A | AA | B | A |
| implementation example 40A | D-1 | 100 | B-35 | 100 | 10 | C-1 | 100 | 10 | C-1 | 100 | A | A | B | A |
| comparison example 1A | D-1 | 100 | interme- | 10 | 10 | C-1 | 100 | 10 | C-1 | 100 | A | AA | B | C |
| | | | diate 1 | | | | | | | | | | | |

### Implementation Example 41A

### [Manufacturing of Master Batch]

Ultraviolet-ray absorbing polymer (B-1) was dried by a vacuum dryer at 50° C. for 12 hours, and a dried product of ultraviolet-ray absorbing polymer (B-1) was manufactured. 100 parts of polyolefin (C-1) and 20 parts of the dried product of ultraviolet-ray absorbing polymer (B-1) were put into a twin-screw extruder having a screw diameter of 30 mm (manufactured by Japan Steel Works) from the same supply port and melt-kneaded at 280° C. Then, a pelletizer was used to cut into a pellet shape so as to manufacture a formation resin composition (master batch).

[Film Formation]

10 parts of the formation resin composition manufactured was mixed with 100 parts of polyolefin (C-1) as a dilution resin. Next, a T-die formation machine (manufactured by Toyo Seiki) was used to melt-mix the mixture at a temperature of 230° C. and form a film having a thickness of 250 μm.

### Implementation Example 42A

### [Manufacturing of Master Batch]

100 parts of polycarbonate (E-1) and 20 parts of the dried product of ultraviolet-ray absorbing polymer (B-1) were put into a twin-screw extruder having a screw diameter of 30 mm (manufactured by Japan Steel Works) from the same supply port and melt-kneaded at 280° C. Then, a pelletizer was used to cut into a pellet shape so as to manufacture a formation resin composition (master batch).

[Film Formation]

10 parts of the formation resin composition manufactured was mixed with 100 parts of polycarbonate (E-1) as a dilution resin. Next, a T-die formation machine (manufactured by Toyo Seiki) was used to melt-mix the mixture at a temperature of 280° C. and form a film having a thickness of 250 μm.

### Implementation Examples 43A to 47A, Comparison Example 2A

Except that the materials of implementation example 42A were changed to the materials and blending amount shown in Table 6, the master batch was manufactured in the same manner as implementation example 42A. Next, films of implementation examples 43A to 47A and comparison example 2A were respectively manufactured. Besides, similar to the dried product of ultraviolet-ray absorbing polymer (B-1), the dried products of ultraviolet-ray absorbing polymers (B-2) to (B-4), (B-27) and (B-33) shown in Table 6 were manufactured by drying with a vacuum dryer at 50° C. for 12 hours.

### Implementation Example 48A

### [Manufacturing of Master Batch]

100 parts of polymethacrylic resin (E-2) and 20 parts of the dried product of ultraviolet-ray absorbing polymer (B-1) were put into a twin-screw extruder having a screw diameter of 30 mm (manufactured by Japan Steel Works) from the same supply port and melt-kneaded at 240° C. Then, a pelletizer was used to cut into a pellet shape so as to manufacture a formation resin composition (master batch).

[Film Formation]

10 parts of the formation resin composition manufactured was mixed with 100 parts of polymethacrylic resin (E-2) as a dilution resin, and a T-die formation machine (manufactured by Toyo Seiki) was used to melt-mix the mixture at a temperature of 280° C. to form a T-die film having a thickness of 250 μm.

### Implementation Examples 49A to 53A, Comparison Examples 3A

Except that the materials of implementation example 48A were changed to the materials and blending amount shown in Table 6, the master batch was manufactured in the same manner as implementation example 48A. Next, films of implementation examples 49A to 53A and comparison example 3A were respectively manufactured.

### Implementation Example 54A

### [Manufacturing of Master Batch]

100 parts of polyester (E-3) and 20 parts of the dried product of ultraviolet-ray absorbing polymer (B-1) were put into a twin-screw extruder having a screw diameter of 30 mm (manufactured by Japan Steel Works) from the same supply port and melt-kneaded at 280° C. Then, a pelletizer was used to cut into a pellet shape so as to manufacture a formation resin composition (master batch).

(Film Formation)

10 parts of the formation resin composition manufactured was mixed with 100 parts of polyester (E-3) as a dilution resin, and T-die formation machine (manufactured by Toyo Seiki) was used to melt-mix the mixture at a temperature of 280° C. to form a film having a thickness of 250 μm.

### Implementation Examples 55A to 59A, Comparison Example 4A

Except that the materials of implementation example 54A were changed to the materials and blending amount shown in Table 6, the master batch was manufactured in the same manner as implementation example 54A. Next, films of implementation examples 55A to 59A and comparison example 4A were respectively manufactured.

### Implementation Example 60A

### [Manufacturing of Master Batch]

100 parts of cycloolefin resin (E-4) and 20 parts of the dried product of ultraviolet-ray absorbing polymer (B-1) were put into a twin-screw extruder having a screw diameter of 30 mm (manufactured by Japan Steel Works) from the same supply port and melt-kneaded at 240° C. Then, a pelletizer was used to cut into a pellet shape so as to manufacture a formation resin composition (master batch).

(Film Formation)

10 parts of the formation resin composition manufactured was mixed with 100 parts of cycloolefin resin (E-4) as a dilution resin, and a T-die formation machine (manufactured by Toyo Seiki) was used to melt-mix the mixture at a temperature of 280° C. so as to form a T-die film having a thickness of 250 μm.

### Implementation Examples 61A to 65A, Comparison Example 5A

Except that the materials of implementation example 60A were changed to the materials and blending amount shown in Table 6, the master batch was manufactured in the same manner as implementation example 60A. Next, films of implementation examples 61A to 65A and comparison example 5A were respectively manufactured.

[Ultraviolet-Ray Absorbing Property]

The evaluation was made using the same evaluation method as experimental example 1.

A: the light transmittance at the wavelength of 280 to 380 nm is less than 2% across the entire region, satisfactory
B: the light transmittance at the wavelength of 280 to 380 nm is partially 2% or more, region of practical use
C: the light transmittance at the wavelength of 280 to 380 nm is 2% or more across the entire region, not for practical use

[Transparency]

The evaluation was made using the same evaluation method and evaluation criterion as experimental example 1.

[Quality Over Time]

The evaluation was made using the same evaluation method and evaluation criterion as [light resistance test] in experimental example 1.

[Migration Evaluation]

The evaluation was made using the same evaluation method as experimental example 1.

A: the absorbance at 280 to 380 nm is not detected (less than 0.05), satisfactory
B: the absorbance at 280 to 380 nm is 0.05 or more and less than 0.2, region of practical use
C: the absorbance at 280 to 380 nm is over 0.2, not for practical use

TABLE 6

| | ultraviolet-ray | | | | | | | | | | |
|---|---|---|---|---|---|---|---|---|---|---|---|
| | absorbing | | | | | | | | | | |
| | polymer dried | | | | manufacturing of | | | | | | |
| | product or | | | | T-die film | | | ultraviolet- | | | |
| | ultraviolet-ray | | thermoplastic | | master | dilution | | ray | | quality | |
| | absorber | | resin | | batch | resin | | absorbing | | over | migration |
| | type | part | type | part | part | type | part | property | transparency | time | evaluation |
| implementation example 41A | B-1 | 20 | C-1 | 100 | 10 | C-1 | 100 | A | AA | B | A |
| implementation example 42A | B-1 | 20 | E-1 | 100 | 10 | E-1 | 100 | A | AA | B | A |
| implementation example 43A | B-2 | 20 | E-1 | 100 | 10 | E-1 | 100 | A | AA | B | A |
| implementation example 44A | B-3 | 20 | E-1 | 100 | 10 | E-1 | 100 | A | AA | B | A |
| implementation example 45A | B-4 | 20 | E-1 | 100 | 10 | E-1 | 100 | A | AA | B | A |
| implementation example 46A | B-27 | 20 | E-1 | 100 | 10 | E-1 | 100 | A | AA | B | A |
| implementation example 47A | B-33 | 20 | E-1 | 100 | 10 | E-1 | 100 | A | AA | B | A |
| implementation example 48A | B-1 | 20 | E-2 | 100 | 10 | E-2 | 100 | A | AA | B | A |
| implementation example 49A | B-2 | 20 | E-2 | 100 | 10 | E-2 | 100 | A | AA | B | A |
| implementation example 50A | B-3 | 20 | E-2 | 100 | 10 | E-2 | 100 | A | AA | B | A |
| implementation example 51A | B-4 | 20 | E-2 | 100 | 10 | E-2 | 100 | A | AA | B | A |
| implementation example 52A | B-27 | 20 | E-2 | 100 | 10 | E-2 | 100 | A | AA | B | A |
| implementation example 53A | B-33 | 20 | E-2 | 100 | 10 | E-2 | 100 | A | AA | B | A |
| implementation example 54A | B-1 | 20 | E-3 | 100 | 10 | E-3 | 100 | A | AA | B | A |
| implementation example 55A | B-2 | 20 | E-3 | 100 | 10 | E-3 | 100 | A | AA | B | A |
| implementation example 56A | B-3 | 20 | E-3 | 100 | 10 | E-3 | 100 | A | AA | B | A |
| implementation example 57A | B-4 | 20 | E-3 | 100 | 10 | E-3 | 100 | A | AA | B | A |
| implementation example 58A | B-27 | 20 | E-3 | 100 | 10 | E-3 | 100 | A | AA | B | A |
| implementation example 59A | B-33 | 20 | E-3 | 100 | 10 | E-3 | 100 | A | AA | B | A |
| implementation example 60A | B-1 | 20 | E-4 | 100 | 10 | E-4 | 100 | A | AA | B | A |
| implementation example 61A | B-2 | 20 | E-4 | 100 | 10 | E-4 | 100 | A | AA | B | A |
| implementation example 62A | B-3 | 20 | E-4 | 100 | 10 | E-4 | 100 | A | AA | B | A |
| implementation example 63A | B-4 | 20 | E-4 | 100 | 10 | E-4 | 100 | A | AA | B | A |
| implementation example 64A | B-27 | 20 | E-4 | 100 | 10 | E-4 | 100 | A | AA | B | A |
| implementation example 65A | B-33 | 20 | E-4 | 100 | 10 | E-4 | 100 | A | AA | B | A |
| comparison example 2A | intermediate 1 | 2 | E-1 | 100 | 10 | E-1 | 100 | A | AA | B | C |
| comparison example 3A | intermediate 1 | 2 | E-2 | 100 | 10 | E-2 | 100 | A | AA | B | C |
| comparison example 4A | intermediate 1 | 2 | E-3 | 100 | 10 | E-3 | 100 | A | AA | B | C |
| comparison example 5A | intermediate 1 | 2 | E-4 | 100 | 10 | E-4 | 100 | A | AA | B | C |

(Manufacturing Example of Adhesive Resin (F-1))

A reaction device equipped with an agitator, a reflux cooler, a nitrogen introduction tube, a thermometer and a dropping tube was used. 50% of the total amount of 96.0 parts of n-butylacrylate and 4.0 parts of 2-hydroxylethyl acrylate, 0.2 part of 2,2′-azobisisobutylnitrile as a polymerization initiator, and 150 parts of ethyl acetate as a solvent were added into a reaction vessel under nitrogen atmosphere, and the rest 50% of the total amount and an appropriate amount of ethyl acetate were added into a dropping vessel. Next, heating was started, and the content in the dropping tube and 0.01 part of ethyl acetate dilution of 2,2′-azobisisobutylnitrile were dropped under reflux after it was confirmed that the reaction in the reaction vessel was started. After the dropping was completed, the reaction went on for 5 hours while the reflux state was maintained. After the reaction was completed, cooling was performed and an appropriate amount of ethyl acetate was added to thereby manufacture adhesive resin (F-1) which is an acrylic resin. The weight average molecular weight of the manufactured adhesive resin (F-1) was 500,000, the nonvolatile content was 40%, and the viscosity was 3,200 mPa·s.

(Manufacturing Example of Adhesive Resin (F-2))

A reaction device equipped with an agitator, a reflux cooler, a nitrogen introduction tube, a thermometer and a dropping tube was used. 50% of the total amount of 96.0 parts of n-butylacrylate and 4.0 parts of acrylic acid, 0.2 part of 2,2′-azobisisobutylnitrile as a polymerization initiator, and 150 parts of ethyl acetate as a solvent were added into a reaction vessel under nitrogen atmosphere, and the rest 50% of the total amount and an appropriate amount of ethyl acetate were added into a dropping vessel. Next, heating was started, and the content in the dropping tube and 0.01 part of ethyl acetate dilution of 2,2′-azobisisobutylnitrile were dropped under reflux after it was confirmed that the reaction in the reaction vessel was started. After the dropping was completed, the reaction went on for 5 hours while the reflux state was maintained. After the reaction was completed, cooling was performed and an appropriate amount of ethyl acetate was added to thereby manufacture adhesive resin (F-2) which is an acrylic resin. The weight average molecular weight of the adhesive resin (F-2) manufactured was 600,000, the nonvolatile content was 40%, and the viscosity was 4,000 mPa·s.

### Implementation Example 66A

2 parts of ultraviolet-ray absorbing polymer (B-27) was mixed with 100 parts of nonvolatile content of adhesive resin (F-1) as an adhesive resin, 0.1 part of KBM-403 (manufactured by Shin-Etsu Chemical) as a silane coupling agent, 0.4 part of trimethylolpropane adduct of tolylene diisocyanate (abbreviation: TDI-TMP, NCO value=13.2, nonvolatile content=75%) as a curing agent were added, and the mixture was thoroughly agitated to manufactured an adhesive. Subsequently, the adhesive was coated on a release film of a polyethylene terephthalate substrate having a thickness of 38 μm so that the thickness after drying became 50 μm, and is dried by a hot-air oven of 100° C. for 2 minutes. Then, a polyethylene terephthalate film of 25 μm was pasted on the adhesive layer side and aged in this state for 7 days at room temperature to manufacture an adhesive sheet.

### Implementation Examples 67A to 70A, Comparison Example 6A

As shown in Table 7, adhesive sheets of implementation examples 67A to 70A and comparison example 6A were respectively manufactured with preparation the same as that of implementation example 66A.

(Evaluation of Adhesive Sheet)

### (1) Adhesion Force

The adhesive sheet manufactured was prepared into a size of 25 mm wide and 150 mm long. The adhesive layer exposed after peeling the release film off from the adhesive sheet was pasted to a glass plate and pressed for bonding by a roll of 2 kg for one reciprocation under an atmosphere of 23° C. and relative humidity 50%. After kept still for 24 hours, adhesion force was measured in a 180° peel test in which a tensile testing machine was used to peel at a speed of 300 mm/min in the 180-degree direction, and evaluation was made on the basis of the following evaluation criterion (in accordance with JIS Z0237: 2000).

AA: the adhesion force is 15 N or higher, extremely satisfactory
A: the adhesion force is 10 N or higher and less than 15 N, satisfactory
C: the adhesion force is less than 10 N, not for practical use

### (2) Retention Force

The adhesive sheet manufactured was prepared into a size of 25 mm wide and 150 mm long. The release sheet is peeled off from the adhesive sheet in accordance with JIS Z0237: 2000, and the adhesive layer was adhered to a lower part of 25 mm wide and 25 mm long in a polished stainless steel plate of 30 mm wide and 150 mm long and pressed for bonding by a roll of 2 kg for one reciprocation. Then, a load of 1 kg was applied at an atmosphere of 40° C. and the adhesive sheet was kept still for 70,000 seconds to thereby measure the retention force. The evaluation was made by measuring the length at which the upper part of the pasting surface of the adhesive sheet shifted downward.

A: the shifted length is less than 0.5 mm, satisfactory
C: the shifted length is 0.5 mm or more, not for practical use

### (3) Transparency

The release sheet was peeled off from the adhesive sheet manufactured, and the transparency of the adhesive layer was visually evaluated. The evaluation on the appearance of the adhesive layer was made on the basis of the three-level evaluation criterion below.

A: the adhesive layer is transparent, satisfactory
B: the adhesive layer is slightly whitened, region of practical use
C: the adhesive layer is whitened, not for practical use

### (4) Migration Property Evaluation

The adhesive sheet manufactured was prepared into a size of 100 mm wide and 100 mm long. The adhesive layer exposed after peeling the release film off from the adhesive sheet was pasted to a glass plate and pressed for bonding by a roll of 2 kg for one reciprocation under an atmosphere of 23° C. and relative humidity 50%. Next, the adhesive sheet was kept still under the same environment for 48 hours, then the adhesive sheet is peeled off, and an UV-VIS-NIR spectrophotometer (manufactured by Shimadzu Corporation) was used to evaluate the migration property of the ultraviolet-ray absorbing material to the glass. The evaluation was made by selecting five points in the glass subjected to the above processing, measuring the absorbance of the ultraviolet region and calculating the average.

A: the absorbance at 280 to 380 nm is not detected (0.05 or lower), satisfactory
B: the absorbance at 280 to 380 nm is higher than 0.05 and 0.2 or lower, region of practical use
C: the absorbance at 280 to 380 nm is over 0.2, not for practical use

TABLE 7

| | ultraviolet-ray | | | | | | | | |
|---|---|---|---|---|---|---|---|---|---|
| | absorbing | | | | | | | | |
| | polymer or | | | | | | | | |
| | ultraviolet-ray | | | | curing | | | | |
| | absorber | | adhesive resin | | agent | adhesion | retention | | migration |
| | type | part | type | part | TDI-TMP | force | force | transparency | evaluation |
| implementation example 66A | B-27 | 2 | F-1 | 100 | 0.4 | A | A | A | A |
| implementation example 67A | B-27 | 2 | F-2 | 100 | 0.4 | AA | A | A | A |
| implementation example 68A | B-1 | 2 | F-2 | 100 | 0.4 | AA | A | A | A |
| implementation example 69A | B-29 | 2 | F-2 | 100 | 0.4 | AA | A | B | A |
| implementation example 70A | B-34 | 2 | F-2 | 100 | 0.4 | AA | A | A | A |
| comparison example 6A | intermediate 1 | 0.2 | F-1 | 100 | 0.4 | A | C | A | C |

<Paint>

### Implementation Example 71A

Agitation mixing was performed with the following composition to prepare a paint. ultraviolet-ray absorbing polymer (B-27) 1.0 part polyester (Vylon GK250, manufactured by Toyo Spinning) 9.0 parts methylethyl ketone 90.0 parts

### Implementation Examples 72A to 75A, Comparison Examples 7A to 8A

As shown in Table 8, paints of implementation examples 72A to 75A and comparison examples 7A to 8A are respectively prepared in the same manner as implementation example 71A.

(Production of Coated Object)

The paint prepared was coated using a bar coater onto a glass substrate having a thickness of 1000 μm so as to obtain a dried film thickness of 6 μm, and was dried at 100° C. for 2 minutes to produce a coating film.

(Evaluation of Coated Object)

The coated object produced was evaluated by the following methods.

[Optical Property]

The transmittance of the coated object produced was measured using an UV-VIS-NIR spectrophotometer (manufactured by Shimadzu Corporation). The transmittance is the spectral transmittance measured with respect to a white standard plate.

Evaluation was made on whether the following conditions are satisfied.
A: the light transmittance at the wavelength of 280 to 380 nm is 2% or lower across the entire region, satisfactory.
B: the light transmittance at the wavelength of 280 to 380 nm is partially over 2% and 10% or lower, region of practical use
C: the light transmittance at the wavelength of 280 to 380 nm is partially 10% or higher or over 2% across the entire region, not for practical use

[Transparency]

The transparency of the coated object produced was visually evaluated.

A: no turbidity is recognized at all, satisfactory
C: turbidity is recognized, not for practical use

[Migration Evaluation]

A soft vinylchloride sheet was placed on the coating film surface of the coated object produced, and a heat press machine was used for thermal pressure bonding under a pressure of 100 g/cm² at a temperature of 170° C. for 30 seconds. Next, the film was directly removed and the migration to the soft vinylchloride sheet was evaluated using an UV-VIS-NIR spectrophotometer (manufactured by Shimadzu Corporation). The evaluation was made by selecting five points in the soft vinylchloride sheet subjected to the above processing, measuring the absorbance of the ultraviolet region and calculating the average.

A: the absorbance at 280 to 380 nm is not detected (0.05 or lower), satisfactory
B: the absorbance at 280 to 380 nm is higher than 0.05 and 0.2 or lower, region of practical use
C: the absorbance at 280 to 380 nm is higher than 0.2, not for practical use.

TABLE 8

| | ultraviolet-ray | | | | | | |
|---|---|---|---|---|---|---|---|
| | absorbing | | | | | | |
| | polymer or | | | | | | |
| | ultraviolet-ray | | | | | | |
| | absorber | | resin | | optical | | migration |
| | type | part | type | part | property | transparency | evaluation |
| implementation example 71A | B-27 | 1 | polyester | 9 | A | A | A |
| implementation example 72A | B-27 | 1 | triacetyl cellulose | 9 | A | A | A |
| implementation example 73A | B-1 | 1 | triacetyl cellulose | 9 | A | A | A |
| implementation example 74A | B-29 | 1 | triacetyl cellulose | 9 | A | A | A |
| implementation example 75A | B-34 | 1 | triacetyl cellulose | 9 | A | A | A |
| comparison example 7A | intermediate 1 | 0.2 | polyester | 9 | A | A | C |
| comparison example 8A | intermediate 1 | 0.2 | triacetyl cellulose | 9 | A | A | C |

<Photocurable Composition>

### Implementation Example 76A

The raw materials were agitated with the following composition to prepare a photocurable composition.

ultraviolet-ray absorbing polymer (B-27) 10.0 parts
photopolymerizable compound (multi-functional acrylate “KAYARAD DPHA” manufactured by Nippon Kayaku Co., Ltd.) 9.0 parts
photopolymerization initiator (“Omnirad 184” manufactured by IGM ResinBV) 1.0 part propyleneglycol monomethyl ether 80.0 parts

### Implementation Examples 77A to 79A, Comparison Example 9A

As shown in Table 9, photocurable compositions of implementation examples 77A to 79A and comparison example 9A were prepared in the same manner as implementation example 76A.

(Production of Coated Object)

The above photocurable composition was coated using a bar coater onto a glass substrate having a thickness of 1 mm so as to obtained a dried film thickness of 6 μm. After dried at 100° C. for 1 minute, the obtained coated layer was irradiated with ultraviolet rays of 400 mJ/cm² by a high-pressure mercury lamp to cure and produce a coated object.

(Evaluation of Coated Object)

The coated object produced was evaluated by the following methods.

[Optical Property]

Evaluation was made by the same evaluation method and evaluation criterion as in <paint> in this experimental example.

[Abrasion Resistance]

The coated object was set on a vibration tester and vibrated using steel wool for 10 times under a load of 250 g. The condition of the scratch was judged according to the five-level visual evaluation for the coated object that was taken out. The greater the numeric value, the more satisfactory the abrasion resistance of the cured film.

5: no scratch at all
4: there is little scratch
3: although there are scratches, the substrate is not visible
2: there are scratches, and a part of the cured film is peeled off
1: the cured film is totally peeled off, and the substrate is exposed

[Pencil Hardness]

In accordance with JIS-K5600, a pencil hardness tester (Scratching Tester HEIDON-14 manufactured by HEIDON) was used to perform test on the cured film of the coated object for five times under a load of 500 g with varied hardness of the pencil lead. The hardness of the lead at which no scratch appears or scratch appears only once among the five times is taken as the pencil hardness of the cured film. The evaluation criterion is as follows.

A: 2H or higher

### B: H

C: lower than H

[Transparency]

Evaluation was made by the same evaluation method as in <paint> in this experimental example.

A: no turbidity is recognized at all, satisfactory
B: turbidity is slightly recognized, region of practical use
C: turbidity is widely recognized, not for practical use

[Migration Evaluation]

The coated object produced was sandwiched by two pieces of soft vinylchloride sheets, and a heat press machine was used for thermal pressure bonding under a pressure of 100 g/cm² at a temperature of 170° C. for 30 seconds. Next, the film was directly removed and the migration to the soft vinylchloride sheet was evaluated using an UV-VIS-NIR spectrophotometer (manufactured by Shimadzu Corporation). The evaluation was made by selecting five points in the soft vinylchloride sheet subjected to the above processing, measuring the absorbance of the ultraviolet region and calculating the average. Besides, the evaluation was made by the same evaluation criterion as in <paint> in this experimental example.

TABLE 9

| | ultraviolet-ray | | | | | | | | |
|---|---|---|---|---|---|---|---|---|---|
| | absorbing | | | | | | | | |
| | polymer or | | | | | | | | |
| | ultraviolet-ray | | KAYARAD | Omnirad | | | | | |
| | absorber | | DPHA | 184 | optical | abrasion | pencil | | migration |
| | type | part | part | part | property | resistance | hardness | transparency | evaluation |
| implementation | B-27 | 10 | 9 | 1 | A | 5 | B | A | A |
| example 76A | | | | | | | | | |
| implementation | B-1 | 10 | 9 | 1 | A | 5 | B | A | A |
| example 77A | | | | | | | | | |
| implementation | B-29 | 10 | 9 | 1 | A | 5 | B | B | A |
| example 78A | | | | | | | | | |
| implementation | B-34 | 10 | 9 | 1 | A | 5 | B | A | A |
| example 79A | | | | | | | | | |
| comparison | intermediate 1 | 1 | 18 | 1 | A | 2 | B | A | C |
| example 9A | | | | | | | | | |

### Experimental Example 3

The polyolefin used in this experimental example is shown below.

(A-1): polyethylene (Suntec LD M2270, MFR=7 g/10 min, manufactured by Asahi Kasei Corporation)
(A-2): polyethylene (Novatec UJ790, MFR=50 g/10 min, manufactured by Japan polyethylene Corporation)
(A-3): polypropylene (Novatec PP FA3EB, MFR=10.5 g/10 min, manufactured by Japan Polypropylene Corporation)
(A-4): polypropylene (Prime Polypro J226T, MFR=20 g/10 min, manufactured by Prime Polymer Co., Ltd.)
(A-5): polyethylene (Evolue H SP65051B, MFR=0.45 g/10 min, manufactured by Prime Polymer Co., Ltd.)

The wax used in this experimental example is the same as wax (D-1) to (D-3) shown in experimental example 1.

### Manufacturing Example of Ultraviolet-Ray Absorbing Polymer

### Manufacturing Example 1B (Polymer (B-1))

61.4 parts of methylethyl ketone was added into a four-neck separable flask equipped with a thermometer, an agitator, a dropping funnel and a cooler, and the temperature was raised to 75° C. in a nitrogen stream. Additionally, 5.0 parts of 4-methacryloyloxybenzophenone (manufactured by MCC Unitec, MBP), 47.5 parts of dicyclopentanyl methacrylate (manufactured by Hitachi Chemical Co., Ltd., FA-513M) as the monomer represented by general formula (1), 47.5 parts of styrene, 10.0 parts of 2,2′-azobis(methyl isobutyrate), and 75.0 parts of methylethyl ketone were uniformly mixed and then added into a dropping funnel. Next, the content of the dropping funnel was dropped for two hours. After the dropping was completed, the reaction continued for two hours. Subsequently, sampling was performed and the polymerization yield was confirmed to be 98% or higher. The product was diluted by methylethyl ketone until the nonvolatile content reaches 35%, and then cooled to room temperature to manufacture resin solution b-1. Next, 500 parts of methylethyl ketone and 500 parts of methanol were added into a four-neck separable flask equipped with a thermometer, an agitator, a dropping funnel and a cooler and rotated 1,000 turns by a disper, and then 250 parts of the resin solution b-1 was dropped for one hour. The generated white sediment was taken out by filtering and dried by a vacuum dryer at 50° C. for 12 hours to manufacture polymer (B-1).

### Manufacturing Example 2B, 3B, 5B, 9B (Polymers (B-2), (B-3), (B-5), (B-9))

Except that the type and blending amount of the monomer are changed according to Table 10, synthesis was performed in the same manner as manufacturing example 1B to manufactured polymers (B-2), (B-3), (B-5), (B-9).

### Manufacturing Example 4B (Polymer (B-4))

The type and blending amount of the monomer were changed according to Table 10 to manufacture resin solution b-4. 250 parts of acetone was added to 250 parts of b-4 having 35% of nonvolatile content and was agitated 1000 turns by a disper for 30 minutes. Then, the agitation was stopped, and the mixture was kept still for one hour to be separated into two layers. The resin layer at the lower layer was taken out and was diluted to 35% by methylethyl ketone to manufacture resin solution b-4′. The resin solution manufactured was dried by a vacuum dryer at 50° C. for 12 hours to manufacture polymer (B-4).

### Manufacturing Example 6B (Polymer (B-6))

250 parts of methylethyl ketone and 250 parts of methanol were added into a four-neck separable flask equipped with a thermometer, an agitator, a dropping funnel and a cooler and was rotated 1,000 turns by a disper, and then 125 parts of resin solution b-4′ manufactured in manufacturing example 4B was dropped for one hour. The generated white sediment was taken out by filtering and dried by a vacuum dryer at 50° C. for 12 hours to manufacture polymer (B-6).

### Manufacturing Examples 7B, 12B (Polymers (B-7), (B-12))

The type and blending amount of the monomer were changed according to Table 10, and the same operations as in manufacturing examples 4B, 6B were performed to manufacture polymers (B-7), (B-12).

### Manufacturing Example 8B (Polymer (B-8))

38.0 parts of methylethyl ketone, 3.0 parts of 4-methacryloyloxybenzophenone, 41.0 parts of dicyclopentanyl methacrylate as the monomer represented by general formula (1), 41.0 parts of styrene, 15.0 parts of 2-[2-hydroxy-5-[2-(methacryloyloxy)ethyl]phenyl]-2H-benzotriazole (manufactured by Otsuka Chemicals, RUVA-93) as the monomer unit represented by general formula (a1-1) and 2.0 g of octyl thioglycolate (manufactured by Yodo Kagaku Co., Ltd., OTG) were added into in a four-neck separable flask equipped with a thermometer, an agitator, a dropping funnel and a cooler, and the temperature was raised to 75° C. in a nitrogen stream. 1.0 part of 2,2′-azobis(methyl isobutyrate), 2.0 g of octyl thioglycolate (manufactured by Yodo Kagaku Co., Ltd., OTG) and 17.0 parts of methylethyl ketone were dropped into the flask for 8 hours. After the dropping was completed, the reaction continued for two hours. Subsequently, sampling was performed and the polymerization yield was confirmed to be 98% or higher. The product was diluted by methylethyl ketone to manufactured resin solution b-8 having a nonvolatile content of 35%. 250 parts of acetone was added to 250 parts of resin solution b-8 and was agitated 1000 turns by a disper for 30 minutes. Then, the agitation was stopped, and the mixture was kept still for one hour to be separated into two layers. The resin layer at the lower layer was taken out and diluted to 35% by methylethyl ketone to manufacture resin solution b-8′.

Next, 250 parts of methylethyl ketone and 250 parts of methanol were added into a four-neck separable flask equipped with a thermometer, an agitator, a dropping funnel and a cooler and rotated 1,000 turns by a disper. Then, 125 parts of resin solution b-8′ was dropped for one hour. The generated white sediment was taken out by filtering and dried by a vacuum dryer at 50° C. for 12 hours to manufacture polymer (B-8).

### Manufacturing Example 10B (Polymer (B-10))

38.0 parts of methylethyl ketone, 3.0 parts of 4-methacryloyloxybenzophenone (manufactured by MCC Unitec, MBP), 41.0 parts of dicyclopentanyl methacrylate as the monomer represented by general formula (1), 41.0 parts of styrene, 15.0 parts of 2-[2-hydroxy-5-[2-(methacryloyloxy)ethyl]phenyl]-2H-benzotriazole as the monomer unit represented by general formula (a1-1) and 4.4 g of methyl 4-cyano-4-[(dodecylsulfanylthiocarbonyl)sulfanyl] pentanoate were added into a four-neck separable flask equipped with a thermometer, an agitator, a dropping funnel and a cooler, and the temperature was raised to 75° C. in a nitrogen stream. 2.5 parts of 2,2′-azobis(methyl isobutyrate) and 17.0 parts of methylethyl ketone were dropped into the flask for 8 hours. After the dropping was completed, the reaction continued for 24 hours. Subsequently, sampling was performed and the polymerization yield was confirmed to be 99% or higher. The product was cooled to 50° C. and taken out to a Teflon (registered trademark) bat. Furthermore, drying was performed by a vacuum dryer at 50° C. for 12 hours to manufacture polymer (B-10).

### Manufacturing Example 11B (Polymer (B-11))

43.0 parts of methylethyl ketone, 1.77 parts of bis(dodecylsulfanylthiocarbonyl) disulfide and 0.88 part of dimethyl 2,2′-azobis(2-methylpropionate) were added into a four-neck separable flask equipped with a thermometer, an agitator, a dropping funnel and a cooler, and the temperature was raised to 70° C. in a nitrogen stream to perform reaction for two hours. 10.0 parts of 4-acryloyloxybenzophenone and 40.0 parts of 2-[2-hydroxy-5-[2-(methacryloyloxy)ethyl]phenyl]-2H-benzotriazole as the monomer unit represented by general formula (a1-1) were added into the flask, and the temperature was raised to 75° C. in a nitrogen stream. 0.15 part of dimethyl 2,2′-azobis(2-methylpropionate) and 10.0 parts of methylethyl ketone were dropped into the flask for 8 hours, and block A was synthesized. Subsequently, 45.0 parts of dicyclopentanyl methacrylate, 5.0 parts of 2-methoxyethyl acrylate and 40.1 part of methylethyl ketone were added, 0.15 part of dimethyl 2,2′-azobis(2-methylpropionate) and 10.0 parts of methylethyl ketone were dropped for 8 hours, and block B was synthesized. After the dropping was completed, the reaction continued for 24 hours. Subsequently, sampling was performed and the polymerization yield was confirmed to be 99% or higher. Resin solution b-11 was manufactured.

Next, 500 parts of methanol was added into a four-neck separable flask equipped with a thermometer, an agitator, a dropping funnel and a cooler and rotated 1,000 turns by a disper. Then, 100 parts of the resin solution b-11 was dropped for one hour. The generated white sediment was taken out by filtering and dried by a vacuum dryer at 50° C. for 12 hours to manufacture AB block polymer (B-11). The weight average molecular weight (Mw) of the polymer manufactured was 15,200, and Mw/Mn was 1.23.

### Manufacturing Example 12B (Polymer (B-12))

25.4 parts of ethyl acetate, 1.77 parts of bis(dodecylsulfanylthiocarbonyl) disulfide and 0.95 part of 2,2′-azobis(2,4-dimethylvaleronitrile) were added into a four-neck separable flask equipped with a thermometer, an agitator, a dropping funnel and a cooler, and the temperature was raised to 70° C. in a nitrogen stream to perform reaction for two hours. 10.0 parts of 4-methacryloyloxybenzophenone (manufactured by MCC Unitec, MBP) and 40.0 parts of 2-[2-hydroxy-5-[2-(methacryloyloxy)ethyl]phenyl]-2H-benzotriazole as the monomer unit represented by general formula (a1-1) were added into the flask, and the temperature was raised to 75° C. in a nitrogen stream. 0.16 part of 2,2′-azobis(2,4-dimethylvaleronitrile) and 10.0 parts of ethyl acetate were dropped into the flask for 8 hours, and block A was synthesized. Subsequently, 45.0 parts of dicyclopentanyl methacrylate, 5.0 parts of 2-methoxyethyl acrylate and 23.4 parts of ethyl acetate were added, 0.16 part of 2,2′-azobis(2,4-dimethylvaleronitrile) and 10.0 parts of ethyl acetate were dropped for 8 hours, and block B was synthesized. After the dropping was completed, the reaction continued for 24 hours. Subsequently, sampling was performed, and the polymerization yield was confirmed to be 99% or higher. Resin solution b-12 was manufactured.

Next, 500 parts of methanol was added into a four-neck separable flask equipped with a thermometer, an agitator, a dropping funnel and a cooler and rotated 1,000 turns by a disper. Then, 100 parts of the resin solution b-12 was dropped for one hour. The generated white sediment was taken out by filtering and dried by a vacuum dryer at 50° C. for 12 hours to manufacture AB block polymer (B-12). The weight average molecular weight (Mw) of the polymer manufactured was 13,600, and Mw/Mn was 1.20.

### Manufacturing Example 13B (Polymer (B-13))

61.4 parts of methylethyl ketone was added into a four-neck separable flask equipped with a thermometer, an agitator, a dropping funnel and a cooler, and the temperature was raised to 75° C. in a nitrogen stream. Additionally, 3.0 parts of 4-methacryloyloxybenzophenone, 41.0 parts of dicyclopentanyl methacrylate as the monomer represented by general formula (1), 41.0 parts of styrene, 15.0 parts of 2-[2-hydroxy-5-[2-(methacryloyloxy)ethyl]phenyl]-2H-benzotriazole as the monomer unit represented by general formula (a1-1), 10.0 parts of 2,2′-azobis(methyl isobutyrate) and 75.0 parts of methylethyl ketone were uniformly mixed and then added into a dropping funnel. Next, the content of the dropping funnel was dropped for two hours. After the dropping was completed, the reaction continued for two hours. Subsequently, sampling was performed and the polymerization yield was confirmed to be 98% or higher. The product was cooled to 50° C. and taken out to a Teflon (registered trademark) bat. Furthermore, drying was performed by a vacuum dryer at 50° C. for 12 hours to manufacture polymer (B-13).

TABLE 10

| | polymer name | monomer (part by mass) | | | | | | |
|---|---|---|---|---|---|---|---|---|
| manufacturing | polymer B-1 | MBP | 5.0 | | | dicyclopentanyl | 47.5 | styrene |
| example 1B | | | | | | methacrylate | | |
| manufacturing | polymer B-2 | MBP | 30.0 | | | dicyclopentanyl | 35.0 | styrene |
| example 2B | | | | | | methacrylate | | |
| manufacturing | polymer B-3 | MBP | 3.0 | RUVA-93 | 15.0 | isostearyl | 41.0 | styrene |
| example 3B | | | | | | acrylate | | |
| manufacturing | polymer B-4 | MBP | 3.0 | RUVA-93 | 15.0 | dicyclopentanyl | 41.0 | styrene |
| example 4B | | | | | | methacrylate | | |
| manufacturing | polymer B-5 | MBP | 3.0 | RUVA-93 | 15.0 | dicyclopentanyl | 41.0 | styrene |
| example 5B | | | | | | methacrylate | | |
| manufacturing | polymer B-6 | MBP | 3.0 | RUVA-93 | 15.0 | dicyclopentanyl | 41.0 | styrene |
| example 6B | | | | | | methacrylate | | |
| manufacturing | polymer B-7 | MBP | 3.0 | RUVA-93 | 15.0 | dicyclopentanyl | 40.0 | styrene |
| example 7B | | | | | | methacrylate | | |
| manufacturing | polymer B-8 | MBP | 3.0 | RUVA-93 | 15.0 | dicyclopentanyl | 41.0 | styrene |
| example 8B | | | | | | methacrylate | | |
| manufacturing | polymer B-9 | | | RUVA-93 | 15.0 | dicyclopentanyl | 42.5 | styrene |
| example 9B | | | | | | methacrylate | | |
| manufacturing | polymer B-10 | MBP | 3.0 | RUVA-93 | 15.0 | dicyclopentanyl | 41.0 | styrene |
| example 10B | | | | | | methacrylate | | |
| manufacturing | polymer B-11 | 4ABP | 10.0 | RUVA-93 | 40.0 | dicyclopentanyl | 45.0 | 2-MTA |
| example 11B | | | | | | methacrylate | | |
| manufacturing | polymer B-12 | MBP | 10.0 | RUVA-93 | 40.0 | dicyclopentanyl | 45.0 | 2-MTA |
| example 12B | | | | | | methacrylate | | |
| manufacturing | polymer B-13 | MBP | 3.0 | RUVA-93 | 15.0 | dicyclopentanyl | 41.0 | styrene |
| example 13B | | | | | | methacrylate | | |
| manufacturing | polymer B-14 | | | | | dicyclopentanyl | 50.0 | styrene |
| example 14B | | | | | | methacrylate | | |
| | | | | | | | | ratio of |
| | | | | | | | | polymer |
| | | | | | | | | having a |
| | | | | | | | | molecular |
| | | | | | | | | weight of |
| | | | | | | | | 1000 or |
| | | monomer (part by mass) | | | refining step | Mn | Mw | lower |
| | manufacturing | 47.5 | | | resedimentation | 4,600 | 8,600 | 0.8% |
| | example 1B | | | | | | | |
| | manufacturing | 35.0 | | | resedimentation | 4,700 | 8,700 | 0.9% |
| | example 2B | | | | | | | |
| | manufacturing | 41.0 | | | resedimentation | 4,500 | 8,200 | 0.8% |
| | example 3B | | | | | | | |
| | manufacturing | 41.0 | | | liquid separation | 4,900 | 8,700 | 0.9% |
| | example 4B | | | | | | | |
| | manufacturing | 41.0 | | | resedimentation | 3,800 | 7,800 | 0.9% |
| | example 5B | | | | | | | |
| | manufacturing | 41.0 | | | liquid separation | 7,100 | 11,000 | 0.7% |
| | example 6B | | | | resedimentation | | | |
| | manufacturing | 40.0 | FA-711MM | 2.0 | liquid separation | 7,300 | 11,500 | 0.7% |
| | example 7B | | | | resedimentation | | | |
| | manufacturing | 41.0 | | | liquid separation | 8,500 | 14,300 | 0.6% |
| | example 8B | | | | resedimentation | | | |
| | manufacturing | 42.5 | | | resedimentation | 4,200 | 7,900 | 0.9% |
| | example 9B | | | | | | | |
| | manufacturing | 41.0 | | | unrefined | 5,000 | 7,000 | 0.8% |
| | example 10B | | | | | | | |
| | manufacturing | 5.0 | | | resedimentation | 12,400 | 15,200 | 0.3% |
| | example 11B | | | | | | | |
| | manufacturing | 5.0 | | | resedimentation | 11,300 | 13,600 | 0.2% |
| | example 12B | | | | | | | |
| | manufacturing | 41.0 | | | unrefined | 2,000 | 6,000 | 7.7% |
| | example 13B | | | | | | | |
| | manufacturing | 50.0 | | | liquid separation | 7,000 | 10,200 | 0.8% |
| | example 14B | | | | resedimentation | | | |

Details of the terms in Table 10 are as follows.

MBP: 4-methacryloyloxybenzophenone (manufactured by MCC Unitec)

4ABP: 4-acryloyloxybenzophenone

RUVA-93: 2-[2-hydroxy-5-[2-(methacryloyloxy)ethyl]phenyl]-2H-benzotriazole (manufactured by Otsuka Chemicals)

FA-711MM: pentamethylpiperidinyl methacrylate (manufactured by Hitachi Chemical Co., Ltd.)

2-MTA: 2-methoxyethyl acrylate

### Implementation Example 1B

### [Manufacturing of Master Batch]

100 parts of wax (D-1) and 100 parts of polymer (B-1) were mixed, and a three-roll mill was used to knead at 160° C. so as to manufacture dispersion of polymer (B-1). Next, 100 parts of the dispersion manufactured was mixed with 100 parts of polyolefin (A-3) by a Henschel mixer. Next, the mixture was melt-kneaded at 180° C. by a single-screw extruder having a screw diameter of 30 mm and then cooled, and a pelletizer was used to cut into a pellet shape so as to manufacture a master batch.

(Film Formation)

50 parts of master batch was mixed with 100 parts of polyolefin (A-3) as a dilution resin, and T-die formation machine (manufactured by Toyo Seiki) was used to melt-mix the mixture at a temperature of 180° C. so as to form a film having a thickness of 250 μm.

### Implementation Examples 2B to 19B, Comparison Examples 1B to 3B

Except that the materials of implementation example 1B were changed to the materials and blending amount shown in Table 11, the master batch was manufactured in the same manner as implementation example 1B. Next, films of implementation examples 2B to 19B and comparison examples 1B to 3B were respectively formed. Besides, Adekastab LA-29 (manufactured by ADEKA) shown in experimental example 1 was also used.

[Ultraviolet-Ray Absorbing]

Evaluation was made by the same evaluation method as experimental example 1. A: the light transmittance at the wavelength of 290 to 360 nm is lower than 0.3% across the entire region, satisfactory

B: regions in which the light transmittance is partially 0.3% or higher exist in the range of a wavelength of 290 to 360 nm, region of practical use
C: the light transmittance at the wavelength of 290 to 360 nm is 0.3% or higher across the entire region, not for practical use

[Translucency of Film]

Evaluation was made by the same evaluation method and evaluation criterion as in [transparency] of experimental example 1.

[Light Resistance Test]

Evaluation was made by the same evaluation method and evaluation criterion as experimental example 1.

[Migration Evaluation]

The formed film was sandwiched by soft vinylchloride sheets in which titanium oxide was blended, and a heat press machine was used for thermal pressure bonding under a pressure of 100 g/cm² at a temperature of 170° C. for 30 seconds. Next, the film was directly removed and the migration to the soft vinylchloride sheet in which titanium oxide was blended was evaluated using an UV-VIS-NIR spectrophotometer (manufactured by Shimadzu Corporation). The evaluation was made by selecting five points in the soft vinylchloride sheet subjected to the above processing, measuring the absorbance of the ultraviolet region and calculating the average.

A: the absorbance at 380 to 480 nm is not detected (lower than 0.05), satisfactory
B: the absorbance at 380 to 480 nm is 0.05 or higher and 0.2 or lower, region of practical use
C: the absorbance at 380 to 480 nm is over 0.2, not for practical use

[Odour Evaluation]

The odour of the formed film was confirmed by a sensory test, and the difference with the film consisting of only polyolefin was confirmed by 5 panellists.

A: 5 panellists determined that the odour was equal to the film consisting of only polyolefin, satisfactory
B: 3 panellists determined that the odour was equal to the film consisting of only polyolefin, region of practical use
C: no panellist determined that the odour was equal to the film consisting of only polyolefin, not for practical use.

TABLE 11

| | manufacturing of master batch | | | | | | | | | | | | | | |
|---|---|---|---|---|---|---|---|---|---|---|---|---|---|---|---|
| | manufacturing of | | | | | | | | | | | | | | |
| | dispersion | | | | | | | | | | | | | | |
| | | | ultraviolet-ray | | | | | | | | ultra- | | | | |
| | | | absorbing | | | | | manufacturing | | | violet- | | | migra- | |
| | | | polymer or | | | | | of T-die film | | | ray | film | light | tion | |
| | | | ultraviolet-ray | | disper- | poly- | | master | dilution | | absorbing | translu- | resist- | evalua- | |
| | wax | | absorber | | sion | olefin | | batch | resin | | property | cency | ance | tion | odour |
| implementation example 1B | D-1 | 100 | B-1 | 100 | 100 | A-3 | 100 | 50 | A-3 | 100 | B | AA | A | B | B |
| implementation example 2B | D-1 | 100 | B-2 | 100 | 100 | A-3 | 100 | 6 | A-3 | 100 | B | B | B | B | B |
| implementation example 3B | D-1 | 100 | B-3 | 100 | 100 | A-3 | 100 | 10 | A-3 | 100 | A | B | B | B | B |
| implementation example 4B | D-1 | 100 | B-4 | 100 | 100 | A-3 | 100 | 10 | A-3 | 100 | A | AA | A | B | B |
| implementation example 5B | D-1 | 100 | B-5 | 100 | 100 | A-3 | 100 | 10 | A-3 | 100 | A | AA | A | B | B |
| implementation example 6B | D-1 | 100 | B-6 | 100 | 100 | A-1 | 100 | 10 | A-1 | 100 | A | AA | A | A | A |
| implementation example 7B | D-1 | 100 | B-6 | 100 | 100 | A-2 | 100 | 10 | A-2 | 100 | A | AA | A | A | A |
| implementation example 8B | D-1 | 100 | B-6 | 100 | 100 | A-3 | 100 | 10 | A-3 | 100 | A | AA | A | A | A |
| implementation example 9B | D-1 | 100 | B-6 | 100 | 100 | A-4 | 100 | 10 | A-4 | 100 | A | AA | A | A | A |
| implementation example 10B | D-1 | 100 | B-6 | 100 | 100 | A-5 | 100 | 10 | A-5 | 100 | A | AA | A | A | A |
| implementation example 11B | D-2 | 100 | B-6 | 100 | 100 | A-3 | 100 | 10 | A-3 | 100 | A | AA | A | A | A |
| implementation example 12B | D-3 | 100 | B-6 | 100 | 100 | A-3 | 100 | 10 | A-3 | 100 | A | AA | A | A | A |
| implementation example 13B | | | B-6 | 100 | 100 | A-3 | 100 | 5 | A-3 | 100 | A | AA | A | A | A |
| implementation example 14B | D-1 | 100 | B-7 | 100 | 100 | A-3 | 100 | 10 | A-3 | 100 | A | AA | A | A | A |
| implementation example 15B | D-1 | 100 | B-8 | 100 | 100 | A-3 | 100 | 10 | A-3 | 100 | A | AA | A | A | A |
| implementation example 16B | D-1 | 100 | B-2/B-9 | 50/50 | 100 | A-3 | 100 | 10 | A-3 | 100 | B | B | A | B | B |
| implementation example 17B | D-1 | 100 | B-10 | 100 | 100 | A-3 | 100 | 10 | A-3 | 100 | A | A | B | B | B |
| implementation example 18B | D-1 | 100 | B-11 | 100 | 100 | A-3 | 100 | 4 | A-3 | 100 | A | AA | A | A | A |
| implementation example 19B | D-1 | 100 | B-12 | 100 | 100 | A-3 | 100 | 5 | A-3 | 100 | A | AA | A | A | A |
| comparison example 1B | D-1 | 100 | B-13 | 100 | 100 | A-3 | 100 | 10 | A-3 | 100 | A | AA | A | C | C |
| comparison example 2B | D-1 | 100 | B-14 | 100 | 100 | A-3 | 100 | 10 | A-3 | 100 | C | A | B | A | A |
| comparison example 3B | D-1 | 100 | Adekastab | 14 | 5.7 | A-1 | 100 | 10 | A-1 | 100 | A | AA | A | C | C |
| | | | LA-29 | | | | | | | | | | | | |

### Experimental Example 4

The thermoplastic resins used in this experimental example are shown below.

(A-1): polyethylene (Suntec LDM2270, MFR=7 g/10 min, manufactured by Asahi Kasei Corporation)
(A-2): polyethylene (Novatec UJ790, MFR=50 g/10 min, manufactured by Japan polyethylene Corporation)
(A-3): polypropylene (Novatec PPFA3EB, MFR=10.5 g/10 min, manufactured by Japan Polypropylene Corporation)
(A-4): polypropylene (Prime Polypro J226T, MFR=20 g/10 min, manufactured by Prime Polymer Co., Ltd.)
(A-5): polycarbonate (Iupilon S3000, MFR=15 g/10 min, manufactured by Mitsubishi Engineering-Plastics)
(A-6): polymethacrylic resin (ACRYPET MF, MFR=14 g/10 min, manufactured by Mitsubishi Rayon)

The wax used in this experimental example is the same as wax (D-1) to (D-3) shown in experimental example 1.

### Manufacturing Example of Monomer

(Monomers (a1-3-1) to (a1-3-4))

Monomers (a1-3-1) to (a1-3-4) were manufactured by a known method with reference to Japanese Patent Laid-Open No. 2018-168148.

(Monomers (a1-3-5) to (a1-3-8))

The following compound was used as the raw material to manufacture monomers (a1-3-5) to (a1-3-8) in the same manner as monomers (a1-3-1) to (a1-3-4).

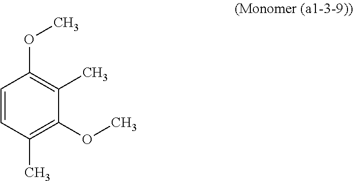

The following compound was used as the raw material to manufacture monomer (a1-3-9) in the same manner as monomers (a1-3-1) to (a1-3-4).

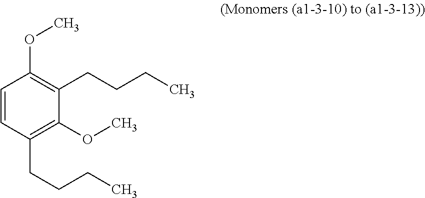 [SMILES: CCCCc1ccc(OC)c(CCCC)c1OC]

Monomers (a1-3-10) to (a1-3-13) were manufactured by a known method with reference to Japanese Patent Laid-Open No. 2018-177696.
(Monomers (a1-3-14) to (a1-3-17))

The following compound was used as the raw material to manufacture monomers (a1-3-14) to (a1-3-17) in the same manner as monomers (a1-3-10) to (a1-3-13).

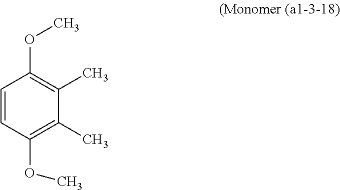

The following compound was used as the raw material to manufacture monomer (a1-3-18) in the same manner as monomers (a1-3-14) to (a1-3-17).

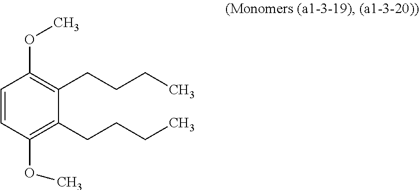 [SMILES: CCCCc1c(OC)ccc(OC)c1CCCC]

The intermediate 1A below was manufactured by a known method with reference to Japanese Patent Laid-Open No. 2018-168148.

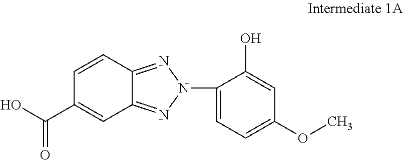 [SMILES: COc1ccc(-n2nc3ccc(C(=O)O)cc3n2)c(O)c1]

Next, 100 g of N-methylpyrrolidone, 28.6 mmol of intermediate 1A and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, and a monomer was precipitated and filtered. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and a mixture of monomers (b-19) and (b-20) was manufactured.

(Monomers (a1-3-21), (a1-3-22))

The intermediate 2A below was manufactured by a known method with reference to Japanese Patent Laid-Open No. 2018-177696.

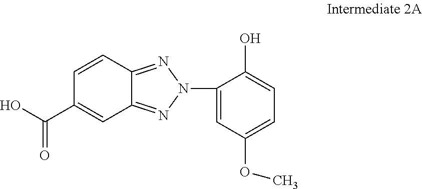 [SMILES: COc1ccc(O)c(-n2nc3ccc(C(=O)O)cc3n2)c1]

Next, 100 g of N-methylpyrrolidone, 28.6 mmol of intermediate 2A and 0.01 mmol of methyl hydroquinone were added into a 200 mL four-neck flask equipped with a thermometer and an agitator and agitated at 120° C. while introducing air into the flask. Subsequently, 62.9 mmol of glycidyl methacrylate and 0.6 mmol of N,N-dimethylbenzylamine were added and agitated at 120° C. for 8 hours. On the other hand, 300 g of water was added into a 500 mL beaker, the previous reaction solution obtained after agitation was dropped little by little, and a monomer was precipitated and filtered. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and a mixture of monomers (b-21) and (b-22) was manufactured.

(Monomers (a1-3-23) to (a1-3-26))

The following compound was used as the raw material to manufacture monomers (a1-3-23) to (a1-3-26) in the same manner as monomers (a1-3-1) to (a1-3-4).

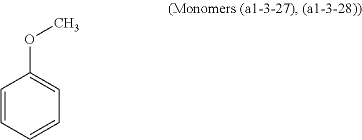

(Monomers (a1-3-27), (a1-3-28)) The following compound was used as the raw material to manufacture monomers (a1-3-27) and (a1-3-28) in the same manner as monomers (a1-3-1) to (a1-3-2).

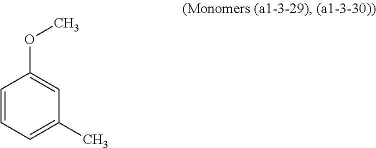

The following compound was used as the raw material to manufacture monomers (a1-3-29) and (a1-3-30) in the same manner as monomers (a1-3-1) to (a1-3-2).

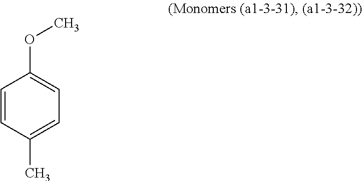

The following compound was used as the raw material to manufacture monomers (a1-3-31) and (a1-3-32) in the same manner as monomers (a1-3-19) and (a1-3-20).

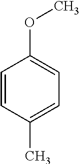

### Manufacturing Example of Ultraviolet-Ray Absorbing Polymer

### Manufacturing Example 1C (Ultraviolet-Ray Absorbing Polymer (B-1))

75.0 parts of methylethyl ketone was added into a four-neck separable flask equipped with a thermometer, an agitator, a dropping funnel and a cooler, and the temperature was raised to 75° C. in a nitrogen stream. Additionally, 14 parts of monomer (a1-3-1) as the monomer unit represented by general formula (3), 43 parts of isostearyl acrylate as the monomer represented by general formula (1), 43 parts of methyl methacrylate, 5.0 parts of 2,2′-azobis(methyl isobutyrate) and 20.0 parts of methylethyl ketone were uniformly mixed and then added into a dropping funnel. Next, the content of the dropping funnel was dropped for two hours. After the dropping was completed, the reaction continued for two hours. Subsequently, sampling was performed and the polymerization yield was confirmed to be 980% or higher. The mixture was cooled to 50′C and taken out to a fluorine resin bat manufactured by DuPont. Furthermore, drying was performed by a vacuum dryer at 50′C for 12 hours to manufacture polymer (B-1).

### Manufacturing Examples 2C to 19C of Ultraviolet-Ray Absorbing Polymer (Ultraviolet-Ray Absorbing Polymers (B-2) to (B-32), (B-35) to (B-45))

Except that the type and blending amount of the monomer used in manufacturing example 1C were changed as described in Table 12, polymers (B-2) to (B-32) and (B-35) to (B-45) were respectively manufactured in the same manner as manufacturing example 1C. Besides, Adekastab LA-82 (manufactured by ADEKA) shown in experimental example 1 was also used.

TABLE 12
content of monomer mixture

| | unsaturated | | | | | | | |
|---|---|---|---|---|---|---|---|---|
| | monomer | | | | | | | |
| | represented by | | | | | | | |
| | general formula | | | | | | | |
| polymer | (3) | | other unsaturated monomer | | | | | |
| B-1 | a1-3-1 | 10 | dicyclopentanyl | 45 | | | styrene | 45 |
| | | | methacrylate | | | | | |
| B-2 | a1-3-2 | 10 | dicyclopentanyl | 45 | | | styrene | 45 |
| | | | methacrylate | | | | | |
| B-3 | a1-3-3 | 10 | dicyclopentanyl | 45 | | | styrene | 45 |
| | | | methacrylate | | | | | |
| B-4 | a1-3-4 | 10 | dicyclopentanyl | 45 | | | styrene | 45 |
| | | | methacrylate | | | | | |
| B-5 | a1-3-5 | 10 | dicyclopentanyl | 45 | | | styrene | 45 |
| | | | methacrylate | | | | | |
| B-6 | a1-3-6 | 10 | dicyclopentanyl | 45 | | | styrene | 45 |
| | | | methacrylate | | | | | |
| B-7 | a1-3-7 | 10 | dicyclopentanyl | 45 | | | styrene | 45 |
| | | | methacrylate | | | | | |
| B-8 | a1-3-8 | 10 | dicyclopentanyl | 45 | | | styrene | 45 |
| | | | methacrylate | | | | | |
| B-9 | a1-3-9 | 10 | dicyclopentanyl | 45 | | | styrene | 45 |
| | | | methacrylate | | | | | |
| B-10 | a1-3-10 | 10 | dicyclopentanyl | 45 | | | styrene | 45 |
| | | | methacrylate | | | | | |
| B-11 | a1-3-11 | 10 | dicyclopentanyl | 45 | | | styrene | 45 |
| | | | methacrylate | | | | | |
| B-12 | a1-3-12 | 10 | dicyclopentanyl | 45 | | | styrene | 45 |
| | | | methacrylate | | | | | |
| B-13 | a1-3-13 | 10 | dicyclopentanyl | 45 | | | styrene | 45 |
| | | | methacrylate | | | | | |
| B-14 | a1-3-14 | 10 | dicyclopentanyl | 45 | | | styrene | 45 |
| | | | methacrylate | | | | | |
| B-15 | a1-3-15 | 10 | dicyclopentanyl | 45 | | | styrene | 45 |
| | | | methacrylate | | | | | |
| B-16 | a1-3-16 | 10 | dicyclopentanyl | 45 | | | styrene | 45 |
| | | | methacrylate | | | | | |
| B-17 | a1-3-17 | 10 | dicyclopentanyl | 45 | | | styrene | 45 |
| | | | methacrylate | | | | | |
| B-18 | a1-3-18 | 10 | dicyclopentanyl | 45 | | | styrene | 45 |
| | | | methacrylate | | | | | |
| B-19 | a1-3-19 | 10 | dicyclopentanyl | 45 | | | styrene | 45 |
| | | | methacrylate | | | | | |
| B-20 | a1-3-20 | 10 | dicyclopentanyl | 45 | | | styrene | 45 |
| | | | methacrylate | | | | | |
| B-21 | a1-3-21 | 10 | dicyclopentanyl | 45 | | | styrene | 45 |
| | | | methacrylate | | | | | |
| B-22 | a1-3-22 | 10 | dicyclopentanyl | 45 | | | styrene | 45 |
| | | | methacrylate | | | | | |
| B-23 | a1-3-23 | 10 | dicyclopentanyl | 45 | | | styrene | 45 |
| | | | methacrylate | | | | | |
| B-24 | a1-3-24 | 10 | dicyclopentanyl | 45 | | | styrene | 45 |
| | | | methacrylate | | | | | |
| B-25 | a1-3-25 | 10 | dicyclopentanyl | 45 | | | styrene | 45 |
| | | | methacrylate | | | | | |
| B-26 | a1-3-26 | 10 | dicyclopentanyl | 45 | | | styrene | 45 |
| | | | methacrylate | | | | | |
| B-27 | a1-3-27 | 10 | dicyclopentanyl | 45 | | | styrene | 45 |
| | | | methacrylate | | | | | |
| B-28 | a1-3-28 | 10 | dicyclopentanyl | 45 | | | styrene | 45 |
| | | | methacrylate | | | | | |
| B-29 | a1-3-29 | 10 | dicyclopentanyl | 45 | | | styrene | 45 |
| | | | methacrylate | | | | | |
| B-30 | a1-3-30 | 10 | dicyclopentanyl | 45 | | | styrene | 45 |
| | | | methacrylate | | | | | |
| B-31 | a1-3-31 | 10 | dicyclopentanyl | 45 | | | styrene | 45 |
| | | | methacrylate | | | | | |
| B-32 | a1-3-32 | 10 | dicyclopentanyl | 45 | | | styrene | 45 |
| | | | methacrylate | | | | | |
| B-35 | a1-3-1 | 10 | isostearyl | 45 | | | styrene | 45 |
| | | | acrylate | | | | | |
| B-36 | a1-3-1 | 10 | dicyclopentanyl | 45 | | | methyl | 45 |
| | | | methacrylate | | | | methacrylate | |
| B-37 | a1-3-1 | 10 | stearyl acrylate | 45 | | | methyl | 45 |
| | | | | | | | methacrylate | |
| B-38 | a1-3-1 | 10 | behenyl acrylate | 45 | | | methyl | 45 |
| | | | | | | | methacrylate | |
| B-39 | a1-3-1 | 10 | dodecyl acrylate | 45 | | | methyl | 45 |
| | | | | | | | methacrylate | |
| B-40 | a1-3-1 | 10 | butyl methacrylate | 45 | | | methyl | 45 |
| | | | | | | | methacrylate | |
| B-41 | a1-3-1 | 1 | dicyclopentanyl | 49 | | | styrene | 50 |
| | | | methacrylate | | | | | |
| B-42 | a1-3-1 | 54 | dicyclopentanyl | 23 | | | styrene | 23 |
| | | | methacrylate | | | | | |
| B-43 | a1-3-1 | 10 | dicyclopentanyl | 40 | Adekastab | 10 | styrene | 40 |
| | | | methacrylate | | LA-82 | | | |
| B-44 | a1-3-1 | 10 | dicyclopentanyl | 44 | Adekastab | 2 | styrene | 44 |
| | | | methacrylate | | LA-82 | | | |
| B-45 | a1-3-1 | 10 | dicyclopentanyl | 25 | Adekastab | 40 | styrene | 25 |
| | | | methacrylate | | LA-82 | | | |

### Implementation Example 1C

### [Manufacturing of Master Batch]

100 parts of ultraviolet-ray absorbing polymer (B-1) was mixed with 100 parts of wax (D-1) and heat-kneaded at 160° C. by a three-roll mill to manufacture dispersion of ultraviolet-ray absorbing polymer (B-1). Next, 10 parts of the dispersion manufactured was mixed with 100 parts of polyolefin (A-1) by a Henschel mixer and melt-kneaded at 180° C. by a single-screw extruder having a screw diameter of 30 mm, and a pelletizer was used to cut into a pellet shape so as to manufacture a formation resin composition (master batch).

[Film Formation]

10 parts of the formation resin composition manufactured was mixed with 100 parts of polyolefin (A-1) as a dilution resin, and a T-die formation machine (manufactured by Toyo Seiki) was used to melt-mix the mixture at a temperature of 180° C. to form a film having a thickness of 250 μm.

### Implementation Examples 2C to 37C, 40C to 50C, Comparison Example 1C

Except that the materials of implementation example 1C were changed as described in Table 13, master batches of implementation examples 2C to 37C, 40C to 50C and comparison example 1C were manufactured in the same manner as implementation example 1C. Next, films of implementation examples 2C to 37C, 40C to 50C and comparison example 1C were respectively formed.

### Implementation Example 51C

### [Manufacturing of Master Batch]

100 parts of polycarbonate (A-5) and 5 parts of ultraviolet-ray absorbing polymer (B-1) were put into a twin-screw extruder having a screw diameter of 30 mm (manufactured by Japan Steel Works) from the same supply port and melt-kneaded at 280° C. Then, a pelletizer was used to cut into a pellet shape so as to manufacture a formation resin composition (master batch).

[Film Formation]

10 parts of the formation resin composition manufactured was mixed with 100 parts of polycarbonate (A-5) as a dilution resin, and a T-die formation machine (manufactured by Toyo Seiki) was used to melt-mix the mixture at a temperature of 280° C. so as to form a film having a thickness of 250 μm.

### Implementation Examples 52C to 82C, Comparison Example 2C

Except that the materials of implementation example 51C were changed as described in Table 14, master batches of implementation examples 52C to 82C and comparison example 2C were respectively manufactured in the same manner as implementation example 51C. Next, films of implementation examples 52C to 82C and comparison example 2C were respectively formed.

### Implementation Example 85C

### [Manufacturing of Master Batch]

100 parts of polymethacrylic resin (A-6) and 5 parts of ultraviolet-ray absorbing polymer (B-1) were put into a twin-screw extruder having a screw diameter of 30 mm (manufactured by Japan Steel Works) from the same supply port and melt-kneaded at 240° C. Then, a pelletizer was used to cut into a pellet shape so as to manufacture a formation resin composition (master batch).

[Film Formation]

10 parts of the formation resin composition manufactured was mixed with 100 parts of polymethacrylic resin (A-6) as a dilution resin, and T-die formation machine (manufactured by Toyo Seiki) was used to melt-mix the mixture at a temperature of 280° C. so as to form a film having a thickness of 250 μm.

### Implementation Examples 86C to 116C, Comparison Example 3C

Except that the materials of implementation example 85C were changed as described in Table 15, master batches of implementation examples 86C to 116C and comparison example 3C were respectively manufactured in the same manner as implementation example 85C. Next, films of implementation examples 86C to 116C and comparison example 3C were respectively formed.

[Ultraviolet-Ray Absorbing Property]

Evaluation was made by the same evaluation method as experimental example 1.

A: the light transmittance at the wavelength of 280 to 420 nm is 2% or lower across the entire region, satisfactory
B: the light transmittance at the wavelength of 280 to 420 nm is partially over 2%, region of practical use
C: the light transmittance at the wavelength of 280 to 420 nm is over 2% across the entire region, not for practical use

[Transparency]

Evaluation was made by the same evaluation method and evaluation criterion as experimental example 1.

[Light Resistance Test]

Evaluation was made by the same evaluation method and evaluation criterion as experimental example 1.

[Migration Evaluation]

Evaluation was made by the same evaluation method as experimental example 3.

A: the absorbance at 280 to 400 nm is not detected (lower than 0.05)
B: the absorbance at 280 to 400 nm is over 0.05 and 0.2 or lower
C: the absorbance at 280 to 400 nm is over 0.2

TABLE 13

| | | | | | | | | | | | ultraviolet | | | migra- |
|---|---|---|---|---|---|---|---|---|---|---|---|---|---|---|
| | manufacturing of master batch | | | | | | | manufacturing of T-die film | | | -ray | trans- | light | tion |
| | manufacturing of dispersion | | | | | | | master | | | absorbing | par- | resis- | evalu- |
| | wax | | polymer | | dispersion | dilution resin | | batch | dilution resin | | property | ency | tance | ation |
| implementation | D-1 | 100 | B-1 | 100 | 10 | A-1 | 100 | 10 | A-1 | 100 | A | AA | B | A |
| example 1C | | | | | | | | | | | | | | |
| implementation | D-1 | 100 | B-1 | 100 | 10 | A-2 | 100 | 10 | A-2 | 100 | A | AA | B | A |
| example 2C | | | | | | | | | | | | | | |
| implementation | D-1 | 100 | B-1 | 100 | 10 | A-3 | 100 | 10 | A-3 | 100 | A | AA | B | A |
| example 3C | | | | | | | | | | | | | | |
| implementation | D-1 | 100 | B-1 | 100 | 10 | A-4 | 100 | 10 | A-4 | 100 | A | AA | B | A |
| example 4C | | | | | | | | | | | | | | |
| implementation | D-2 | 100 | B-1 | 100 | 10 | A-1 | 100 | 10 | A-1 | 100 | A | AA | B | A |
| example 5C | | | | | | | | | | | | | | |
| implementation | D-3 | 100 | B-1 | 100 | 10 | A-1 | 100 | 10 | A-1 | 100 | A | AA | B | A |
| example 6C | | | | | | | | | | | | | | |
| implementation | D-1 | 100 | B-2 | 100 | 10 | A-1 | 100 | 10 | A-1 | 100 | A | AA | B | A |
| example 7C | | | | | | | | | | | | | | |
| implementation | D-1 | 100 | B-3 | 100 | 10 | A-1 | 100 | 10 | A-1 | 100 | A | AA | B | A |
| example 8C | | | | | | | | | | | | | | |
| implementation | D-1 | 100 | B-4 | 100 | 10 | A-1 | 100 | 10 | A-1 | 100 | A | AA | B | A |
| example 9C | | | | | | | | | | | | | | |
| implementation | D-1 | 100 | B-5 | 100 | 10 | A-1 | 100 | 10 | A-1 | 100 | A | AA | B | A |
| example 10C | | | | | | | | | | | | | | |
| implementation | D-1 | 100 | B-6 | 100 | 10 | A-1 | 100 | 10 | A-1 | 100 | A | AA | B | A |
| example 11C | | | | | | | | | | | | | | |
| implementation | D-1 | 100 | B-7 | 100 | 10 | A-1 | 100 | 10 | A-1 | 100 | A | AA | B | A |
| example 12C | | | | | | | | | | | | | | |
| implementation | D-1 | 100 | B-8 | 100 | 10 | A-1 | 100 | 10 | A-1 | 100 | A | AA | B | A |
| example 13C | | | | | | | | | | | | | | |
| implementation | D-1 | 100 | B-9 | 100 | 10 | A-1 | 100 | 10 | A-1 | 100 | A | AA | B | A |
| example 14C | | | | | | | | | | | | | | |
| implementation | D-1 | 100 | B-10 | 100 | 10 | A-1 | 100 | 10 | A-1 | 100 | A | AA | B | A |
| example 15C | | | | | | | | | | | | | | |
| implementation | D-1 | 100 | B-11 | 100 | 10 | A-1 | 100 | 10 | A-1 | 100 | A | AA | B | A |
| example 16C | | | | | | | | | | | | | | |
| implementation | D-1 | 100 | B-12 | 100 | 10 | A-1 | 100 | 10 | A-1 | 100 | A | AA | B | A |
| example 17C | | | | | | | | | | | | | | |
| implementation | D-1 | 100 | B-13 | 100 | 10 | A-1 | 100 | 10 | A-1 | 100 | A | AA | B | A |
| example 18C | | | | | | | | | | | | | | |
| implementation | D-1 | 100 | B-14 | 100 | 10 | A-1 | 100 | 10 | A-1 | 100 | A | AA | B | A |
| example 19C | | | | | | | | | | | | | | |
| implementation | D-1 | 100 | B-15 | 100 | 10 | A-1 | 100 | 10 | A-1 | 100 | A | AA | B | A |
| example 20C | | | | | | | | | | | | | | |
| implementation | D-1 | 100 | B-16 | 100 | 10 | A-1 | 100 | 10 | A-1 | 100 | A | AA | B | A |
| example 21C | | | | | | | | | | | | | | |
| implementation | D-1 | 100 | B-17 | 100 | 10 | A-1 | 100 | 10 | A-1 | 100 | A | AA | B | A |
| example 22C | | | | | | | | | | | | | | |
| implementation | D-1 | 100 | B-18 | 100 | 10 | A-1 | 100 | 10 | A-1 | 100 | A | AA | B | A |
| example 23C | | | | | | | | | | | | | | |
| implementation | D-1 | 100 | B-19 | 100 | 10 | A-1 | 100 | 10 | A-1 | 100 | A | AA | B | A |
| example 24C | | | | | | | | | | | | | | |
| implementation | D-1 | 100 | B-20 | 100 | 10 | A-1 | 100 | 10 | A-1 | 100 | A | AA | B | A |
| example 25C | | | | | | | | | | | | | | |
| implementation | D-1 | 100 | B-21 | 100 | 10 | A-1 | 100 | 10 | A-1 | 100 | A | AA | B | A |
| example 26C | | | | | | | | | | | | | | |
| implementation | D-1 | 100 | B-22 | 100 | 10 | A-1 | 100 | 10 | A-1 | 100 | A | AA | B | A |
| example 27C | | | | | | | | | | | | | | |
| implementation | D-1 | 100 | B-23 | 100 | 10 | A-1 | 100 | 10 | A-1 | 100 | A | AA | B | A |
| example 28C | | | | | | | | | | | | | | |
| implementation | D-1 | 100 | B-24 | 100 | 10 | A-1 | 100 | 10 | A-1 | 100 | A | AA | B | A |
| example 29C | | | | | | | | | | | | | | |
| implementation | D-1 | 100 | B-25 | 100 | 10 | A-1 | 100 | 10 | A-1 | 100 | A | AA | B | A |
| example 30C | | | | | | | | | | | | | | |
| implementation | D-1 | 100 | B-26 | 100 | 10 | A-1 | 100 | 10 | A-1 | 100 | A | AA | B | A |
| example 31C | | | | | | | | | | | | | | |
| implementation | D-1 | 100 | B-27 | 100 | 10 | A-1 | 100 | 10 | A-1 | 100 | A | AA | B | A |
| example 32C | | | | | | | | | | | | | | |
| implementation | D-1 | 100 | B-28 | 100 | 10 | A-1 | 100 | 10 | A-1 | 100 | A | AA | B | A |
| example 33C | | | | | | | | | | | | | | |
| implementation | D-1 | 100 | B-29 | 100 | 10 | A-1 | 100 | 10 | A-1 | 100 | A | AA | B | A |
| example 34C | | | | | | | | | | | | | | |
| implementation | D-1 | 100 | B-30 | 100 | 10 | A-1 | 100 | 10 | A-1 | 100 | A | AA | B | A |
| example 35C | | | | | | | | | | | | | | |
| implementation | D-1 | 100 | B-31 | 100 | 10 | A-1 | 100 | 10 | A-1 | 100 | A | AA | B | A |
| example 36C | | | | | | | | | | | | | | |
| implementation | D-1 | 100 | B-32 | 100 | 10 | A-1 | 100 | 10 | A-1 | 100 | A | AA | B | A |
| example 37C | | | | | | | | | | | | | | |
| implementation | D-1 | 100 | B-35 | 100 | 10 | A-1 | 100 | 10 | A-1 | 100 | A | AA | B | A |
| example 40C | | | | | | | | | | | | | | |
| implementation | D-1 | 100 | B-36 | 100 | 10 | A-1 | 100 | 10 | A-1 | 100 | A | A | B | A |
| example 41C | | | | | | | | | | | | | | |
| implementation | D-1 | 100 | B-37 | 100 | 10 | A-1 | 100 | 10 | A-1 | 100 | A | A | B | A |
| example 42C | | | | | | | | | | | | | | |
| implementation | D-1 | 100 | B-38 | 100 | 10 | A-1 | 100 | 10 | A-1 | 100 | A | A | B | A |
| example 43C | | | | | | | | | | | | | | |
| implementation | D-1 | 100 | B-39 | 100 | 10 | A-1 | 100 | 10 | A-1 | 100 | A | A | B | A |
| example 44C | | | | | | | | | | | | | | |
| implementation | D-1 | 100 | B-40 | 100 | 10 | A-1 | 100 | 10 | A-1 | 100 | A | B | B | A |
| example 45C | | | | | | | | | | | | | | |
| implementation | D-1 | 100 | B-41 | 100 | 10 | A-1 | 100 | 10 | A-1 | 100 | B | AA | B | A |
| example 46C | | | | | | | | | | | | | | |
| implementation | D-1 | 100 | B-42 | 100 | 10 | A-1 | 100 | 10 | A-1 | 100 | A | A | A | |
| example 47C | | | | | | | | | | | | | | B |
| implementation | D-1 | 100 | B-43 | 100 | 10 | A-1 | 100 | 10 | A-1 | 100 | A | AA | A | A |
| example 48C | | | | | | | | | | | | | | |
| implementation | D-1 | 100 | B-44 | 100 | 10 | A-1 | 100 | 10 | A-1 | 100 | A | AA | A | B |
| example 49C | | | | | | | | | | | | | | |
| implementation | D-1 | 100 | B-45 | 100 | 10 | A-1 | 100 | 10 | A-1 | 100 | A | A | A | A |
| example 50C | | | | | | | | | | | | | | |
| comparison | D-1 | 100 | a1-3-1 | 10 | 10 | A-1 | 100 | 10 | A-1 | 100 | A | AA | B | C |
| example 1C | | | | | | | | | | | | | | |

[Table 14]

TABLE 14

| | | | | | | manufacturing of T-die film | | | ultraviolet-ray | | light | migration |
|---|---|---|---|---|---|---|---|---|---|---|---|---|
| | polymer | | dispersion | dilution resin | | master batch | dilution resin | | absorbing property | transparency | resistance | evaluation |
| implementation | B-1 | 10 | 10 | A-5 | 100 | 10 | A-5 | 100 | A | AA | B | A |
| example 51C | | | | | | | | | | | | |
| implementation | B-2 | 10 | 10 | A-5 | 100 | 10 | A-5 | 100 | A | AA | B | A |
| example 52C | | | | | | | | | | | | |
| implementation | B-3 | 10 | 10 | A-5 | 100 | 10 | A-5 | 100 | A | AA | B | A |
| example 53C | | | | | | | | | | | | |
| implementation | B-4 | 10 | 10 | A-5 | 100 | 10 | A-5 | 100 | A | AA | B | A |
| example 54C | | | | | | | | | | | | |
| implementation | B-5 | 10 | 10 | A-5 | 100 | 10 | A-5 | 100 | A | AA | B | A |
| example 55C | | | | | | | | | | | | |
| implementation | B-6 | 10 | 10 | A-5 | 100 | 10 | A-5 | 100 | A | AA | B | A |
| example 56C | | | | | | | | | | | | |
| implementation | B-7 | 10 | 10 | A-5 | 100 | 10 | A-5 | 100 | A | AA | B | A |
| example 57C | | | | | | | | | | | | |
| implementation | B-8 | 10 | 10 | A-5 | 100 | 10 | A-5 | 100 | A | AA | B | A |
| example 58C | | | | | | | | | | | | |
| implementation | B-9 | 10 | 10 | A-5 | 100 | 10 | A-5 | 100 | A | AA | B | A |
| example 59C | | | | | | | | | | | | |
| implementation | B-10 | 10 | 10 | A-5 | 100 | 10 | A-5 | 100 | A | AA | B | A |
| example 60C | | | | | | | | | | | | |
| implementation | B-11 | 10 | 10 | A-5 | 100 | 10 | A-5 | 100 | A | AA | B | A |
| example 61C | | | | | | | | | | | | |
| implementation | B-12 | 10 | 10 | A-5 | 100 | 10 | A-5 | 100 | A | AA | B | A |
| example 62C | | | | | | | | | | | | |
| implementation | B-13 | 10 | 10 | A-5 | 100 | 10 | A-5 | 100 | A | AA | B | A |
| example 63C | | | | | | | | | | | | |
| implementation | B-14 | 10 | 10 | A-5 | 100 | 10 | A-5 | 100 | A | AA | B | A |
| example 64C | | | | | | | | | | | | |
| implementation | B-15 | 10 | 10 | A-5 | 100 | 10 | A-5 | 100 | A | AA | B | A |
| example 65C | | | | | | | | | | | | |
| implementation | B-16 | 10 | 10 | A-5 | 100 | 10 | A-5 | 100 | A | AA | B | A |
| example 66C | | | | | | | | | | | | |
| implementation | B-17 | 10 | 10 | A-5 | 100 | 10 | A-5 | 100 | A | AA | B | A |
| example 67C | | | | | | | | | | | | |
| implementation | B-18 | 10 | 10 | A-5 | 100 | 10 | A-5 | 100 | A | AA | B | A |
| example 68C | | | | | | | | | | | | |
| implementation | B-19 | 10 | 10 | A-5 | 100 | 10 | A-5 | 100 | A | AA | B | A |
| example 69C | | | | | | | | | | | | |
| implementation | B-20 | 10 | 10 | A-5 | 100 | 10 | A-5 | 100 | A | AA | B | A |
| example 70C | | | | | | | | | | | | |
| implementation | B-21 | 10 | 10 | A-5 | 100 | 10 | A-5 | 100 | A | AA | B | A |
| example 71C | | | | | | | | | | | | |
| implementation | B-22 | 10 | 10 | A-5 | 100 | 10 | A-5 | 100 | A | AA | B | A |
| example 72C | | | | | | | | | | | | |
| implementation | B-23 | 10 | 10 | A-5 | 100 | 10 | A-5 | 100 | A | AA | B | A |
| example 73C | | | | | | | | | | | | |
| implementation | B-24 | 10 | 10 | A-5 | 100 | 10 | A-5 | 100 | A | AA | B | A |
| example 74C | | | | | | | | | | | | |
| implementation | B-25 | 10 | 10 | A-5 | 100 | 10 | A-5 | 100 | A | AA | B | A |
| example 75C | | | | | | | | | | | | |
| implementation | B-26 | 10 | 10 | A-5 | 100 | 10 | A-5 | 100 | A | AA | B | A |
| example 76C | | | | | | | | | | | | |
| implementation | B-27 | 10 | 10 | A-5 | 100 | 10 | A-5 | 100 | A | AA | B | A |
| example 77C | | | | | | | | | | | | |
| implementation | B-28 | 10 | 10 | A-5 | 100 | 10 | A-5 | 100 | A | AA | B | A |
| example 78C | | | | | | | | | | | | |
| implementation | B-29 | 10 | 10 | A-5 | 100 | 10 | A-5 | 100 | A | AA | B | A |
| example 79C | | | | | | | | | | | | |
| implementation | B-30 | 10 | 10 | A-5 | 100 | 10 | A-5 | 100 | A | AA | B | A |
| example 80C | | | | | | | | | | | | |
| implementation | B-31 | 10 | 10 | A-5 | 100 | 10 | A-5 | 100 | A | AA | B | A |
| example 81C | | | | | | | | | | | | |
| implementation | B-32 | 10 | 10 | A-5 | 100 | 10 | A-5 | 100 | A | AA | B | A |
| example 82C | | | | | | | | | | | | |
| comparison | a1-3-1 | 1 | 10 | A-5 | 100 | 10 | A-5 | 100 | A | AA | B | C |
| example 2C | | | | | | | | | | | | |

TABLE 15

| | | | | | | | | | ultraviolet-ray | | | |
|---|---|---|---|---|---|---|---|---|---|---|---|---|
| | | | | | | manufacturing of T-die film | | | absorbing | light | migration | |
| | polymer | | dispersion | dilution resin | | master batch | dilution resin | | property | transparency | resistance | evaluation |
| implementation | B-1 | 10 | 10 | A-6 | 100 | 10 | A-6 | 100 | A | AA | B | A |
| example 85C | | | | | | | | | | | | |
| implementation | B-2 | 10 | 10 | A-6 | 100 | 10 | A-6 | 100 | A | AA | B | A |
| example 86C | | | | | | | | | | | | |
| implementation | B-3 | 10 | 10 | A-6 | 100 | 10 | A-6 | 100 | A | AA | B | A |
| example 87C | | | | | | | | | | | | |
| implementation | B-4 | 10 | 10 | A-6 | 100 | 10 | A-6 | 100 | A | AA | B | A |
| example 88C | | | | | | | | | | | | |
| implementation | B-5 | 10 | 10 | A-6 | 100 | 10 | A-6 | 100 | A | AA | B | A |
| example 89C | | | | | | | | | | | | |
| implementation | B-6 | 10 | 10 | A-6 | 100 | 10 | A-6 | 100 | A | AA | B | A |
| example 90C | | | | | | | | | | | | |
| implementation | B-7 | 10 | 10 | A-6 | 100 | 10 | A-6 | 100 | A | AA | B | A |
| example 91C | | | | | | | | | | | | |
| implementation | B-8 | 10 | 10 | A-6 | 100 | 10 | A-6 | 100 | A | AA | B | A |
| example 92C | | | | | | | | | | | | |
| implementation | B-9 | 10 | 10 | A-6 | 100 | 10 | A-6 | 100 | A | AA | B | A |
| example 93C | | | | | | | | | | | | |
| implementation | B-10 | 10 | 10 | A-6 | 100 | 10 | A-6 | 100 | A | AA | B | A |
| example 94C | | | | | | | | | | | | |
| implementation | B-11 | 10 | 10 | A-6 | 100 | 10 | A-6 | 100 | A | AA | B | A |
| example 95C | | | | | | | | | | | | |
| implementation | B-12 | 10 | 10 | A-6 | 100 | 10 | A-6 | 100 | A | AA | B | A |
| example 96C | | | | | | | | | | | | |
| implementation | B-13 | 10 | 10 | A-6 | 100 | 10 | A-6 | 100 | A | AA | B | A |
| example 97C | | | | | | | | | | | | |
| implementation | B-14 | 10 | 10 | A-6 | 100 | 10 | A-6 | 100 | A | AA | B | A |
| example 98C | | | | | | | | | | | | |
| implementation | B-15 | 10 | 10 | A-6 | 100 | 10 | A-6 | 100 | A | AA | B | A |
| example 99C | | | | | | | | | | | | |
| implementation | B-16 | 10 | 10 | A-6 | 100 | 10 | A-6 | 100 | A | AA | B | A |
| example 100C | | | | | | | | | | | | |
| implementation | B-17 | 10 | 10 | A-6 | 100 | 10 | A-6 | 100 | A | AA | B | A |
| example 101C | | | | | | | | | | | | |
| implementation | B-18 | 10 | 10 | A-6 | 100 | 10 | A-6 | 100 | A | AA | B | A |
| example 102C | | | | | | | | | | | | |
| implementation | B-19 | 10 | 10 | A-6 | 100 | 10 | A-6 | 100 | A | AA | B | A |
| example 103C | | | | | | | | | | | | |
| implementation | B-20 | 10 | 10 | A-6 | 100 | 10 | A-6 | 100 | A | AA | B | A |
| example 104C | | | | | | | | | | | | |
| implementation | B-21 | 10 | 10 | A-6 | 100 | 10 | A-6 | 100 | A | AA | B | A |
| example 105C | | | | | | | | | | | | |
| implementation | B-22 | 10 | 10 | A-6 | 100 | 10 | A-6 | 100 | A | AA | B | A |
| example 106C | | | | | | | | | | | | |
| implementation | B-23 | 10 | 10 | A-6 | 100 | 10 | A-6 | 100 | A | AA | B | A |
| example 107C | | | | | | | | | | | | |
| implementation | B-24 | 10 | 10 | A-6 | 100 | 10 | A-6 | 100 | A | AA | B | A |
| example 108C | | | | | | | | | | | | |
| implementation | B-25 | 10 | 10 | A-6 | 100 | 10 | A-6 | 100 | A | AA | B | A |
| example 109C | | | | | | | | | | | | |
| implementation | B-26 | 10 | 10 | A-6 | 100 | 10 | A-6 | 100 | A | AA | B | A |
| example 110C | | | | | | | | | | | | |
| implementation | B-27 | 10 | 10 | A-6 | 100 | 10 | A-6 | 100 | A | AA | B | A |
| example 111C | | | | | | | | | | | | |
| implementation | B-28 | 10 | 10 | A-6 | 100 | 10 | A-6 | 100 | A | AA | B | A |
| example 112C | | | | | | | | | | | | |
| implementation | B-29 | 10 | 10 | A-6 | 100 | 10 | A-6 | 100 | A | AA | B | A |
| example 113C | | | | | | | | | | | | |
| implementation | B-30 | 10 | 10 | A-6 | 100 | 10 | A-6 | 100 | A | AA | B | A |
| example 114C | | | | | | | | | | | | |
| implementation | B-31 | 10 | 10 | A-6 | 100 | 10 | A-6 | 100 | A | AA | B | A |
| example 115C | | | | | | | | | | | | |
| implementation | B-32 | 10 | 10 | A-6 | 100 | 10 | A-6 | 100 | A | AA | B | A |
| example 116C | | | | | | | | | | | | |
| comparison | al-3-1 | 1 | 10 | A-6 | 100 | 10 | A-6 | 100 | A | AA | B | C |
| example 3C | | | | | | | | | | | | |

### Experimental Example 5

The polyolefin used in this experimental example (the number average molecular weight is 30,000 or higher) is shown.

(A-1): polyethylene (Suntec LD M2270, MFR=7 g/10 min, manufactured by Asahi Kasei Corporation)
(A-2): polyethylene (Novatec UJ790, MFR=50 g/10 min, manufactured by Japan polyethylene Corporation)
(A-3): polypropylene (Novatec PP FA3EB, MFR=10.5 g/10 min, manufactured by Japan Polypropylene Corporation)
(A-4): polypropylene (Prime Polypro J226T, MFR=20 g/10 min, manufactured by Prime Polymer Co., Ltd.)
(A-5): polyethylene (Evolue H SP65051B, MFR=0.45 g/10 min, manufactured by Prime Polymer Co., Ltd.)

The wax used in this experimental example is the same as wax (D-1) to (D-3) shown in experimental example 1.

### Manufacturing Example of Ultraviolet-Ray Absorbing Polymer

### Manufacturing Example 1D (Polymer (B-1))

17.5 parts of toluene was added into a four-neck separable flask equipped with a thermometer, an agitator, a dropping funnel and a cooler, 1.0 part of 4-cyano-4-[(dodecylsulfanylthiocarbonyl)sulfanyl]methyl pentanoate and 40.0 parts of the monomer represented by structural formula (a1-1-1) were added, and the temperature was raised to 75° C. in a nitrogen stream. 0.12 part of 2,2′-azobis(2,4-dimethylvaleronitrile) and 10.0 parts of toluene were dropped into the flask for 8 hours, and block A was synthesized. Subsequently, 30.0 parts of dicyclopentanyl methacrylate, 30.0 parts of styrene and 30.0 parts of toluene were added, 0.12 part of 2,2′-azobis(2,4-dimethylvaleronitrile) and 10.0 parts of toluene were dropped for 8 hours, and block B was synthesized. After the dropping was completed, the reaction continued for 24 hours. Subsequently, sampling was performed and the polymerization yield was confirmed to be 99% or higher. Resin solution b-1 was manufactured.

Next, 500 parts of methanol was added into a four-neck separable flask equipped with a thermometer, an agitator, a dropping funnel and a cooler and rotated 1,000 turns by a disper. Then, 100 parts of resin solution b-1 was dropped for one hour. The generated white sediment was taken out by filtering and dried by a vacuum dryer at 50° C. for 12 hours to manufacture AB block polymer (B-1). The weight average molecular weight (Mw) of the polymer manufactured was 22,000, and Mw/Mn was 1.22.

### Manufacturing Examples 3D, 4D, 6D to 9D (Polymers (B-3), (B-4), (B-6) to (B-9))

Except that the type and blending amount of the monomer were changed according to Table 16, polymer (B-3), (B-4), (B-6) to (B-9) were manufactured in the same manner as manufacturing example 1D.

TABLE 16
manufacturing example polymer

| | manufacturing | | manufacturing | | manufacturing | | manufacturing | | manufacturing | | manufacturing | | manufacturing | |
|---|---|---|---|---|---|---|---|---|---|---|---|---|---|---|
| | example 1D | | example 3D | | example 4D | | example 6D | | example7D | | example8D | | example9D | |
| | polymer B-1 | | polymer B-3 | | polymer B-4 | | polymer B-6 | | polymer B-7 | | polymer B-8 | | polymer B-9 | |
| solvent | toluene | 17.5 | toluene | 24.4 | toluene | 17.7 | ethyl | 11.0 | toluene | 17.5 | toluene | 17.5 | toluene | 17.5 |
| | | | | | | | acetate | | | | | | | |
| RAFT | methyl 4- | 1.0 | bis{4- | 1.3 | bis{4- | 1.3 | bis{4- | 1.2 | methyl 4- | 1.0 | methyl 4- | 1.0 | methyl 4- | 1.0 |
| agent | cyano-4- | | [ethyl-(2 | | [ethyl-(2- | | [ethyl-(2- | | cyano-4- | | cyano-4- | | cyano-4- | |
| | (dodecyl- | | hydroxy | | hydroxy | | hydroxy | | (dodecyl- | | (dodecyl- | | (dodecyl- | |
| | sulfanyl- | | ethyl | | ethyl | | ethyl | | sulfanyl- | | sulfanyl- | | sulfanyl- | |
| | thio- | | carba- | | carba- | | carba- | | thio- | | thio- | | thio- | |
| | carbonyl) | | moyl] | | moyl] | | moyl] | | carbonyl) | | carbonyl) | | carbonyl) | |
| | sulfanyl] | | benzyl} | | benzyl} | | benzyl} | | sulfanyl] | | sulfanyl] | | sulfanyl] | |
| | pentanoate | | trithio- | | trithio- | | trithio- | | pentanoate | | | | | |
| | | | carbonate | | carbonate | | carbonate | | | | pentanoate | | pentanoate | |
| block A | structural | 40.0 | structural | 50.0 | structural | 40.0 | structural | 30.0 | structural | 40.0 | structural | 40.0 | structural | 20.0 |
| monomer | formula | | formula | | formula | | formula | | formula | | formula | | formula | |
| | (a1-1-1) | | (a1-2-6) | | (a1-3-2) | | (a1-3-23) | | (a1-4-1) | | (a1-4-4) | | (a1-4-4) | |
| | | | | | | | | | | | | | structural | 20.0 |
| | | | | | | | | | | | | | formula | |
| | | | | | | | | | | | | | (a1-3-5) | |
| initiator | V-65 | 0.1 | V-65 | 0.1 | V-65 | 0.1 | V-65 | 0.1 | V-65 | 0.1 | V-65 | 0.1 | V-65 | 0.1 |
| solvent | toluene | 10.0 | toluene | 10.0 | toluene | 10.0 | ethyl | 10.0 | toluene | 10.0 | toluene | 10.0 | toluene | 10.0 |
| | | | | | | | acetate | | | | | | | |
| block B | DCPMA | 30.0 | DCPMA | 50.0 | ISTA | 41.0 | ISTA | 35.0 | DCPMA | 60.0 | DCPMA | 60.0 | DCPMA | 60. |
| monomer | styrene | 30.0 | | | styrene | 19.0 | styrene | 35.0 | | | | | | |
| solvent | toluene | 30.0 | toluene | 23.4 | toluene | 30.1 | ethyl | 36.7 | toluene | 30.1 | toluene | 30.1 | toluene | 30.1 |
| | | | | | | | acetate | | | | | | | |
| initiator | V-65 | 0.1 | V-65 | 0.1 | V-65 | 0.1 | V-65 | 0.1 | V-65 | 0.1 | V-65 | 0.1 | V-65 | 0.1 |
| solvent | toluene | 10.0 | toluene | 10.0 | toluene | 10.0 | ethyl | 10.0 | toluene | 10.0 | toluene | 10.0 | toluene | 10.0 |
| | | | | | | | acetate | | | | | | | |

| | | | | | | | |
|---|---|---|---|---|---|---|---|
| block | AB block | AB block | AB block | AB block | AB block | AB block | AB block |
| form | | | | | | | |
| block A | 40% | 50% | 40% | 30% | 40% | 40% | 40% |
| content | | | | | | | |
| (%) | | | | | | | |
| Mw | 15,600 | 16,200 | 12,400 | 14,500 | 13,400 | 12,800 | 13,300 |
| Mw/Mn | 1.22 | 1.22 | 1.22 | 1.26 | 1.24 | 1.16 | 1.24 |

Details of the terms in Table 16 are as follows

V-65: 2,2′-azobis(2,4-dimethylvaleronitrile)

DCPMA: dicyclopentanyl methacrylate

ISTA: isostearyl acrylate

### Manufacturing Example 2D (Polymer (B-2))

36.0 parts of ethyl acetate, 3.5 parts of bis(dodecylsulfanylthiocarbonyl) disulfide and 1.9 parts of 2,2′-azobis(2,4-dimethylvaleronitrile) were added into a four-neck separable flask equipped with a thermometer, an agitator, a dropping funnel and a cooler, and the temperature was raised to 70° C. in a nitrogen stream to perform reaction for two hours. 40.0 parts of the monomer represented by structural formula (a1-1-1) was added into the flask, and the temperature was raised to 75° C. in a nitrogen stream. 0.31 part of 2,2′-azobis(2,4-dimethylvaleronitrile) and 10.0 parts of ethyl acetate were dropped into the flask for 8 hours, and block A was synthesized. Subsequently, 50.0 parts of dicyclopentanyl methacrylate, 10.0 parts of 2-methoxyethyl acrylate and 50.3 parts of ethyl acetate were added, 0.31 part of 2,2′-azobis(2,4-dimethylvaleronitrile) and 10.0 parts of ethyl acetate were dropped for 8 hours, and block B was synthesized. After the dropping was completed, the reaction continued for 24 hours. Subsequently, sampling was performed and the polymerization yield was confirmed to be 99% or higher. Resin solution b-2 was manufactured.

Next, 500 parts of methanol was added into a four-neck separable flask equipped with a thermometer, an agitator, a dropping funnel and a cooler and rotated 1,000 turns by a disper. Then, 100 parts of resin solution b-2 was dropped for one hour. The generated white sediment was taken out by filtering and dried by a vacuum dryer at 50° C. for 12 hours to manufacture AB block polymer (B-2). The weight average molecular weight (Mw) of the polymer manufactured was 13,600, and Mw/Mn was 1.20.

### Manufacturing Example 5D (Polymer (B-5))

36.0 parts of ethyl acetate, 3.5 parts of bis(dodecylsulfanylthiocarbonyl) disulfide and 1.9 parts of 2,2′-azobis(2,4-dimethylvaleronitrile) were added into a four-neck separable flask equipped with a thermometer, an agitator, a dropping funnel and a cooler, and the temperature was raised to 70° C. in a nitrogen stream to perform reaction for two hours. 40.0 parts of the monomer represented by structural formula (a1-3-5) was added into the flask, and the temperature was raised to 75° C. in a nitrogen stream. 0.31 part of 2,2′-azobis(2,4-dimethylvaleronitrile) and 10.0 parts of ethyl acetate were dropped into the flask for 8 hours, and block A was synthesized. Subsequently, 60.0 parts of dicyclopentanyl methacrylate and 50.3 parts of ethyl acetate were added, 0.31 part of 2,2′-azobis(2,4-dimethylvaleronitrile) and 10.0 parts of ethyl acetate were dropped for 8 hours, and block B was synthesized. After the dropping was completed, the reaction continued for 24 hours. Subsequently, sampling was performed and the polymerization yield was confirmed to be 99% or higher. Resin solution b-5 was manufactured.

Next, 500 parts of methanol was added into a four-neck separable flask equipped with a thermometer, an agitator, a dropping funnel and a cooler and rotated 1,000 turns by a disper. Then, 100 parts of resin solution b-5 was dropped for one hour. The generated white sediment was taken out by filtering and dried by a vacuum dryer at 50° C. for 12 hours to manufacture AB block polymer (B-5). The weight average molecular weight (Mw) of the polymer manufactured was 14,600, and Mw/Mn was 1.20.

### Manufacturing Example 10D (Polymer (B-10))

17.5 parts of toluene, 1.0 part of methyl 4-cyano-4-[(dodecylsulfanylthiocarbonyl)sulfanyl]pentanoate and 30.0 parts of dicyclopentanyl methacrylate were added into a four-neck separable flask equipped with a thermometer, an agitator, a dropping funnel and a cooler, and the temperature was raised to 75° C. in a nitrogen stream. 0.06 part of 2,2′-azobis(2,4-dimethylvaleronitrile) and 5.0 parts of toluene were dropped into the flask for 8 hours, and block B was synthesized. Subsequently, 20.0 parts of the monomer represented by structural formula (a1-4-4) and 20.0 parts of the monomer represented by structural formula (a1-1-1) were added, and the temperature was raised to 75° C. in a nitrogen stream. 0.12 part of 2,2′-azobis(2,4-dimethylvaleronitrile) and 10.0 parts of toluene were dropped into the flask for 8 hours, and block A was synthesized. Subsequently, 30.0 parts of dicyclopentanyl methacrylate was added, and the temperature was raised to 75° C. in a nitrogen stream. 0.06 part of 2,2′-azobis(2,4-dimethylvaleronitrile) and 5.0 parts of toluene were dropped into the flask for 8 hours, and block B was synthesized. Subsequently, sampling was performed and the polymerization yield was confirmed to be 99% or higher. Resin solution b-10 was manufactured.

Next, 500 parts of methanol was added into a four-neck separable flask equipped with a thermometer, an agitator, a dropping funnel and a cooler and rotated 1,000 turns by a disper. Then, 100 parts of the resin solution b-10 was dropped for one hour. The generated white sediment was taken out by filtering and dried by a vacuum dryer at 50° C. for 12 hours to manufacture, BAB block polymer (B-10). The weight average molecular weight (Mw) of the polymer manufactured was 13,000, and Mw/Mn was 1.25.

### Manufacturing Example 11D (Polymer (B-11))

61.4 parts of methylethyl ketone was added into a four-neck separable flask equipped with a thermometer, an agitator, a dropping funnel and a cooler, and the temperature was raised to 75° C. in a nitrogen stream. Additionally, 40.0 parts of the monomer represented by structural formula (a1-1-1), 30.0 parts of dicyclopentanyl methacrylate, 30.0 parts of styrene, 10.0 parts of 2,2′-azobis(methyl isobutyrate) and 75.0 parts of methylethyl ketone were uniformly mixed and then added into a dropping funnel. Next, the content of the dropping funnel was dropped for two hours. After the dropping was completed, the reaction continued for two hours. Subsequently, sampling was performed and the polymerization yield was confirmed to be 98% or higher. Resin solution b-11 was manufactured.

Next, 500 parts of methanol was added into a four-neck separable flask equipped with a thermometer, an agitator, a dropping funnel and a cooler and rotated 1,000 turns by a disper. Then, 100 parts of the resin solution b-11 as dropped for one hour. The generated white sediment was taken out by filtering and dried by a vacuum dryer at 50° C. for 12 hours to manufacture random polymer (B-11).

### Manufacturing Examples 12D, 13D (Polymer (B-12), (B-13))

Except that the type and blending amount of the monomer were changed according to Table 17, synthesis was performed in the same manner as manufacturing example 1D to manufacture polymers (B-12) and (B-13).

[Table 17]

TABLE 17

| manu- | | | | | | |
|---|---|---|---|---|---|---|
| facturing | manufacturing | | manufacturing | | manufacturing | |
| example | example 11D | | example 12D | | example 13D | |
| polymer | polymer B-11 | | polymer B-12 | | polymer B-13 | |
| solvent | methylethyl | 61.4 | methylethyl | 61.4 | methylethyl | 61.4 |
| | ketone | | ketone | | ketone | |
| monomer | structural | 40.0 | | | | |
| | formula | | | | | |
| | (a1-1-1) | | | | | |
| monomer | DCPMA | 30.0 | DCPMA | 50.0 | DCPMA | 100.0 |
| | styrene | 30.0 | styrene | 50.0 | | |
| initiator | 2,2′-azobis | 10.0 | 2,2′-azobis | 10.0 | 2,2′-azobis | 10.0 |
| | (Methyl | | (Methyl | | (Methyl | |
| | isobutyrate) | | isobutyrate) | | isobutyrate) | |
| solvent | methylethyl | 75.0 | methylethyl | 75.0 | methylethyl | 75.0 |
| | ketone | | ketone | | ketone | |

| | | | |
|---|---|---|---|
| Mw | 12,200 | 12,700 | 12,300 |
| Mw/Mn | 1.97 | 2.31 | 2.05 |

### Implementation Example 1D

### [Manufacturing of Master Batch]

100 parts of wax (D-1) and 100 parts of polymer (B-1) were mixed, and a three-roll mill was used to knead at 160° C. so as to manufacture dispersion of polymer (B-1). Next, 30 parts of the dispersion manufactured was mixed with 100 parts of polyolefin (A-3) by a Henschel mixer. Next, the mixture was melt-kneaded at 180° C. by a single-screw extruder having a screw diameter of 30 mm and then cooled, and a pelletizer was used to cut into a pellet shape so as to manufacture a master batch.

[Film Formation]

10 parts of the master batch manufactured was mixed with 100 parts of polyolefin (A-3) as a dilution resin. Next, a T-die formation machine (manufactured by Toyo Seiki) was used to melt-mix the mixture at a temperature of 180° C. and form a film having a thickness of 250 μm.

### Implementation Examples 2D to 17D, Comparison Examples 1D to 3D

Except that the materials of implementation example 1D were changed to the materials and blending amount shown in Table 18, master batches were manufactured in the same manner as implementation example 1D. Next, films of implementation examples 2D to 17D and comparison examples 1D to 3D were respectively formed. Note that, in implementation example 12D, polyethylene terephthalate (called P-1 for short, MITSUI PET SA135, IV=0.83 dl/g, manufactured by Mitsui Chemicals, Inc.) was used as the dilution resin during film formation. In addition, IV indicates intrinsic viscosity and is measured by the method described in JIS K 7367.

[Ultraviolet-Ray Absorbing Property]

Evaluation was made by the same evaluation method as experimental example 1.

AA: the light transmittance at the wavelength of 290 to 360 nm is 0.3% or lower across the entire region, satisfactory
A: regions in which the light transmittance is partially 0.3% or higher exist in the range of a wavelength of 290 to 360 nm, region of practical use
C: the light transmittance at the wavelength of 290 to 360 nm is 0.3% or higher across the entire region, not for practical use

[Translucency of Film]

Evaluation was made by the same evaluation method and evaluation criterion as in [transparency] of experimental example 1.

TABLE 18

| | manufacturing of master batch | | | | | | | | | | | | ultraviolet- | |
|---|---|---|---|---|---|---|---|---|---|---|---|---|---|---|
| | manufacturing of dispersion | | | | | | | | | | | | ray | film |
| | | | ultraviolet-ray | | disper- | | | polyethylene | | manufacturing of T-die film | | | absorbing | trans- |
| | wax | | absorbing polymer | | sion | polyolefin | | terephthalate | | master batch | dilution resin | | property | lucency |
| implementation | D-1 | 100 | B-1 | 100 | 30 | A-3 | 100 | | | 10 | A-3 | 100 | AA | A |
| example 1D | | | | | | | | | | | | | | |
| implementation | D-1 | 100 | B-2 | 100 | 30 | A-3 | 100 | | | 10 | A-3 | 100 | AA | A |
| example 2D | | | | | | | | | | | | | | |
| implementation | D-1 | 100 | B-3 | 100 | 23 | A-3 | 100 | | | 10 | A-3 | 100 | AA | A |
| example 3D | | | | | | | | | | | | | | |
| implementation | D-1 | 100 | B-4 | 100 | 30 | A-3 | 100 | | | 10 | A-3 | 100 | A | A |
| example 4D | | | | | | | | | | | | | | |
| implementation | D-1 | 100 | B-5 | 100 | 30 | A-3 | 100 | | | 10 | A-3 | 100 | A | A |
| example 5D | | | | | | | | | | | | | | |
| implementation | D-1 | 100 | B-6 | 100 | 45 | A-1 | 100 | | | 10 | A-1 | 100 | A | A |
| example 6D | | | | | | | | | | | | | | |
| implementation | D-1 | 100 | B-6 | 100 | 45 | A-2 | 100 | | | 10 | A-2 | 100 | A | A |
| example 7D | | | | | | | | | | | | | | |
| implementation | D-1 | 100 | B-1 | 100 | 30 | A-3 | 100 | | | 10 | A-3 | 100 | AA | A |
| example 8D | | | | | | | | | | | | | | |
| implementation | D-1 | 100 | B-1 | 100 | 30 | A-4 | 100 | | | 10 | A-4 | 100 | AA | A |
| example 9D | | | | | | | | | | | | | | |
| implementation | D-1 | 100 | B-1 | 100 | 30 | A-5 | 100 | | | 10 | A-5 | 100 | AA | A |
| example 10D | | | | | | | | | | | | | | |
| implementation | D-2 | 100 | B-1 | 100 | 30 | A-3 | 100 | | | 10 | A-3 | 100 | AA | A |
| example 11D | | | | | | | | | | | | | | |
| implementation | D-3 | 100 | B-1 | 100 | 30 | | | P-1 | 100 | 10 | A-3 | 100 | AA | A |
| example 12D | | | | | | | | | | | | | | |
| implementation | D-3 | 100 | B-1 | 100 | 30 | A-3 | 100 | | | 10 | A-3 | 100 | AA | A |
| example 13D | | | | | | | | | | | | | | |
| implementation | D-1 | 100 | B-7 | 100 | 30 | A-3 | 100 | | | 10 | A-3 | 100 | AA | A |
| example 14D | | | | | | | | | | | | | | |
| implementation | D-1 | 100 | B-8 | 100 | 30 | A-3 | 100 | | | 10 | A-3 | 100 | AA | A |
| example 15D | | | | | | | | | | | | | | |
| implementation | D-1 | 100 | B-9 | 100 | 30 | A-3 | 100 | | | 10 | A-3 | 100 | A | A |
| example 16D | | | | | | | | | | | | | | |
| implementation | D-1 | 100 | B-10 | 100 | 30 | A-3 | 100 | | | 10 | A-3 | 100 | A | A |
| example 17D | | | | | | | | | | | | | | |
| comparison | D-1 | 100 | B-11 | 100 | 30 | A-3 | 100 | | | 10 | A-3 | 100 | A | C |
| example 1D | | | | | | | | | | | | | | |
| comparison | D-1 | 100 | B-12 | 100 | 30 | A-3 | 100 | | | 10 | A-3 | 100 | C | A |
| example 2D | | | | | | | | | | | | | | |
| comparison | D-1 | 100 | B-13 | 100 | 30 | A-1 | 100 | | | 10 | A-1 | 100 | C | A |
| example 3D | | | | | | | | | | | | | | |

### Experimental Example 6

The polyolefin used in this experimental example is shown below. Besides, the number average molecular weight of the polyolefin is 30,000 or higher in all cases.

(C-1): polyethylene (Suntec LD M2270, MFR=7 g/10 min, manufactured by Asahi Kasei Corporation)
(C-2): polyethylene (Novatec UJ790, MFR=50 g/10 min, manufactured by Japan polyethylene Corporation)
(C-3): polypropylene (Novatec PP FA3EB, MFR=10.5 g/10 min, manufactured by Japan Polypropylene Corporation)
(C-4): polypropylene (Prime Polypro J226T, MFR=20 g/10 min, manufactured by Prime Polymer Co., Ltd.)

The wax used in this experimental example is the same as wax (D-1) to (D-3) shown in experimental example 1.

### Manufacturing Example of Ultraviolet-Ray Absorbing Monomer

### (Ultraviolet-Ray Absorbing Monomer (A-1))

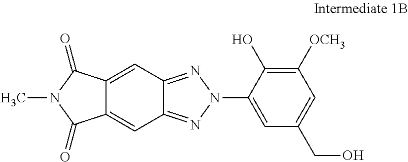 [SMILES: COc1cc(CO)cc(-n2nc3cc4c(cc3n2)C(=O)N(C)C4=O)c1O]

The intermediate 1B was synthesized according to the synthesis method in the implementation example of International Publication No. 2014/165434, taking 4-amino-5-bromo-N-methyl phthalimide and vanillyl alcohol as the raw material. Subsequently, 100 g of tetrahydrofuran and 28.6 mmol of the previous intermediate 1B were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Next, drying was performed at 40° C. under reduced pressure, and ultraviolet-ray absorbing monomer (A-1) was manufactured.

(Ultraviolet-Ray Absorbing Monomer (A-2))

Except that methacryloyl chloride was used instead of acryloyl chloride used in the manufacturing of ultraviolet-ray absorbing monomer (A-1), ultraviolet-ray absorbing monomer (A-2) was manufactured in the same manner.

(Ultraviolet-Ray Absorbing Monomer (A-3))

100 g of tetrahydrofuran and 28.6 mmol of previous intermediate 1B were added into a 200 mL four-neck flask equipped with a thermometer and an agitator and agitated at room temperature. Subsequently, 28.6 mmol of 2-acryloyloxyethyl isocyanate was added, and 0.02 mmol of Neostann U-810 (tin-based catalysis, manufactured by Nitto Kasei) was further added and agitated at 60° C. for 5 hours. Subsequently, agitation was performed under heat to volatilize the tetrahydrofuran until an ultraviolet-ray absorbing monomer was precipitated, drying was further performed at 40° C. under reduced pressure, and ultraviolet-ray absorbing monomer (A-3) was manufactured.

(Ultraviolet-Ray Absorbing Monomer (A-4))

Except that 2-methacryloyloxyethyl isocyanate was used instead of 2-acryloyloxyethyl isocyanate used in the manufacturing of ultraviolet-ray absorbing monomer (A-3), ultraviolet-ray absorbing monomer (A-4) was manufactured in the same manner.

(Ultraviolet-Ray Absorbing Monomer (A-5))

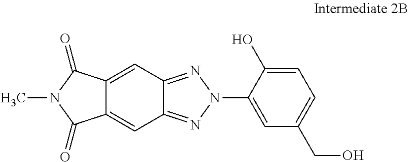 [SMILES: CN1C(=O)c2cc3nn(-c4cc(CO)ccc4O)nc3cc2C1=O]

The intermediate 2B was synthesized by the same method as intermediate 1B except that 4-hydroxy benzylalcohol was used instead of vanillyl alcohol used in the synthesis of intermediate 1B. Subsequently, 100 g of tetrahydrofuran and 28.6 mmol of the previous intermediate 2B were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Next, drying was performed at 40° C. under reduced pressure, and ultraviolet-ray absorbing monomer (A-5) was manufactured.

(Ultraviolet-Ray Absorbing Monomer (A-6))

Except that methacryloyl chloride was dropped instead of acryloyl chloride used in the manufacturing of ultraviolet-ray absorbing monomer (A-5), ultraviolet-ray absorbing monomer (A-6) was manufactured in the same manner.

(Ultraviolet-Ray Absorbing Monomer (A-7))

100 g of tetrahydrofuran and 28.6 mmol of the previous intermediate 2B were added into a 200 mL four-neck flask equipped with a thermometer and an agitator and agitated at room temperature. Subsequently, 28.6 mmol of 2-acryloyloxyethyl isocyanate was added, and 0.02 mmol of Neostann U-810 manufactured by Nitto Kasei was further added and agitated at 60° C. for 5 hours. Subsequently, agitation was performed under heat to volatilize the tetrahydrofuran until an ultraviolet-ray absorbing monomer was precipitated, drying was further performed at 40° C. under reduced pressure, and ultraviolet-ray absorbing monomer (A-7) was manufactured.

(Ultraviolet-Ray Absorbing Monomer (A-8))

Except that 2-methacryloyloxyethyl isocyanate was used instead of 2-acryloyloxyethyl isocyanate used in the manufacturing of ultraviolet-ray absorbing monomer (A-7), ultraviolet-ray absorbing monomer (A-8) was manufactured in the same manner.

(Ultraviolet-Ray Absorbing Monomer (A-9))

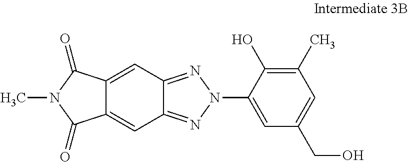 [SMILES: Cc1cc(CO)cc(-n2nc3cc4c(cc3n2)C(=O)N(C)C4=O)c1O]

The intermediate 3B was synthesized by the same method as intermediate 1B except that 4-hydroxy-3-methylbenzylalcohol was used instead of vanillyl alcohol used in the synthesis of intermediate 1B. Subsequently, 100 g of tetrahydrofuran and 28.6 mmol of the previous intermediate 3B were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Next, drying was performed at 40° C. under reduced pressure, and ultraviolet-ray absorbing monomer (A-9) was manufactured.

(Ultraviolet-Ray Absorbing Monomer (A-10))

Except that methacryloyl chloride was dropped instead of acryloyl chloride used in the manufacturing of ultraviolet-ray absorbing monomer (A-9), ultraviolet-ray absorbing monomer (A-10) was manufactured in the same manner.

(Ultraviolet-Ray Absorbing Monomer (A-11))

After the synthesis of the intermediate 3B, 100 g of tetrahydrofuran and 28.6 mmol of the previous intermediate 3B were added into a 200 mL four-neck flask equipped with a thermometer and an agitator and agitated at room temperature. Subsequently, 28.6 mmol of 2-acryloyloxyethyl isocyanate was added, and 0.02 mmol of Neostann U-810 manufactured by Nitto Kasei was further added agitated at 60° C. for 5 hours. Subsequently, agitation was performed under heat to volatilize the tetrahydrofuran until an ultraviolet-ray absorbing monomer was precipitated, drying was further performed at 40° C. under reduced pressure, and ultraviolet-ray absorbing monomer (A-11) was manufactured.

(Ultraviolet-Ray Absorbing Monomer (A-12))

Except that 2-methacryloyloxyethyl isocyanate was used instead of 2-acryloyloxyethyl isocyanate used in the manufacturing of ultraviolet-ray absorbing monomer (A-11), ultraviolet-ray absorbing monomer (A-12) was manufactured in the same manner.

(Ultraviolet-Ray Absorbing Monomer (A-13))

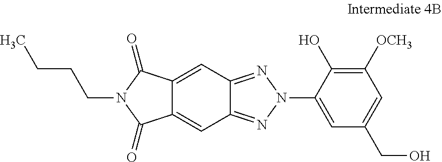 [SMILES: CCCCN1C(=O)c2cc3nn(-c4cc(CO)cc(OC)c4O)nc3cc2C1=O]

The intermediate 4B was synthesized according to the synthesis method in the implementation example of International Publication No. 2014/165434, taking intermediate 1B and n-butylamine as the raw material. Subsequently, 100 g of tetrahydrofuran and 28.6 mmol of the previous intermediate 4B were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Next, drying was performed at 40° C. under reduced pressure, and ultraviolet-ray absorbing monomer (A-13) was manufactured.

(Ultraviolet-Ray Absorbing Monomer (A-14))

Except that methacryloyl chloride was dropped instead of acryloyl chloride used in the manufacturing of ultraviolet-ray absorbing monomer (A-13), ultraviolet-ray absorbing monomer (A-14) was manufactured in the same manner.

(Ultraviolet-Ray Absorbing Monomer (A-15))

After the synthesis of the intermediate 4B, 100 g of tetrahydrofuran and 28.6 mmol of the previous intermediate 4B were added into a 200 mL four-neck flask equipped with a thermometer and an agitator and agitated at room temperature. Subsequently, 28.6 mmol of 2-acryloyloxyethyl isocyanate was added, and 0.02 mmol of Neostann U-810 manufactured by Nitto Kasei was further added and agitated at 60° C. for 5 hours. Subsequently, agitation was performed under heat to volatilize the tetrahydrofuran until an ultraviolet-ray absorbing monomer was precipitated, drying was further performed at 40° C. under reduced pressure, and ultraviolet-ray absorbing monomer (A-15) was manufactured.

(Ultraviolet-Ray Absorbing Monomer (A-16))

Except that 2-methacryloyloxyethyl isocyanate was used instead of 2-acryloyloxyethyl isocyanate used in the manufacturing of ultraviolet-ray absorbing monomer (A-15), ultraviolet-ray absorbing monomer (A-16) was manufactured in the same manner.

(Ultraviolet-Ray Absorbing Monomer (A-17))

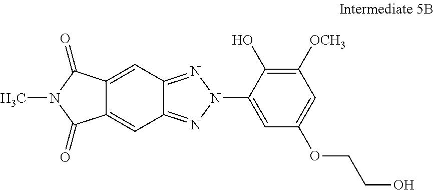 [SMILES: COc1cc(OCCO)cc(-n2nc3cc4c(cc3n2)C(=O)N(C)C4=O)c1O]

The intermediate 5B was synthesized by the same method as intermediate 1B except that 4-(2-hydroxy ethoxy)-2-methoxyphenol was used instead of vanillyl alcohol used in the synthesis of intermediate 1B. Subsequently, 100 g of tetrahydrofuran and 28.6 mmol of the previous intermediate 5B were added into a 200 mL four-neck flask equipped with a thermometer and an agitator and agitated at room temperature. Subsequently, 62.9 mmol of acryloyl chloride was dropped little by little. Subsequently, 85.7 mmol of triethylamine was dropped little by little and agitated at room temperature for one hour. On the other hand, 300 g of water was added into a 500 mL beaker, the previous reaction solution obtained after agitation was dropped little by little, agitation was performed under heat to volatilize the tetrahydrofuran until an ultraviolet-ray absorbing monomer was precipitated, and then filtering was performed. Subsequently, sprinkle cleaning was performed by 300 g of water. The obtained wet cake was returned to 300 g of water for reslurrying at room temperature for 30 minutes, and then filtering was performed. Subsequently, sprinkle cleaning was performed by 300 g of water. Drying was performed at 40° C. under reduced pressure, and ultraviolet-ray absorbing monomer (A-17) was manufactured.

(Ultraviolet-Ray Absorbing Monomer (A-18))

Except that methacryloyl chloride was dropped instead of acryloyl chloride used in the manufacturing of ultraviolet-ray absorbing monomer (A-17), ultraviolet-ray absorbing monomer (A-18) was manufactured in the same manner.

(Ultraviolet-Ray Absorbing Monomer (A-19))

After the synthesis of the intermediate 5B, 100 g of tetrahydrofuran and 28.6 mmol of the previous intermediate 5B were added into a 200 mL four-neck flask equipped with a thermometer and an agitator and agitated at room temperature. Subsequently, 28.6 mmol of 2-acryloyloxyethyl isocyanate was added, and 0.02 mmol of Neostann U-810 manufactured by Nitto Kasei was further added and agitated at 60° C. for 5 hours. Subsequently, agitation was performed under heat to volatilize the tetrahydrofuran until an ultraviolet-ray absorbing monomer was precipitated, drying was further performed at 40° C. under reduced pressure, and ultraviolet-ray absorbing monomer (A-19) was manufactured.

(Ultraviolet-Ray Absorbing Monomer (A-20)) Except that 2-methacryloyloxyethyl isocyanate was used instead of 2-acryloyloxyethyl isocyanate used in the manufacturing of ultraviolet-ray absorbing monomer (A-19), ultraviolet-ray absorbing monomer (A-20) was manufactured in the same manner.

### Manufacturing Example of Acrylic Polymer

### (Acrylic Polymer (B-1))

75.0 parts of methylethyl ketone was added into a four-neck separable flask equipped with a thermometer, an agitator, a distillation tube and a cooler, and the temperature was raised to 75° C. in a nitrogen stream. Additionally, 10 parts of ultraviolet-ray absorbing monomer (A-1), 45 parts of dicyclopentanyl methacrylate, 45 parts of styrene, 5.0 parts of 2,2′-azobis(Methyl isobutyrate) and 20.0 parts of methylethyl ketone were made uniform and added into a dropping funnel, then attached to the four-neck separable flask and dropped for two hours. Two hours after the dropping was completed, sampling was performed and polymerization conversion rate was confirmed to be 98% or higher, then the temperature was reduced to 50° C. Accordingly, acrylic polymer (B-1) solution having 50 mass % of nonvolatile content was manufactured.

### (Acrylic Polymers (B-2) to (B-31))

Except that the ultraviolet-ray absorbing monomer used in the synthesis of acrylic polymer (B-1) was changed as shown in Table 19, acrylic polymers (B-2) to (B-31) were respectively manufactured in the same manner as acrylic polymer (B-1). Besides, Adekastab LA-82 (manufactured by ADEKA) shown in experimental example 1.

TABLE 19

| | content of monomer mixture | | | | | | | |
|---|---|---|---|---|---|---|---|---|
| | unsaturated monomer | | | | | | | |
| | represented by | | | | | | | |
| acrylic polymer | general formula (a1-2) | | other unsaturated monomer | | | | | |
| B-1 | A-1 | 10 | dicyclopentanyl | 45 | | | styrene | 45 |
| | | | methacrylate | | | | | |
| B-2 | A-2 | 10 | dicyclopentanyl | 45 | | | styrene | 45 |
| | | | methacrylate | | | | | |
| B-3 | A-3 | 10 | dicyclopentanyl | 45 | | | styrene | 45 |
| | | | methacrylate | | | | | |
| B-4 | A-4 | 10 | dicyclopentanyl | 45 | | | styrene | 45 |
| | | | methacrylate | | | | | |
| B-5 | A-5 | 10 | dicyclopentanyl | 45 | | | styrene | 45 |
| | | | methacrylate | | | | | |
| B-6 | A-6 | 10 | dicyclopentanyl | 45 | | | styrene | 45 |
| | | | methacrylate | | | | | |
| B-7 | A-7 | 10 | dicyclopentanyl | 45 | | | styrene | 45 |
| | | | methacrylate | | | | | |
| B-8 | A-8 | 10 | dicyclopentanyl | 45 | | | styrene | 45 |
| | | | methacrylate | | | | | |
| B-9 | A-9 | 10 | dicyclopentanyl | 45 | | | styrene | 45 |
| | | | methacrylate | | | | | |
| B-10 | A-10 | 10 | dicyclopentanyl | 45 | | | styrene | 45 |
| | | | methacrylate | | | | | |
| B-11 | A-11 | 10 | dicyclopentanyl | 45 | | | styrene | 45 |
| | | | methacrylate | | | | | |
| B-12 | A-12 | 10 | dicyclopentanyl | 45 | | | styrene | 45 |
| | | | methacrylate | | | | | |
| B-13 | A-13 | 10 | dicyclopentanyl | 45 | | | styrene | 45 |
| | | | methacrylate | | | | | |
| B-14 | A-14 | 10 | dicyclopentanyl | 45 | | | styrene | 45 |
| | | | methacrylate | | | | | |
| B-15 | A-15 | 10 | dicyclopentanyl | 45 | | | styrene | 45 |
| | | | methacrylate | | | | | |
| B-16 | A-16 | 10 | dicyclopentanyl | 45 | | | styrene | 45 |
| | | | methacrylate | | | | | |
| B-17 | A-17 | 10 | dicyclopentanyl | 45 | | | styrene | 45 |
| | | | methacrylate | | | | | |
| B-18 | A-18 | 10 | dicyclopentanyl | 45 | | | styrene | 45 |
| | | | methacrylate | | | | | |
| B-19 | A-19 | 10 | dicyclopentanyl | 45 | | | styrene | 45 |
| | | | methacrylate | | | | | |
| B-20 | A-20 | 10 | dicyclopentanyl | 45 | | | styrene | 45 |
| | | | methacrylate | | | | | |
| B-21 | A-1 | 10 | isostearyl | 45 | | | styrene | 45 |
| | | | acrylate | | | | | |
| B-22 | A-1 | 10 | dicyclopentanyl | 45 | | | methyl | 45 |
| | | | methacrylate | | | | | |
| B-23 | A-1 | 10 | stearyl | 45 | | | methyl | 45 |
| | | | acrylate | | | | | |
| | | | methacrylate | | | | | |
| B-24 | A-1 | 10 | behenyl | 45 | | | methyl | 45 |
| | | | acrylate | | | | methacrylate | |
| B-25 | A-1 | 10 | dodecyl | 45 | | | methyl | 45 |
| | | | acrylate | | | | methacrylate | |
| B-26 | A-1 | 10 | butyl | 45 | | | methyl | 45 |
| | | | methacrylate | | | | methacrylate | |
| B-27 | A-1 | 1 | dicyclopentanyl | 49 | | | styrene | 50 |
| | | | methacrylate | | | | | |
| B-28 | A-1 | 54 | dicyclopentanyl | 23 | | | styrene | 23 |
| | | | methacrylate | | | | | |
| B-29 | A-1 | 10 | dicyclopentanyl | 40 | AdekastabLA-82 | 10 | styrene | 40 |
| | | | methacrylate | | | | | |
| B-30 | A-1 | 10 | dicyclopentanyl | 44 | AdekastabLA-82 | 2 | styrene | 44 |
| | | | methacrylate | | | | | |
| B-31 | A-1 | 10 | dicyclopentanyl | 25 | AdekastabLA-82 | 40 | styrene | 25 |
| | | | methacrylate | | | | | |

### Implementation Example 1E

### [Manufacturing of Master Batch]

100 parts of wax (D-1) and 100 parts of acrylic polymer (B-1) were mixed, and a three-roll mill was used to knead at 160° C. so as to manufacture dispersion of acrylic polymer (B-1). Next, 10 parts of the dispersion manufactured was mixed with 100 parts by mass of polyolefin (C-1) by a Henschel mixer. Next, the mixture was melt-kneaded at 180° C. by a single-screw extruder having a screw diameter of 30 mm, and then a pelletizer was used to cut into a pellet shape so as to manufacture a master batch.

[Film Formation]

10 parts of the master batch manufactured was mixed with 100 parts of polyolefin (C-1) as a dilution resin. Next, a T-die formation machine (manufactured by Toyo Seiki) was used to melt-mix the mixture at a temperature of 180° C. and form a film having a thickness of 250 μm.

### Implementation Examples 2E to 37E, Comparison Example 1E

Except that the materials of implementation example 1E were changed to the materials and blending amount shown in Table 20, master batches were manufactured in the same manner as implementation example 1E. Next, films of implementation examples 2E to 37E and comparison example 1E were respectively formed. Besides, in the comparison example, intermediate 1B was used instead of acrylic polymer (B-1) of implementation example 1E.

[Film Formation]

10 parts of the master batch manufactured was mixed with 100 parts of polyolefin (C-1) as a dilution resin. Next, a T-die formation machine (manufactured by Toyo Seiki) was used to melt-mix the mixture at a temperature of 180° C. and form a film having a thickness of 250 μm.

[Ultraviolet-Ray Absorbing Property]

Evaluation was made by the same evaluation method and evaluation criterion as experimental example 1.

[Transparency]

Evaluation was made by the same evaluation method and evaluation criterion as experimental example 1.

[Light Resistance Test]

Evaluation was made by the same evaluation method as experimental example 1.

AA: no turbidity is recognized, extremely satisfactory
A: almost no turbidity is recognized, satisfactory
B: turbidity is slightly recognized, region of practical use
C: turbidity is clearly recognized, not for practical use

[Migration Evaluation]

Evaluation was made by the same evaluation method and evaluation criterion as experimental example 4.

TABLE 20

| | manufacturing of master batch | | | | | | | | | | ultraviolet- | | | migra- |
|---|---|---|---|---|---|---|---|---|---|---|---|---|---|---|
| | manufacturing of dispersion | | | | | | | | | | ray | | light | tion |
| | | | acrylic polymer or | | disper- | | | manufacturing of T-die film | | | absorbing | trans- | resis- | evalu- |
| | wax | | unsaturated monomer | | sion | polyolefin | | master batch | dilution resin | | property | parency | tance | ation |
| implementation | D-1 | 100 | B-1 | 100 | 10 | C-1 | 100 | 10 | C-1 | 100 | A | AA | B | A |
| example lE | | | | | | | | | | | | | | |
| implementation | D-1 | 100 | B-1 | 100 | 10 | C-2 | 100 | 10 | C-2 | 100 | A | AA | B | A |
| example 2E | | | | | | | | | | | | | | |
| implementation | D-1 | 100 | B-1 | 100 | 10 | C-3 | 100 | 10 | C-3 | 100 | A | AA | B | A |
| example 3E | | | | | | | | | | | | | | |
| implementation | D-1 | 100 | B-1 | 100 | 10 | C-4 | 100 | 10 | C-4 | 100 | A | AA | B | A |
| example 4E | | | | | | | | | | | | | | |
| implementation | D-2 | 100 | B-1 | 100 | 10 | C-1 | 100 | 10 | C-1 | 100 | A | AA | B | A |
| example 5E | | | | | | | | | | | | | | |
| implementation | D-3 | 100 | B-1 | 100 | 10 | C-1 | 100 | 10 | C-1 | 100 | A | AA | B | A |
| example 6E | | | | | | | | | | | | | | |
| implementation | D-4 | 100 | B-1 | 100 | 10 | C-1 | 100 | 10 | C-1 | 100 | A | AA | B | A |
| example 7E | | | | | | | | | | | | | | |
| implementation | D-1 | 100 | B-2 | 100 | 10 | C-1 | 100 | 10 | C-1 | 100 | A | AA | B | A |
| example 8E | | | | | | | | | | | | | | |
| implementation | D-1 | 100 | B-3 | 100 | 10 | C-1 | 100 | 10 | C-1 | 100 | A | AA | B | A |
| example 9E | | | | | | | | | | | | | | |
| implementation | D-1 | 100 | B-4 | 100 | 10 | C-1 | 100 | 10 | C-1 | 100 | A | AA | B | A |
| example 10E | | | | | | | | | | | | | | |
| implementation | D-1 | 100 | B-5 | 100 | 10 | C-1 | 100 | 10 | C-1 | 100 | A | AA | B | A |
| example 11E | | | | | | | | | | | | | | |
| implementation | D-1 | 100 | B-6 | 100 | 10 | C-1 | 100 | 10 | C-1 | 100 | A | AA | B | A |
| example 12E | | | | | | | | | | | | | | |
| implementation | D-1 | 100 | B-7 | 100 | 10 | C-1 | 100 | 10 | C-1 | 100 | A | AA | B | A |
| example 13E | | | | | | | | | | | | | | |
| implementation | D-1 | 100 | B-8 | 100 | 10 | C-1 | 100 | 10 | C-1 | 100 | A | AA | B | A |
| example 14E | | | | | | | | | | | | | | |
| implementation | D-1 | 100 | B-9 | 100 | 10 | C-1 | 100 | 10 | C-1 | 100 | A | AA | B | A |
| example 15E | | | | | | | | | | | | | | |
| implementation | D-1 | 100 | B-10 | 100 | 10 | C-1 | 100 | 10 | C-1 | 100 | A | AA | B | A |
| example 16E | | | | | | | | | | | | | | |
| implementation | D-1 | 100 | B-11 | 100 | 10 | C-1 | 100 | 10 | C-1 | 100 | A | AA | B | A |
| example 17E | | | | | | | | | | | | | | |
| implementation | D-1 | 100 | B-12 | 100 | 10 | C-1 | 100 | 10 | C-1 | 100 | A | AA | B | A |
| example 18E | | | | | | | | | | | | | | |
| implementation | D-1 | 100 | B-13 | 100 | 10 | C-1 | 100 | 10 | C-1 | 100 | A | AA | B | A |
| example 19E | | | | | | | | | | | | | | |
| implementation | D-1 | 100 | B-14 | 100 | 10 | C-1 | 100 | 10 | C-1 | 100 | A | AA | B | A |
| example 20E | | | | | | | | | | | | | | |
| implementation | D-1 | 100 | B-15 | 100 | 10 | C-1 | 100 | 10 | C-1 | 100 | A | AA | B | A |
| example 21E | | | | | | | | | | | | | | |
| implementation | D-1 | 100 | B-16 | 100 | 10 | C-1 | 100 | 10 | C-1 | 100 | A | AA | B | A |
| example 22E | | | | | | | | | | | | | | |
| implementation | D-1 | 100 | B-17 | 100 | 10 | C-1 | 100 | 10 | C-1 | 100 | A | AA | B | A |
| example 23E | | | | | | | | | | | | | | |
| implementation | D-1 | 100 | B-18 | 100 | 10 | C-1 | 100 | 10 | C-1 | 100 | A | AA | B | A |
| example 24E | | | | | | | | | | | | | | |
| implementation | D-1 | 100 | B-19 | 100 | 10 | C-1 | 100 | 10 | C-1 | 100 | A | AA | B | A |
| example 25E | | | | | | | | | | | | | | |
| implementation | D-1 | 100 | B-20 | 100 | 10 | C-1 | 100 | 10 | C-1 | 100 | A | AA | B | A |
| example 26E | | | | | | | | | | | | | | |
| implementation | D-1 | 100 | B-21 | 100 | 10 | C-1 | 100 | 10 | C-1 | 100 | A | AA | B | A |
| example 27E | | | | | | | | | | | | | | |
| implementation | D-1 | 100 | B-22 | 100 | 10 | C-1 | 100 | 10 | C-1 | 100 | A | A | B | A |
| example 28E | | | | | | | | | | | | | | |
| implementation | D-1 | 100 | B-23 | 100 | 10 | C-1 | 100 | 10 | C-1 | 100 | A | A | B | A |
| example 29E | | | | | | | | | | | | | | |
| implementation | D-1 | 100 | B-24 | 100 | 10 | C-1 | 100 | 10 | C-1 | 100 | A | A | B | A |
| example 30E | | | | | | | | | | | | | | |
| implementation | D-1 | 100 | B-25 | 100 | 10 | C-1 | 100 | 10 | C-1 | 100 | A | A | B | A |
| example 31E | | | | | | | | | | | | | | |
| implementation | D-1 | 100 | B-26 | 100 | 10 | C-1 | 100 | 10 | C-1 | 100 | A | B | B | A |
| example 32E | | | | | | | | | | | | | | |
| implementation | D-1 | 100 | B-27 | 100 | 10 | C-1 | 100 | 10 | C-1 | 100 | B | AA | B | A |
| example 33E | | | | | | | | | | | | | | |
| implementation | D-1 | 100 | B-28 | 100 | 10 | C-1 | 100 | 10 | C-1 | 100 | A | A | B | A |
| example 34E | | | | | | | | | | | | | | |
| implementation | D-1 | 100 | B-29 | 100 | 10 | C-1 | 100 | 10 | C-1 | 100 | A | AA | A | A |
| example 35E | | | | | | | | | | | | | | |
| implementation | D-1 | 100 | B-30 | 100 | 10 | C-1 | 100 | 10 | C-1 | 100 | A | AA | B | A |
| example 36E | | | | | | | | | | | | | | |
| implementation | D-1 | 100 | B-31 | 100 | 10 | C-1 | 100 | 10 | C-1 | 100 | A | A | A | A |
| example 37E | | | | | | | | | | | | | | |
| comparison | D-1 | 100 | intermediate | 10 | 10 | C-1 | 100 | 10 | C-1 | 100 | A | AA | B | C |
| example lE | | | 1B | | | | | | | | | | | |

What is claimed is:

1. An ultraviolet-ray absorbing polymer containing a monomer unit represented by general formula (12) below and a monomer unit derived from a monomer represented by general formula (1) below, 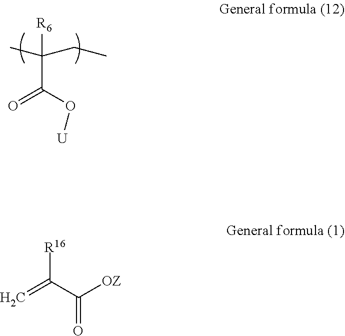
in general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom,
in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

2. An ultraviolet-ray absorbing polymer which contains block A and block B, wherein
the block A is a polymer block containing a monomer unit represented by general formula (12) below, and
the block B is a polymer block containing a monomer unit derived from a monomer represented by general formula (1) below wherein, the polymer block does not contain the monomer unit represented by general formula (12), 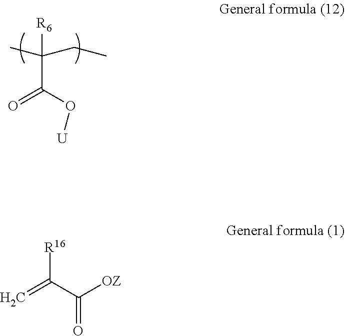
in general formula (12), R₆ represents any one selected from a group consisting of a hydrogen atom and a methyl group, U represents a hydrocarbon group, and the hydrocarbon group includes a skeleton absorbing ultraviolet rays and optionally contains a heteroatom,
in general formula (1), R¹⁶ represents any one selected from a group consisting of a hydrogen atom and a methyl group, and Z represents any one selected from a group consisting of a chain hydrocarbon group having 10 or more carbon atoms and a polycyclic hydrocarbon group having 10 or more carbon atoms.

3. The ultraviolet-ray absorbing polymer according to claim 2, wherein the block A contains 30 to 100 mass % of the monomer unit represented by general formula (12).

4. The ultraviolet-ray absorbing polymer according to claim 1, wherein the skeleton absorbing ultraviolet rays is one or more skeletons selected from a group consisting of a benzotriazole skeleton, a triazine skeleton, and a benzophenone skeleton.

5. The ultraviolet-ray absorbing polymer according to claim 4, wherein the skeleton absorbing ultraviolet rays is one or more skeletons selected from a group consisting of the benzotriazole skeleton and the triazine skeleton,
the monomer unit containing the benzotriazole skeleton contains one monomer unit selected from a group consisting of a monomer unit represented by general formula (a1-1) below and a monomer unit represented by general formula (3) below, and
the monomer unit containing the triazine skeleton contains a monomer unit represented by general formula (a1-4) below, 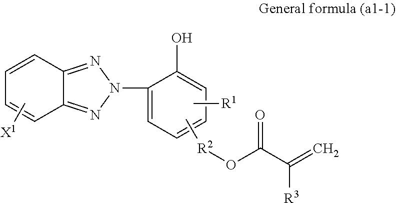
in general formula (a1-1), R¹ represents any one selected from a group consisting of a hydrogen atom and a hydrocarbon group having 1 to 8 carbon atoms, R² represents any one selected from a group consisting of an alkylene group having 1 to 6 carbon atoms and —O—R⁵, R⁵ represents an alkylene group having 1 to 6 carbon atoms, R³ represents any one selected from a group consisting of a hydrogen atom and a methyl group, and X¹ represents any one selected from a group consisting of a hydrogen atom, a halogen atom, a hydrocarbon group having 1 to 8 carbon atoms, an alkoxy group having 1 to 6 carbon atoms, a cyano group, and a nitro group, 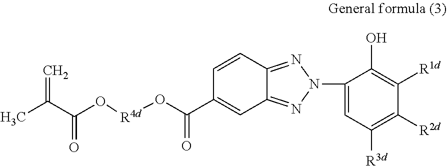
in general formula (3), R^{1d} represents any one selected from a group consisting of a hydrogen atom, an alkyl group having 1 to 20 carbon atoms, and a cycloalkyl group having 3 to 20 carbon atoms, R^{2d} and R^{3d} independently represent any one selected from a group consisting of a hydrogen atom, an alkyl group having 1 to 20 carbon atoms, a cycloalkyl group having 3 to 20 carbon atoms, and an alkoxy group having 1 to 20 carbon atoms, and R^{4d} represents any one selected from a group consisting of an alkylene group having 1 to 20 carbon atoms and a hydroxy alkylene group having 3 to 5 carbon atoms, 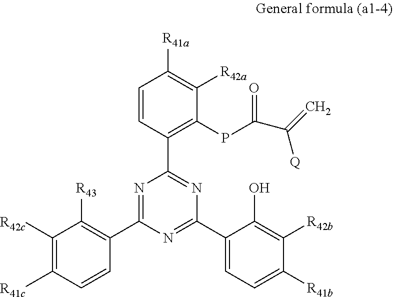
in general formula (a1-4), R₄₁ₐ, R_{41b}, and R_{41c} independently represent any one selected from a group consisting of a hydrogen atom, an alkyl group having 1 to 20 carbon atoms, an aryl group having 6 to 20 carbon atoms, —O—R₄₄ₐ, and —O—R₄₅ₐ—CO—O—R₄₆ₐ, R₄₄ₐ and R₄₆ₐ independently represent any one selected from a group consisting of an alkyl group having 1 to 20 carbon atoms and an aryl group having 6 to 20 carbon atoms, the alkyl group optionally forms a cyclic structure, R₄₅ₐ represents any one selected from a group consisting of an alkylene group having 1 to 20 carbon atoms and an arylene group having 6 to 20 carbon atoms, R₄₂ₐ, R_{42b}, and R_{42c} independently represent any one selected from a group consisting of a hydrogen atom and an alkyl group having 1 to 10 carbon atoms, R₄₃ represents any one selected from a group consisting of a hydrogen atom, a hydroxyl group, an alkyl group having 1 to 20 carbon atoms, an aryl group having 6 to 20 carbon atoms, —O—R_{44b}, and —O—R_{45b}—CO—O—R_{46b}, R_{44b} and R_{46b} independently represent any one selected from a group consisting of an alkyl group having 1 to 20 carbon atoms and an aryl group having 6 to 20 carbon atoms, the alkyl group optionally forms a cyclic structure, R_{45b} represents any one selected from a group consisting of an alkylene group having 1 to 20 carbon atoms and an arylene group having 6 to 20 carbon atoms, and the alkyl group optionally forms a cyclic structure,
P represents any one selected from a group consisting of —O— and —O—R₄₇—O—, R₄₇ represents an alkylene group having 1 to 20 carbon atoms, the alkylene group optionally contains a hydroxyl group, and Q represents any one selected from a group consisting of a hydrogen atom and a methyl group.

6. The ultraviolet-ray absorbing polymer according to claim 1, which is obtained by copolymerization of the monomer unit represented by general formula (12), the monomer unit derived from the monomer represented by general formula (1), and a monomer unit represented by general formula (5) below, 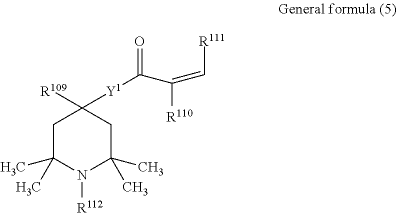
in general formula (5), R¹⁰⁹ represents any one selected from a group consisting of a hydrogen atom and a cyano group, R¹¹⁰ and R¹¹¹ independently represent any one selected from a group consisting of a hydrogen atom and a methyl group, R¹¹² represents any one selected from a group consisting of a hydrogen atom and a hydrocarbon group, and Y¹ represents any one selected from a group consisting of an oxygen atom and an imino group.

7. A formation resin composition, wherein the formation resin composition contains a thermoplastic resin and the ultraviolet-ray absorbing polymer according to claim 1, and
the weight average molecular weight of the ultraviolet-ray absorbing polymer is 5,000 to 100,000.

8. The formation resin composition according to claim 7, wherein the thermoplastic resin is polyolefin.

9. A formed body containing the formation resin composition according to claim 7.

10. The ultraviolet-ray absorbing polymer according to claim 2, wherein the skeleton absorbing ultraviolet rays is one or more skeletons selected from a group consisting of a benzotriazole skeleton, a triazine skeleton, and a benzophenone skeleton.

11. The ultraviolet-ray absorbing polymer according to claim 10, wherein the skeleton absorbing ultraviolet rays is one or more skeletons selected from a group consisting of the benzotriazole skeleton and the triazine skeleton,
the monomer unit containing the benzotriazole skeleton contains one monomer unit selected from a group consisting of a monomer unit represented by general formula (a1-1) below and a monomer unit represented by general formula (3) below, and
the monomer unit containing the triazine skeleton contains a monomer unit represented by general formula (a1-4) below, 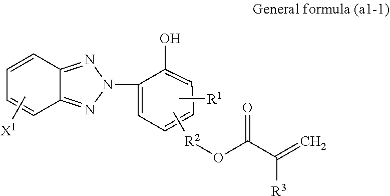
in general formula (a1-1), R¹ represents any one selected from a group consisting of a hydrogen atom and a hydrocarbon group having 1 to 8 carbon atoms, R² represents any one selected from a group consisting of an alkylene group having 1 to 6 carbon atoms and —O—R⁵, R⁵ represents an alkylene group having 1 to 6 carbon atoms, R³ represents any one selected from a group consisting of a hydrogen atom and a methyl group, and X¹ represents any one selected from a group consisting of a hydrogen atom, a halogen atom, a hydrocarbon group having 1 to 8 carbon atoms, an alkoxy group having 1 to 6 carbon atoms, a cyano group, and a nitro group, 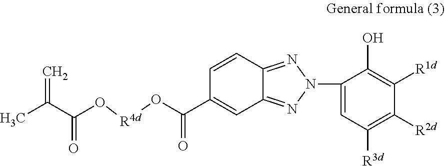
in general formula (3), R^{1d} represents any one selected from a group consisting of a hydrogen atom, an alkyl group having 1 to 20 carbon atoms, and a cycloalkyl group having 3 to 20 carbon atoms, R^{2d} and R^{3d} independently represent any one selected from a group consisting of a hydrogen atom, an alkyl group having 1 to 20 carbon atoms, a cycloalkyl group having 3 to 20 carbon atoms, and an alkoxy group having 1 to 20 carbon atoms, and R^{4d} represents any one selected from a group consisting of an alkylene group having 1 to 20 carbon atoms and a hydroxy alkylene group having 3 to 5 carbon atoms, 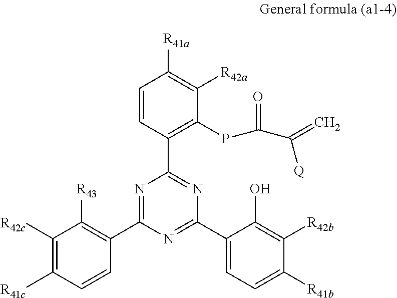
in general formula (a1-4), R₄₁ₐ, R_{41b}, and R_{41c} independently represent any one selected from a group consisting of a hydrogen atom, an alkyl group having 1 to 20 carbon atoms, an aryl group having 6 to 20 carbon atoms, —O—R₄₄ₐ, and —O—R₄₅ₐ—CO—O—R₄₆ₐ, R₄₄ₐ and R₄₆ₐ independently represent any one selected from a group consisting of an alkyl group having 1 to 20 carbon atoms and an aryl group having 6 to 20 carbon atoms, the alkyl group optionally forms a cyclic structure, R₄₅ₐ represents any one selected from a group consisting of an alkylene group having 1 to 20 carbon atoms and an arylene group having 6 to 20 carbon atoms, R₄₂ₐ, R_{42b}, and R_{42c} independently represent any one selected from a group consisting of a hydrogen atom and an alkyl group having 1 to 10 carbon atoms, R₄₃ represents any one selected from a group consisting of a hydrogen atom, a hydroxyl group, an alkyl group having 1 to 20 carbon atoms, an aryl group having 6 to 20 carbon atoms, —O—R_{44b}, and —O—R_{45b}—CO—O—R_{46b}, R_{44b} and R_{46b} independently represent any one selected from a group consisting of an alkyl group having 1 to 20 carbon atoms and an aryl group having 6 to 20 carbon atoms, the alkyl group optionally forms a cyclic structure, R_{45b} represents any one selected from a group consisting of an alkylene group having 1 to 20 carbon atoms and an arylene group having 6 to 20 carbon atoms, and the alkyl group optionally forms a cyclic structure,
P represents any one selected from a group consisting of —O— and —O—R₄₇—O—, R₄₇ represents an alkylene group having 1 to 20 carbon atoms, the alkylene group optionally contains a hydroxyl group, and Q represents any one selected from a group consisting of a hydrogen atom and a methyl group.

12. The ultraviolet-ray absorbing polymer according to claim 2, which is obtained by copolymerization of the monomer unit represented by general formula (12), the monomer unit derived from the monomer represented by general formula (1), and a monomer unit represented by general formula (5) below, 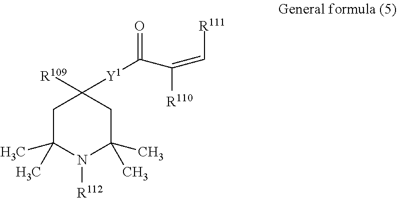
in general formula (5), R¹⁰⁹ represents any one selected from a group consisting of a hydrogen atom and a cyano group, R¹¹⁰ and R¹¹¹ independently represent any one selected from a group consisting of a hydrogen atom and a methyl group, R¹¹² represents any one selected from a group consisting of a hydrogen atom and a hydrocarbon group, and Y¹ represents any one selected from a group consisting of an oxygen atom and an imino group.

13. A formation resin composition, wherein the formation resin composition contains a thermoplastic resin and the ultraviolet-ray absorbing polymer according to claim 2, and
the weight average molecular weight of the ultraviolet-ray absorbing polymer is 5,000 to 100,000.

14. The formation resin composition according to claim 13, wherein the thermoplastic resin is polyolefin.

15. A formed body containing the formation resin composition according to claim 13.
